(19) United States
(12) Patent Application Publication
(10) Pub. No.: US 2017/0030166 A1
(43) Pub. Date: Feb. 2, 2017

(54) SHOCK AND VIBRATION TOOL MODELING

(71) Applicant: Schlumberger Technology Corporation, Sugar Land, TX (US)

(72) Inventors: Yuelin Shen, Spring, TX (US); Geng Yun, Spring, TX (US); Zhengxin Zhang, Spring, TX (US); Wei Chen, Spring, TX (US); Sujian Huang, Beijing (CN)

(21) Appl. No.: 15/216,823

(22) Filed: Jul. 22, 2016

Related U.S. Application Data
(60) Provisional application No. 62/197,119, filed on Jul. 27, 2015.

(51) Int. Cl. E21B 41/00; E21B 49/00; G06F 17/50; E21B 47/022; E21B 34/06; E21B 1/00; E21B 7/24; E21B 49/08

(52) U.S. Cl. CPC E21B 41/0085; E21B 7/24; E21B 49/00; E21B 49/08; E21B 47/022; E21B 34/06; E21B 1/00; G06F 17/5009

(57) ABSTRACT

A system for simulating a downhole operation including a computing device having a computing processor and computer-readable media storing computer-executable instructions that cause the computing device to use bottomhole assembly parameters, wellbore parameters, drilling operating parameters, and vibration tool parameters or shock tool parameters, to execute a first simulation to generate first performance parameters. The instructions are also configured to cause the computing device to use the BHA parameters, wellbore parameters, drilling operating parameters, and a second set of vibration tool parameters or shock tool parameters to execute a second simulation to generate second performance parameters. By comparing the first and second simulations, a bottomhole assembly may be evaluated, modified, selected, or designed.

### CROSS-REFERENCE TO RELATED APPLICATIONS

This application claims the benefit of, and priority to, U.S. patent application Ser. No. 62/197,119 filed Jul. 27, 2015, which application is expressly incorporated herein by this reference in its entirety.

### BACKGROUND

Operations, such as geophysical surveying, drilling, logging, wellbore completion, hydraulic fracturing, steam injection, and production, among others are often performed to locate and gather valuable subterranean assets, such as valuable fluids, gases, or minerals. These subterranean assets, however, may not be limited to hydrocarbons (e.g., oil or gas).

During wellbore drilling operations, friction of a drill string against a wellbore wall may be generated. In addition, horizontal sections of a wellbore may produce higher friction than vertical or directional sections of the wellbore. With increased friction, weight transfer to a drill bit may not be immediately realized, rates of penetration may decline, wear of the drill string and bit may be amplified, and productivity may be reduced.

### SUMMARY

One or more embodiments of the present disclosure relate to a system for simulating a downhole operation, the system having a computing device including a computing processor and computer-readable media storing computer-executable instructions that, when executed by the computing processor, are configured to cause the computing device to execute a first simulation to generate first performance parameters. To execute the first simulation, bottom hole assembly (BHA) parameters, wellbore parameters, drilling operating parameters, and first vibration tool parameters or shock tool parameters may be used with the BHA parameters, wellbore parameters, and drilling operating parameters. A second simulation may be executed to generate second performance parameters using second vibration tool parameters or shock tool parameters may be used. A graphical user interface is executed with functionality to receive the BHA parameters, wellbore parameters, drilling operating parameters, first vibration tool parameters or shock tool parameters, and second vibration tool parameters or shock tool parameters. The graphical user interface may present the first performance parameters generated from the first simulation and may be used to modify a parameter of the first vibration tool parameters or shock tool parameters to obtain the second vibration tool parameters or shock tool parameters. The graphical user interface may present the second performance parameters generated from the second simulation, and a downhole system may be selected, modified, or designed based on the first or second performance parameters.

One or more embodiments of the present disclosure relate to a method for selecting a downhole assembly. The method includes receiving vibration tool parameters, bottom hole assembly (BHA) parameters, wellbore parameters, and drilling operating parameters. A dynamic simulation is performed for a first downhole assembly based on the vibration tool parameters, BHA parameters, wellbore parameters, and drilling operating parameters. A performance parameter of the first downhole assembly, and which is obtained from performing the dynamic simulation, is presented.

One or more embodiments of the present disclosure relate to a method of designing a downhole assembly. The method includes accessing vibration tool parameters, shock tool parameters, bottom hole assembly (BHA) parameters, wellbore parameters, and drilling operating parameters. A dynamic simulation of a first downhole assembly is performed based on the vibration tool parameters, shock tool parameters, BHA parameters, wellbore parameters, and drilling operating parameters. A performance parameter of the first downhole assembly calculated from the dynamic simulation of the first downhole assembly, is also presented.

This summary is provided to introduce a selection of concepts that are further described below in the detailed description. This summary is not intended to identify key or essential features of the claimed subject matter, nor is it intended to be used as an aid in limiting the scope of the claimed subject matter. Other aspects of the disclosure will be apparent from the following description and the appended claims.

### BRIEF DESCRIPTION OF DRAWINGS

FIG. 1 shows a drilling system for drilling an earth formation, according to one or more embodiments of the present disclosure.

FIG. 2 shows a fixed-cutter bit, according to one or more embodiments of the present disclosure.

FIG. 3 shows a visualization of a finite element analysis, in accordance with one or more embodiments of the present disclosure.

FIGS. 4-1 through 4-4 are cross-sectional views of a vibration tool, in accordance with one or more embodiments of the present disclosure.

FIG. 5 is a cross-sectional view of a vibration tool and a shock tool, in accordance with one or more embodiments of the present disclosure.

FIG. 6 schematically depicts a system for simulating a downhole assembly, in accordance with one or more embodiments of the present disclosure.

FIG. 7 is a flow chart of a method for simulating a downhole operation, in accordance with one or more embodiments of the present disclosure.

FIG. 8-1 is a depiction of a vibration tool and a shock tool, in accordance with one or more embodiments of the present disclosure.

FIGS. 8-2 and 8-3 show plots of pulse force versus time, in accordance with one or more embodiments of the present disclosure.

FIG. 9-1 is a depiction of a downhole assembly, in accordance with one or more embodiments of the present disclosure.

FIGS. 9-2 and 9-3 show visualizations of a drill bit model, in accordance with one or more embodiments of the present disclosure.

FIG. 10 is a visualization of a model of a wellbore, in accordance with one or more embodiments of the present disclosure.

FIG. 11 is a 3D visualization of a wellbore, in accordance with one or more embodiments of the present disclosure.

FIGS. 12-1 and 12-2 are plots of rate of penetration and downhole weight on bit, respectively, for multiple simulation scenarios, in accordance with one or more embodiments of the present disclosure.

FIGS. 13-1 to 13-4 are plots of rate of penetration for each of the simulation scenarios of FIGS. 12-1 and 12-2, in accordance with one or more embodiments of the present disclosure.

FIGS. 14-1 to 14-4 are plots of downhole weight on bit for each of the simulation scenarios of FIGS. 12-1 and 12-2, in accordance with one or more embodiments of the present disclosure.

FIGS. 15-1 to 15-4 are plots of surface weight on bit for each of the simulation scenarios of FIGS. 12-1 and 12-2, in accordance with one or more embodiments of the present disclosure.

FIGS. 16-1 to 16-4 are plots of BHA axial velocity for each of the simulation scenarios of FIGS. 12-1 and 12-2, in accordance with one or more embodiments of the present disclosure.

FIGS. 17-1 to 17-4 are plots of BHA axial friction force for each of the simulation scenarios of FIGS. 12-1 and 12-2, in accordance with one or more embodiments of the present disclosure.

FIGS. 18-1 to 18-4 are plots of BHA axial acceleration for each of the simulation scenarios of FIGS. 12-1 and 12-2, in accordance with one or more embodiments of the present disclosure.

FIGS. 19-1 to 19-4 are plots of BHA lateral acceleration for each of the simulation scenarios of FIGS. 12-1 and 12-2, in accordance with one or more embodiments of the present disclosure.

FIGS. 20-1 to 20-4 are plots of bit axial acceleration for each of the simulation scenarios of FIGS. 12-1 and 12-2, in accordance with one or more embodiments of the present disclosure.

FIGS. 21-1 to 21-4 are plots of bit lateral acceleration for each of the simulation scenarios of FIGS. 12-1 and 12-2, in accordance with one or more embodiments of the present disclosure.

FIGS. 22-1 to 22-4 are plots of bit RPM for each of the simulation scenarios of FIGS. 12-1 and 12-2, in accordance with one or more embodiments of the present disclosure.

FIG. 23 is a 3D visualization of a wellbore showing various locations for placement of vibration or shock tools, in accordance with one or more embodiments of the present disclosure.

FIGS. 24-1 and 24-2 are plots of rate of penetration and downhole weight on bit, respectively, for multiple simulation scenarios using the locations of FIG. 23, in accordance with one or more embodiments of the present disclosure.

FIGS. 25-1 to 34-6 are plots of performance parameters for each of the simulation scenarios of FIGS. 24-1 and 24-2, in accordance with one or more embodiments of the present disclosure.

FIG. 35 is a 3D visualization of a wellbore showing locations for placement of multiple vibration or shock tools, in accordance with one or more embodiments of the present disclosure.

FIGS. 36-1 and 36-2 are plots of rate of penetration and downhole weight on bit, respectively, for multiple simulation scenarios by varying the locations of FIG. 35, in accordance with one or more embodiments of the present disclosure.

FIGS. 37-1 to 46-6 are plots of performance parameters for each of the simulation scenarios of FIGS. 36-1 and 36-2, in accordance with one or more embodiments of the present disclosure.

FIGS. 47-1 to 47-3 are plots of example wave or pulse interference for in-phase, out-of-phase, and partially in-phase waves or pulses, in accordance with one or more embodiments of the present disclosure.

FIG. 48 is a plot of example attenuation of flow pressure based on a separation distance, in accordance with one or more embodiments of the present disclosure.

FIGS. 49-1 and 49-2 are plots of rate of penetration and downhole weight on bit, respectively, for multiple simulation scenarios of distances between a shock tool and a vibration tool, in accordance with one or more embodiments of the present disclosure.

FIGS. 50-1 to 59-6 are plots of performance parameters for each of the simulation scenarios of FIGS. 49-1 and 49-2, in accordance with one or more embodiments of the present disclosure.

### DETAILED DESCRIPTION

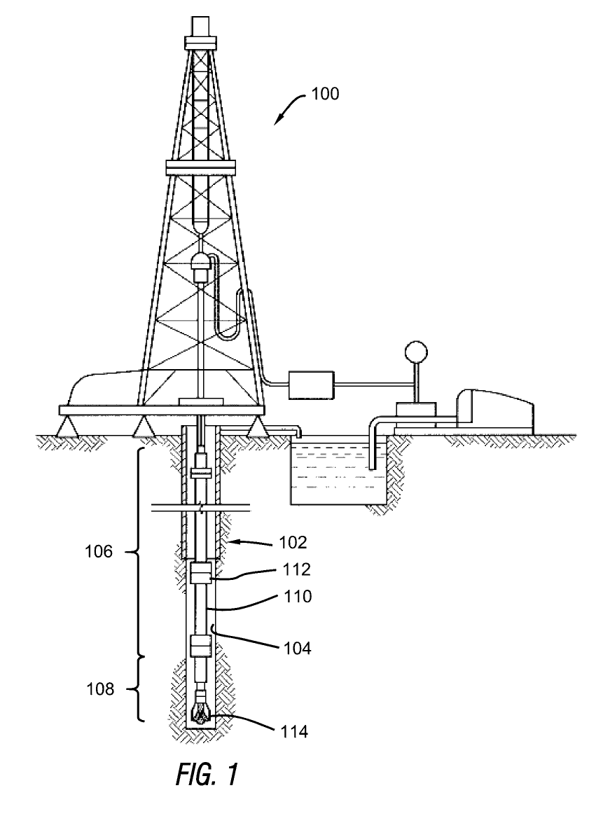

FIG. 1 illustrates an example of a drilling system for drilling an earth formation. The drilling system includes a drilling rig 100 used to turn a drilling tool assembly 102 that extends downward into a wellbore 104. The drilling tool assembly 102 includes a drill string 106, and a bottom hole assembly (BHA) 108, which is coupled to a distal end of the drill string 106. The distal end of the drill string 106 is the end furthest from the drilling rig 100.

The drill string 106 includes several joints of drill pipe 110 coupled end to end through tool joints 112. The drill string 106 may be used to transmit drilling fluid and/or to transmit rotational power from the drill rig 100 to the BHA 108. In some embodiments, the drill string 106 may further include additional components such as subs, pup joints, etc.

The BHA 108 may include a bit 114 and/or other components coupled to the drill string 106. Examples of additional BHA components include drill collars, transition drill pipe, stabilizers, measurement-while-drilling (MWD) tools, logging-while-drilling (LWD) tools, instrumented tools, subs, hole openers, reamers, jars, thrusters, downhole motors, vibration tools, anchors, whipstocks, and rotary steerable systems.

When drilling with the bit 114, rotational moment and axial forces may be applied to cause cutting elements of the bit 114 to cut into material and/or crush formation. The axial force applied on the bit 114 is referred to as the weight-on-bit (WOB). The rotational moment applied to the drilling tool assembly 102 at the drill rig 100 (e.g., by a rotary table or a top drive mechanism) to turn the drilling tool assembly 102, or downhole (e.g., by a mud motor or turbine drive) to turn the bit 114, is referred to as the rotary torque. Additionally, the speed at which the drilling tool assembly 102 and/or the bit 114 rotates, measured in revolutions per minute (RPM), is referred to as the rotary speed.

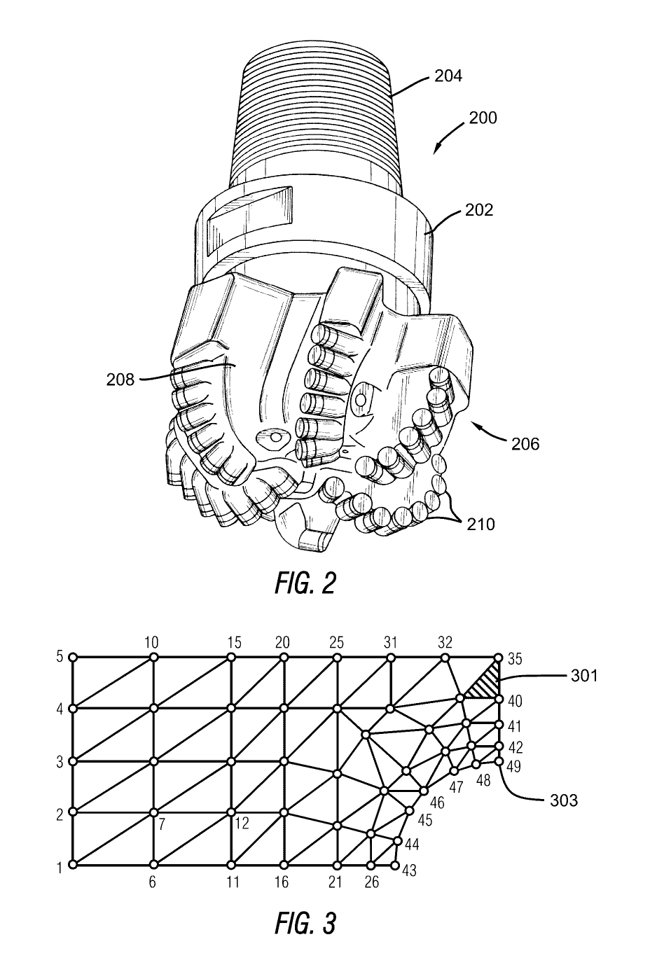

Drilling may include using a drill bit (e.g., bit 114, FIG. 1) to remove earth formation at a distal end of a wellbore (e.g., a vertical wellbore, a lateral borehole, a deviated borehole, etc.). Referring to FIG. 2, an example of a drill bit 200 known as a fixed-cutter bit is shown. The drill bit 200 has a bit body 202 having a threaded connection at one end 204 and a cutting head 206 formed at the other end. The cutting head 206 of the drill bit 200 includes, in this embodiment, multiple blades 208 arranged about a rotational axis of the drill bit 200, and extending radially outward from the bit body 202. Cutting elements 210 may be raised from the bit body 202 by, for instance, being embedded in, or otherwise coupled to, the blades 208 to cut formation as the drill bit 200 is rotated on a bottom surface of a wellbore. Cutting elements 210 of drill bits may include polycrystalline diamond compacts (PDC), other specially manufactured diamond cutters, cubic boron nitride (CBN) cutters, other cutting elements, or combinations of the foregoing. Drill bits that include PDCs may also be referred to as PDC bits or drag bits. Other types of drill bits that may be used include roller cone bits, impreg bits, hybrid bits, percussion hammer bits, or bi-center bits.

The design and manufacture of drilling and operating equipment is expensive. As such, in order to optimize performance, engineers may consider a variety of factors. For example, when selecting and/or designing a downhole assembly, engineers may consider a rock profile (e.g., the type of rock or the geologic characteristics of an earth formation), different forces acting on the downhole assembly, performance parameters, drill bit parameters, wellbore parameters, among many others. Without accurate models or simulations of downhole assemblies and how they operate in a given condition, however, engineers may not be provided with enough quantitative and substantial information to make an optimal or other choice for downhole assembly components and parameters. Comparisons of drill bit components as well as different drill bit parameters, wellbore parameters, and drilling operating parameters may therefore be helpful in determining the optimal downhole assembly to be used during a particular drilling operation.

Accordingly, embodiments disclosed herein provide systems, methods, tools, and techniques to model the behavior of various downhole assemblies under multiple conditions to achieve an optimal downhole assembly for a given drilling operation or other field or downhole operation. More particularly, one or more embodiments disclosed herein provide for methods of directly evaluating and/or comparing various downhole assemblies to determine which may be desired or whether an assembly operates in a suitable manner. Evaluations and comparisons may be performed by comparing a downhole assembly against selected criteria (e.g., rate of penetration (ROP), tool life, wellbore quality, vibrational profiles, etc.), or directly against another downhole assembly. In other embodiments, an engineer may make recommendations on which components to use in a downhole assembly (e.g., a vibration tool, a shock tool, an accelerator, etc.) in order to satisfy one or more criteria, and an iterative or other process may be performed to determine a desired, improved, or optimal combination of components, location of components, number of components, and the like. For sake of clarity, a number of definitions are provided below.

“Wellbore parameters” may include at least one of the geometry of a wellbore or the material properties of the formation (i.e., geologic characteristics). The trajectory of a wellbore in which the downhole assembly is to be confined may also be defined along with an initial wellbore bottom surface geometry. A wellbore trajectory may be straight (e.g., vertical, horizontal, or inclined), curved, or have a combination of straight and curved sections. As a result, wellbore trajectories, in general, may be defined by defining parameters for each segment of the traj ectory. For example, a wellbore may be defined as having N segments characterized by the length, diameter, inclination angle, azimuth direction, and any other characteristics of each segment, and an indication of the order of the segments (i.e., first, second, etc.).

Wellbore parameters defined in this manner may then be used mathematically to produce a model of a full and/or partial wellbore trajectory. Formation material properties at various depths along the wellbore may also be defined and used. One of ordinary skill in the art will appreciate in view of the disclosure herein that wellbore parameters may include additional properties, such as friction of the walls of the wellbore, casing and cement properties, and wellbore fluid properties, among others, without departing from the scope of the disclosure.

“Downhole assembly parameters” may include one or more of the following: the type, location, or number of components included in the downhole assembly; the length, internal diameter of components, outer diameter of components, weight, or material properties of each component; the type, size, weight, configuration, or material properties of the drilling tool assembly; or the type, size, number, location, orientation, or material properties of the cutting elements on the drilling tool assembly. Material properties in designing a downhole assembly may include, for example, the strength, elasticity, and density of the material. It should be understood that downhole assembly parameters may include any other configuration or material property of the downhole assembly without departing from the scope of the disclosure.

“Bit parameters,” which may be a subset of, or independent from, the downhole assembly, may include one or more of the following: bit type; size of bit; shape of bit; or cutting structures on the bit, such as cutting type, cutting element geometry, number of cutting structures, or location of cutting structures. As with other components in the drilling tool assembly, the material properties of the bit may be defined.

“Vibration tool parameters” may also be a subset of, or independent from, the downhole assembly parameters. Vibration tool parameters may include any combination of the size and geometry of the vibration tool. Other vibration tool parameters may include the location of the vibration tool along a drill string or within a wellbore, the distance between multiple vibration tools, the distance between the vibration tool and a bit (e.g., a drill bit or a mill), or the like. Vibration tool parameters may include characteristics of a pressure pulse (e.g., a fluid pulse) or other vibration generated by the vibration tool. The characteristics may include the amplitude, phase, frequency, direction (e.g., axial, lateral, torsional, etc.) of the pressure pulse or other vibration, among others.

“Shock parameters” may be a subset of, or independent from, the downhole assembly parameters. In some embodiments, shock parameters may be a subset of, or independent from, the vibration tool parameters. Shock parameters may include any combination of the size, geometry, and material properties of a shock tool (e.g., a shock sub). Shock parameters may include the type of shock tool (e.g., a shock sub, a jar, a shock component integrated on another tool, etc.). Other shock parameters may include the location of a shock tool along the drill string, the distance between the shock tool and other tools (e.g., distance from other shock tools, distance from vibration tools, etc.), or the distance between the shock tool and a bit. Shock parameters may include characteristics of a force pulse (e.g., an axial fluid pulse), generated by the shock tool or passed to the shock tool from another component. The characteristics may include the amplitude, magnitude, phase, and frequency of the pulse, among others.

“Drilling operating parameters” may include one or more of the following: the rotational speed of a drill string; the downhole motor speed (if a mud motor, turbine drive, or other downhole motor is used); or the hook load. Drilling operating parameters may further include drilling fluid parameters, such as the viscosity and density of the drilling fluid and pump pressure, for example. It should be understood in view of the disclosure herein that drilling operating parameters are not limited to these variables. In other embodiments, drilling operating parameters may include other variables (e.g., rotary torque and drilling fluid flow rate). Dip angle is the magnitude of the inclination of the formation from horizontal. Strike angle is the azimuth of the intersection of a plane with a horizontal surface. Additionally, drilling operating parameters for the purpose of drilling simulation may further include the total number of drill bit revolutions to be simulated, the total distance to be drilled, or the total drilling time desired for drilling simulation.

“Performance parameters” may include any combination of: ROP; rotary torque for turning the drilling tool assembly; rotary speed at which the drilling tool assembly is turned; downhole assembly lateral, axial, or torsional vibrations and accelerations induced during drilling; WOB; weight on reamer (WOR); forces acting on components of the downhole assembly; or forces acting on drilling tool assembly, the drill bit, or other components of the drill bit (e.g., on blades and/or cutting elements). Performance parameters may also include any combination of the torque along the downhole assembly, bending moment, alternative stress, percentage of fatigue life consumed, pump pressure, stick slip, whirl, dog leg severity, wellbore diameter, deformation, work rate, azimuth and inclination of the well, build up rate, walk rate, or bit wear. One skilled in the art will appreciate in view of the disclosure herein that other performance parameters exist and may be considered without departing from the scope of the disclosure.

In at least some downhole applications (including drilling, milling, fishing, cementing, etc.), the actual WOB or WOR may not remain constant. Some of the fluctuation in the force applied to the bit or reamer may be the result of the bit or reamer contacting with surfaces having harder and softer portions that break unevenly. Other fluctuations, however, may be attributed to downhole assembly vibrations. Downhole assemblies may extend more than a mile in length while being less than a foot in diameter. As a result, downhole assemblies may be relatively flexible along their length and may vibrate when rotated. Downhole assembly vibrations may also result from vibration of the bit, reamer, or other cutting component during a drilling, reaming, milling, or other downhole operation. Several modes of vibration are possible for downhole assemblies. In general, downhole assemblies may experience torsional, axial, and lateral vibrations. Although partial damping of vibration may result due to the viscosity of drilling fluid, friction of the drill pipe rubbing against the wall of the wellbore, friction of the casing rubbing against the wall of the wellbore, energy absorbed in drilling, and the downhole assembly impacting with the wellbore, these sources of damping may not be enough to suppress vibrations completely.

Vibrations, inconsistent WOB and WOR, and the like may be particularly relevant to drilling or other operational performance when working with directional wells. For successful directional operations, appropriate tools, fluids, and techniques are selected. Drill bits, mills, reamers, or similar cutting tools should be appropriate for the wellbore conditions and the materials to be removed or the operations to be performed. The fluids should be capable of removing drilled material or other cuttings or debris from the wellbore. Additionally, the techniques employed should be appropriate for the anticipated conditions in order to achieve operation objectives.

Accordingly, in one aspect, embodiments of the present disclosure provides a method of analyzing the performance of different downhole assemblies against pre-selected criteria, against one another, against data acquired in the field, or against any combination of the foregoing.

As used herein, a “drilling simulation” includes a dynamic simulation of a downhole assembly used in a downhole operation. The drilling simulation is referred to as being “dynamic” because the drilling is a “transient time simulation,” meaning that it is based on time or the incremental rotation of the drilling tool assembly. Methods for such simulations are known to the assignee of the current application, such as those disclosed in U.S. Pat. Nos. 6,516,293, 6,785,641, 6,873,947, 7,139,689, 7,464,013, 7,844,426, and 8,401,831, as well as U.S. Patent Publication Nos. 2004/0143427 and 2005/0096847, each of which is incorporated by this reference herein in its entirety.

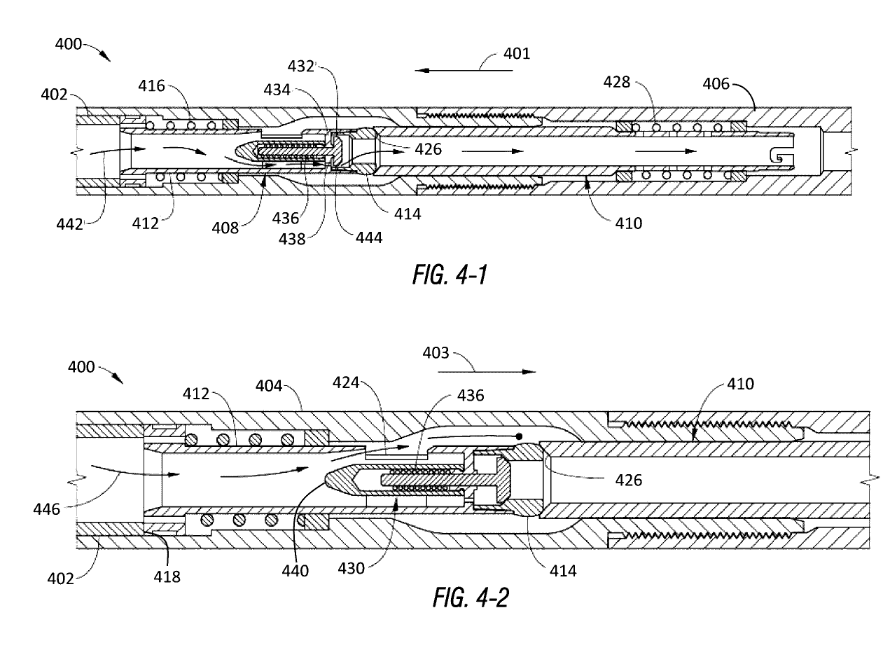

In one or more embodiments, as shown in FIG. 3, the downhole assembly may be modeled with beam elements (e.g., using finite element analysis (FEA) techniques). Briefly, FEA may involve dividing a body under study into a finite number of pieces (subdomains) called elements 301.

Particular assumptions are then made on the variation of the unknown dependent variable(s) across each element 301 using so-called interpolation or approximation functions. This approximated variation is quantified in terms of solution values at special element locations called nodes 303 (49 nodes are shown in FIG. 3). Through this process, the method for modeling sets up an algebraic system of equations for unknown nodal values that approximate the solution. Element size, shape, and approximating scheme can be varied to suit the problem; thus, the method can accurately simulate solutions to problems of complex geometry and loading.

For a MWD/LWD tool, for example, the tool may be divided into elements 301, based on the geometry of the tool and sensor locations. Each element 301 has two nodes 303, and the nodes 303 are located at the division points of the elements 301. During the simulation, drilling of the wellbore by the downhole assembly is simulated, and the wellbore propagates as the simulation progresses. The downhole assembly is confined in the wellbore. The downhole assembly moves dynamically during the simulation, depending on the loading and contacting conditions as well as initial conditions.

When the downhole assembly moves in the wellbore during the simulation, the nodes 303 will each have a history of accelerations, velocities, displacements, etc. The locations of the nodes 303 with reference to the wellbore center or other reference may be determined. Representative performance parameters that are produced by the simulation may include, accelerations, velocities, displacements, trajectory, torque, and contact force. Each of the performance parameters may be identified at a number of locations, including at the bit, along the drill string, at stabilizers, at vibration tools, at shock tools, or other locations. Any or each of these results may be produced in the form of one or more of time history, box and whisker plots, 2D or 3D animations, graphs, or pictures, among many others. In the same or other embodiments, results may be produced in the form of numeric or other raw data.

In one or more embodiments, the simulation may provide visual outputs of performance parameters. Further, the outputs may include tabular data of one or more performance parameters. In addition, the outputs may be in the form of: graphs, charts, and/or logs of a performance parameter; with respect to time; with respect to location along the downhole assembly or at any of its components; or with respect to number of rotations, for example.

Other plots or outputs may include presentation or visualization of the results at a minimum or maximum value, as an average value, or using any combination of the results disclosed herein. A graphical visualization of the downhole assembly, drill bit, drill string, drilling tools (e.g., a hole opener, a reamer, stabilizer, etc.), shock tools, vibration tools, and the like may also be output. A graphical visualization (e.g., 2D, 3D, or 4D) may, in some embodiments, include a color scheme for the downhole assembly and its components to indicate performance parameters at locations along the length of the downhole assembly.

For the purposes of calibrating the model and having a baseline for potential solutions, a drilling simulation may be performed using a previously used downhole assembly. For instance, the drilling operating parameters, wellbore parameters, performance parameters, or any combination of the foregoing, may be obtained from a particular field operation, and may be input for the previously used downhole assembly.

During a field operation, the trajectory of a wellbore may change. For example, the trajectory may change from a substantially vertically drilled wellbore to an inclined or even a substantially horizontally drilled wellbore (or vice versa). When drilling, the transition from vertical to inclined or horizontal drilling (or vice versa) is known as directional drilling. Directional drilling involves certain terms of art, which are presented herein for background information.

A method used to obtain the measurements to calculate and plot a 3D wellbore path is called a directional survey. In some embodiments, three parameters may be measured at multiple locations along the wellbore path—measure depth (MD), inclination, and hole direction. MD is the actual depth of the wellbore drilled to any point along the wellbore or the total depth as measured from the surface location. Inclination is the angle, measured in degrees, by which the wellbore or survey-instrument axis varies from a true vertical line. An inclination of 0° would be true vertical, and an inclination of 90° would be horizontal.

Hole direction is the angle, measured in degrees, of the horizontal component of the wellbore or survey-instrument axis from a known north reference. This reference may be true north, magnetic north, or grid north, and may be measured clockwise by convention. Hole direction may be measured in degrees and expressed in either azimuth (e.g., 0 to 360°), quadrant (e.g., Northeast (NE), Southeast (SE), Southwest (SW), Northwest (NW)), or other suitable form.

The build rate is the positive change in inclination over a normalized length (e.g., 3°/100 ft. or 0.00172 rad/m). A negative change in inclination is referred to as the drop rate. A long-radius horizontal wellbore may be characterized by build rates of 2 to 6°/100 ft. (0.00115 to 0.00344 rad/m), which result in a radius of 3,000 to 1,000 ft. (914 to 305 m), respectively. This profile may be drilled with directional-drilling tools. In some embodiments, lateral sections of up to 8,000 ft. (2,438 m) of a long-radius horizontal wellbore may be drilled.

Medium-radius horizontal wellbores may, in some embodiments, have build rates of 6 to 35°/100 ft. (0.00344 to 0.02004 rad/m), radii of 1,000 to 160 ft. (305 to 49 m), respectively, and lateral sections of up to 8,000 ft. (2,438 m). In at least some embodiments, medium-radius horizontal wellbores may be drilled with specialized downhole mud motors and/or conventional drill string components. Double-bend assemblies may be designed to build angles at rates up to 35°/100 ft. (0.02004 rad/m). In at least some embodiments, the lateral section may be drilled with conventional, proprietary, custom, or other steerable motor assemblies.

Short-radius horizontal wellbores may have build rates of 5 to 10°/3 ft. (0.095 to 0.191 rad/m), which equates to radii of 40 to 20 ft. (12 to 6 m), respectively. The length of the lateral section may vary, and in some embodiments may be between 200 and 900 ft. (61 and 274 m). Short-radius wellbores may be drilled with specialized drilling tools and techniques. In some embodiments, a short-radius horizontal wellbore profile may be drilled as a re-entry from any existing wellbore.

Particularly when drilling a long (250 ft. or 76 m) horizontal or inclined wellbore (which may or may not be a long-radius horizontal well), WOB may not effectively be transferred from the surface to the bit. This may be on account, for example, of the large horizontal distance and axial friction from the drill string within the deviated or horizontal portion of the wellbore. For instance, in a horizontal or inclined well, gravity may affect the drill string and pull the drill string toward the lower surface of the well, thereby increasing friction. In addition, as the length of a wellbore increases, the ROP of a drill bit may be reduced as WOB and/or surface RPM capabilities may not be sufficient in maintaining a specific ROP. Further, in long substantially horizontal wells, friction acting on the drill string, BHA, drill bit, other components of the drilling assembly, or combinations of the foregoing, may deleteriously affect the performance of the drilling operation and drill string and bit wear may be amplified. Of course, those having skill in the art will appreciate in view of the disclosure herein that many other conditions may affect the performance and/or drilling operation.

To attenuate or reduce friction, various tools may be used to induce a vibration, hammering effect, or reciprocation in a portion of or the entirety of the downhole assembly. For example, a vibration tool may be used to generate a force (e.g., an axial force, a lateral force, a torsional force) at a particular frequency and/or amplitude, causing a vibration that oscillates the downhole assembly and reduces friction. To generate the force, the vibration tool may be used to create and apply cyclical pressure pulses to the downhole assembly or any of components of the downhole assembly. In another example, the cyclical pressure pulses of the vibration tool may produce a water hammering effect, causing a vibration that oscillates the downhole assembly and reduces friction. Further, certain tools may use an external prime mover, such as a mud motor or turbine, in order to produce the cyclical pressure pulses.

Referring now to FIGS. 4-1 to 4-4, an example vibration tool 400 is shown in accordance with one or more embodiments. In one or more embodiments, one or more of the elements shown in FIGS. 4-1 to 4-4 may be omitted, repeated, or substituted. In other embodiments, the vibration tool 400 may be replaced or supplemented with other vibration tools. Accordingly, embodiments of the present disclosure should not be considered limited to the specific arrangements of elements shown in FIGS. 4-1 to 4-4.

FIGS. 4-1 to 4-4 are cross-sectional views of the vibration tool 400. In one or more embodiments, the vibration tool 400 may include an upper sub 402, an upper valve cylinder 404, a lower valve cylinder 406, and a lower sub (not shown). The upper sub 402 may be coupled to the upper valve cylinder 404, the upper valve cylinder 404 may be coupled to the lower valve cylinder 406, and the lower valve cylinder 406 may be coupled to the lower sub through the use of threads, bolts, welds, or any other attachment feature know to those skilled in the art.

The vibration tool 400 may also include an upper valve assembly 408 and a lower valve assembly 410. The upper valve assembly 408 may include an upper valve body 412 coupled to an upper valve seat 414. The upper valve assembly 408 may be oriented such that the upper valve body 412 is located uphole relative to the upper valve seat 414. The upper valve body 412 may be coupled to the upper valve seat 414 through the use of threads, bolts, welds, or any other attachment feature known to those skilled in the art.

The upper valve assembly 408 may also include an upper biasing mechanism 416. The upper biasing mechanism 416 may bias the upper valve assembly 408 in an uphole direction 401. In some embodiments, the upper biasing mechanism 416 may be coupled to the upper valve body 412. The upper biasing mechanism 416 may be a coiled spring, a Belleville washer spring, or any other biasing mechanism known to those skilled in the art.

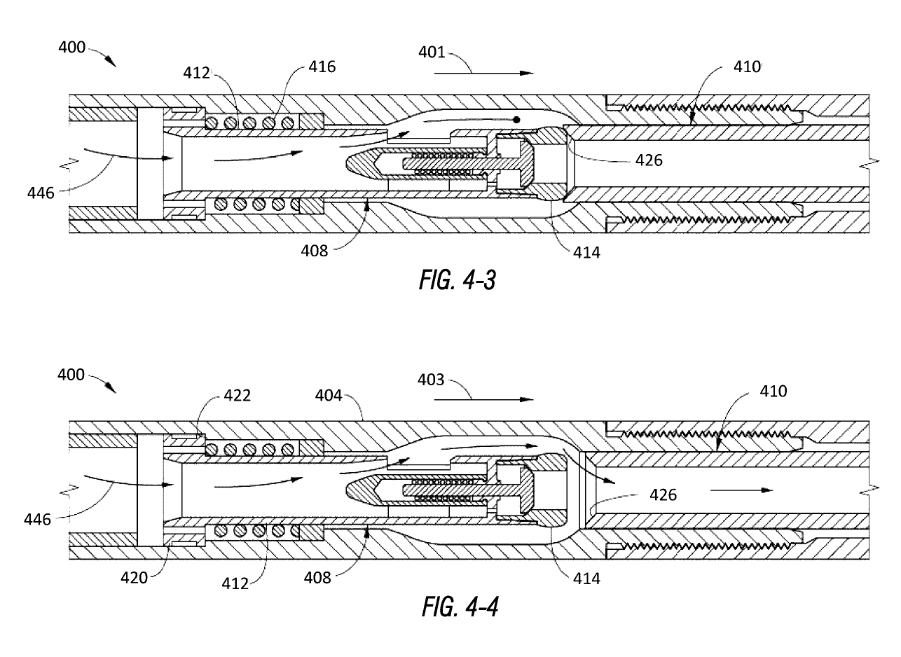

The upper biasing mechanism 416 may bias the upper valve assembly 408 into a first position in which the upper valve assembly 408 is seated against an upper shoulder 418. The upper shoulder 418 may be located within a bore of the upper valve cylinder 404. In some embodiments, the upper shoulder 418 may be formed by a downhole end of the upper sub 402. The upper valve body 412 may include a head section 420 (as shown in FIG. 4-4) having a greater outer diameter than at last some, and potentially the rest, of the upper valve body 412. When the upper valve assembly 408 is in the first position, an uphole side of the head section 420 may be seated against the upper shoulder 418.

Movement of the upper valve assembly 408 may also be limited by a lower shoulder 422. The lower shoulder 422 may be formed by a change in diameter of a bore of the upper valve cylinder 404. The upper valve assembly 408 may be in a second position when it is seated against the lower shoulder 422. In particular, a downhole side of the head section 420 may be seated against the lower shoulder 422 when the upper valve assembly 408 is in the second position. In some embodiments, a spacer may be coupled to the lower shoulder 422 to further limit movement of the upper valve assembly 408. The upper valve assembly 408 may also include a window 424 along the upper valve body 412, providing a channel from a bore of the upper valve body 412 to the bore of the upper valve cylinder 404.

The lower valve assembly 410 may include a lower valve seat 426 located at an uphole end of the lower valve assembly 410. The lower valve assembly 410 may also include a lower biasing mechanism 428, which may bias the lower valve assembly 410 in the uphole direction 401. The lower biasing mechanism 428 may be a coiled spring, a Belleville washer spring, or any other biasing mechanism known to those skilled in the art.

The lower biasing mechanism 428 may bias the lower valve assembly 410 into contact with the upper valve assembly 408 such that a seal may be created where the lower valve seat 426 meets the upper valve seat 414. In some embodiments, a metal-to-metal seal is formed where the lower valve seat 426 meets the upper valve seat 414.

An activation valve subassembly 430 may be within or coupled to the upper valve assembly 408. The activation valve subassembly 430 may include a plunger 432, an activation valve centralizer 434, an activation biasing mechanism 436, one or more flow path openings 438, and a diverter sleeve 440. In one or more embodiments, the upper biasing mechanism 416 may bias the upper valve assembly 408 into the first position. Additionally, the lower biasing mechanism 428 may bias the lower valve assembly 410 into contact with the upper valve assembly 408 such that a seal may be created where the lower valve seat 426 meets the upper valve seat 414.

A fluid flow 442 may pass from a bore of the upper sub 402 through the bore of the upper valve body 412. The fluid flow 442 may have a flow rate less than a predetermined threshold flow rate. The fluid flow 442 may include a flow of drilling fluid, drilling mud, or any other implementation known to those skilled in the art.

With the flow rate less than the predetermined threshold flow rate, the pressure pulse well tool 400 is placed in an inactive state. In the inactive state, the activation biasing mechanism 436 may bias the plunger 432 in the uphole direction 401 such that the plunger 432 may be seated against the activation valve centralizer 434. With the plunger 432 seated against the activation valve centralizer 434, the fluid flow 442 may pass through the one or more flow path openings 438 and through an annular restriction 444. The annular restriction 420 may be formed by an outer diameter of the plunger 432 and the bore of the upper valve seat 414. Using the seal created where the lower valve seat 426 meets the upper valve seat 414, the fluid flow 442 may pass from the bore of the upper valve seat 426 through a bore of the lower valve assembly 410.

FIG. 4-2 is a cross-sectional view of the vibration tool 400 in an active state, in accordance with one or more embodiments. As shown in FIG. 4-2, a fluid flow 446 may pass from the bore of the upper sub 402 through the bore of the upper valve body 412 at a flow rate greater than or equal to a predetermined threshold flow rate. The fluid flow 446 may include a flow of drilling fluid, drilling mud, or any other implementation known to those skilled in the art. With the flow rate greater than or equal to the predetermined threshold flow rate, a fluid pressure differential across the activation valve subassembly 430 may increase, such that the plunger 432 may overcome the activation biasing mechanism 436 and move in a downhole direction 403. The plunger 432 may move until forming a seal within the bore of the upper valve seat 414, placing the vibration tool 400 in an active state.

The predetermined threshold flow rate may be defined as a minimum flow rate used to move the plunger 432 to form the seal within the bore of the upper valve seat 414. In some embodiments, the predetermined threshold flow rate may be altered by increasing or decreasing a bias of the activation biasing mechanism 436. In other embodiments, the predetermined threshold flow rate may be altered by increasing or decreasing the size of the annular restriction 444.

In one or more embodiments, the predetermined threshold flow rate may range from 100 to 200 gallons per minute or gpm (6.3 to 12.6 L/s), from 125 to 175 gpm (7.9 to 11.0 L/s), or from 140 to 160 gpm (8.8 to 10.1 L/s). In some embodiments, the predetermined threshold flow rate may be equal to 150 gpm (9.5 L/s). In other embodiments, the predetermined threshold flow rate may be less than 100 gpm (6.3 L/s) or more than 200 gpm (12.6 L/s).

The seal formed by the plunger 432 may restrict the fluid flow 446 from passing through the upper valve assembly 408. In particular, the fluid flow 446 may lack a fluid path from the bore of the upper valve body 412 to the bore of the lower valve assembly 410. The fluid flow 446 may then instead pass from the bore of the upper valve body 412 through the window 424. The fluid flow 446 may then deadhead in the bore of the upper valve cylinder 404 surrounding the seal created by the lower valve seat 426, meeting the upper valve seat 414. In turn, a fluid pressure may increase across the upper valve body 412, which may lead to an increase in a pressure force acting on the upper valve assembly 408 and an increase in a pressure force acting on the lower valve assembly 410.

FIG. 4-3 is a cross-sectional view of the vibration tool 400 in the active state in accordance with one or more embodiments. As shown in FIG. 4-3, the upper valve assembly 408 may move away from the first position in the downhole direction 403 due to a momentum of the fluid flow 446 and the pressure force acting on the upper valve assembly 408, overcoming the upper biasing mechanism 416.

Further, the lower valve assembly 410 may overcome the lower biasing mechanism 428 and move in conjunction with the upper valve assembly 408 in the downhole direction 403 due to the momentum of the fluid flow 446, the pressure force acting on the upper valve assembly 408, and the pressure force acting on the lower valve assembly 410. The seal where the lower valve seat 426 meets the upper valve seat 414 may be maintained while the upper valve assembly 408 and the lower valve assembly 410 move in the downhole direction 403.

FIG. 4-4 is a cross-sectional view of the vibration tool 400 in the active state in accordance with one or more embodiments. As shown in FIG. 4-4, the upper valve assembly 408 may move in the downhole direction 403 until reaching the second position, where the head section 420 of the upper valve body 412 may be seated against the lower shoulder 422. When the upper valve assembly 408 reaches the second position, the movement of the upper valve assembly 408 in the downhole direction 403 may be arrested. At this position, the pressure force acting on the lower valve assembly 410 may continue to move the lower valve assembly 410 in the downhole direction 403. In turn, the lower valve assembly 410 may separate from the upper valve assembly 408, breaking the seal where the lower valve seat 426 meets the upper valve seat 414. The fluid flow 446 may then pass from the bore of the upper valve cylinder 404 to the bore of the lower valve assembly 410. As the fluid flow 446 passes through the bore of the lower valve assembly 410, the fluid pressure across the upper valve body 412 may then decrease.

The fluid pressure across the upper valve body 412 may be relieved, leading to a decrease in the pressure force acting on the upper valve assembly 408 and a decrease in the pressure force acting on the lower valve assembly 410. In turn, the upper biasing mechanism 416 may overcome the pressure force acting on the upper valve assembly 408 and bias the upper valve assembly 408 back to the first position such that the head section 420 of the upper valve body 412 may be seated against the upper shoulder 418. In other embodiments, the upper biasing mechanism 416 may bias the upper valve assembly 408 in the uphole direction 401 to a position proximate to the first position such that the head section 420 may be at a distance from the upper shoulder 418.

Further, the lower biasing mechanism 428 may overcome the pressure force acting on the lower valve assembly 410 and begin to move the lower valve assembly 410 in the uphole direction 401. In some embodiments, the upper valve assembly 408 may return to the first position before the lower biasing mechanism 428 biases the lower valve assembly 410 into contact with the upper valve assembly 408. Thus, the upper valve assembly 408 may return to the first position before the seal, where the lower valve seat 426 meets the upper valve seat 414, is recreated.

In one or more embodiments, the lower biasing mechanism 428 may bias the lower valve assembly 410 into contact with the upper valve assembly 408 such that the seal where the lower valve seat 428 meets the upper valve seat 414 may be recreated. Further, with the flow rate of the fluid flow 446 greater than or equal to the predetermined threshold flow rate, the vibration tool 400 may remain in the active state. The fluid pressure may again increase across the upper valve body 412, which may cause the vibration tool 400 to again operate as described with respect to FIGS. 4-1 to 4-4. In operating as described herein, the vibration tool 400 may produce a cyclical increase and decrease in fluid pressure across the upper valve assembly 408.

The vibration tool 400 may generate pressure pulses which vary in amplitude. The variance in amplitude may depend on any number of different factors or conditions. For instance, the amplitude may vary based on the physical dimensions of components of the vibration tool, the fluid flow rate, the mud weight of the fluid, or other factors. In one or more embodiments, the pressure pulses may vary in amplitude by 200-350 psi (1.4-2.4 MPa), although the variation may be less than 200 psi (1.4 MPa) or greater than 350 psi (2.4 MPa) in other embodiments. Further, in one or more embodiments, the vibration tool 400 may generate pressure pulses at a rate of 5-60 Hz. In some embodiments, the vibration tool 400 may generate pressure pulses at a rate of 5-25 Hz, at a rate of 10-20 Hz, at a rate of 15 Hz, or at a rate of 40 Hz. In other embodiments, the pressure pulses may be generated at a rate of less than 5 Hz or greater than 60 Hz.

The cyclical increase and decrease in fluid pressure across the upper valve assembly 408 of the vibration tool 400, may be applied to tools which use pressure pulses. For example, in combination with, or independent from, a vibration tool (e.g., vibration tool 400 in FIGS. 4-1 to 4-4), a shock tool may optionally be used to reduce impact and vibration of the downhole assembly by dampening the variable dynamic loads produced by the drill bit, BHA, or other components during drilling operations. Reducing the impact loads may lead to an increase in productivity by extending the life of the bit, increasing ROP, and lowering cost of drilling per foot.

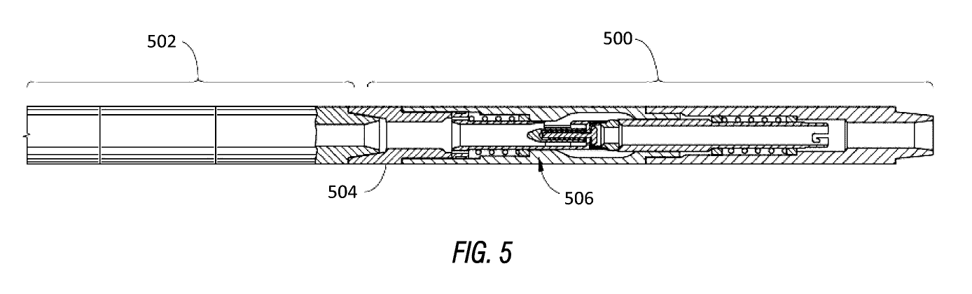

Referring now to FIG. 5, a cross-sectional view of a vibration tool 500 and a shock tool 502 is shown in accordance with one or more embodiments. In one or more embodiments, one or more of the elements shown in FIG. 5 may be omitted, repeated, or substituted. Accordingly, embodiments of the present disclosure should not be considered limited to the specific arrangements of elements shown in FIG. 5.

In one or more embodiments, the vibration tool 500 may be coupled directly or indirectly to, a shock tool 502. In some embodiments, the vibration tool 500 and the shock tool 502 may be part of a downhole assembly for use in wellbore operations (e.g., drilling, milling, fishing, cementing, etc.). The shock tool 502 may be uphole relative to the vibration tool 502. In other embodiments, the shock tool 502 may be downhole relative to the vibration tool 500. The upper sub 504 of the vibration tool 500 may be coupled to a downhole end of the shock tool 502 through the use of threads, bolts, welds, other downhole tool components, or any other attachment feature known to those skilled in the art.

The cyclical increase and decrease in fluid pressure across the upper valve assembly 506 of the vibration tool 500 may produce pressure pulses. The pressure pulses may travel through the upper sub 504. From the upper sub 504, the pressure pulses may be applied to the shock tool 502. In turn, the application of the pressure pulses may generate force pulses within the shock tool 502. The force pulses produced within the shock tool 502 may reduce impact and vibration along at least a portion of the downhole assembly. In some embodiment, the shock tool 502 may amplify or otherwise alter the pressure pulses.

The vibration tool 500 may be used without a shock tool (e.g., in coil tubing applications). In such embodiments, the pressure pulses produced by the vibration tool 500 may generate a water hammering effect, such that the pressure pulses may cause a vibration that travels up and down a downhole assembly. In turn, the vibration may oscillate the downhole assembly and reduce friction.

In one or more embodiments, during drilling or other downhole operations, the shock tool 502 may be configured to absorb energy. For instance, the shock tool 502 may use a Belleville spring, friction, hydraulic fluid, or other components to absorb energy generated by any number of components or interactions within a drilling system. In some embodiments, the shock tool 502 may be configured to compress or relax in order to absorb pressure pulses or other loads. Pressure pulses generated by the vibration tool 500, for instance, may be used to generate force pulses within the shock tool 502. The force pulses produced within the shock tool 502 may cause vibration (e.g., an axial vibration) which oscillates the downhole assembly. As the downhole assembly oscillates, friction may be reduced between the downhole assembly and the wellbore, casing, and the like, thereby increasing the efficiency of a drilling or other downhole operation. For example, when the shock tool 502 is used with the vibration tool 500, weight transfer may be more consistently applied, resulting in a more consistent WOB and higher ROP. Other results may also be achieved during operation.

In one or more embodiments, the vibration tool 500 and/or the shock tool 502 may be coupled to a drill string or other tubular for use in drilling a wellbore. Some embodiments contemplate multiple shock tools and/or vibration tools in a downhole assembly. In one or more embodiments, the vibration tool 500 may be placed along a downhole assembly in a vertical, horizontal, or directional orientation. Similarly, the shock tool 502 may be placed along a downhole assembly in a vertical, horizontal, or directional orientation. Additional vibration tools 500 and/or shock tools 502 may also be positioned at other positions and vertical, horizontal, or directional orientations.

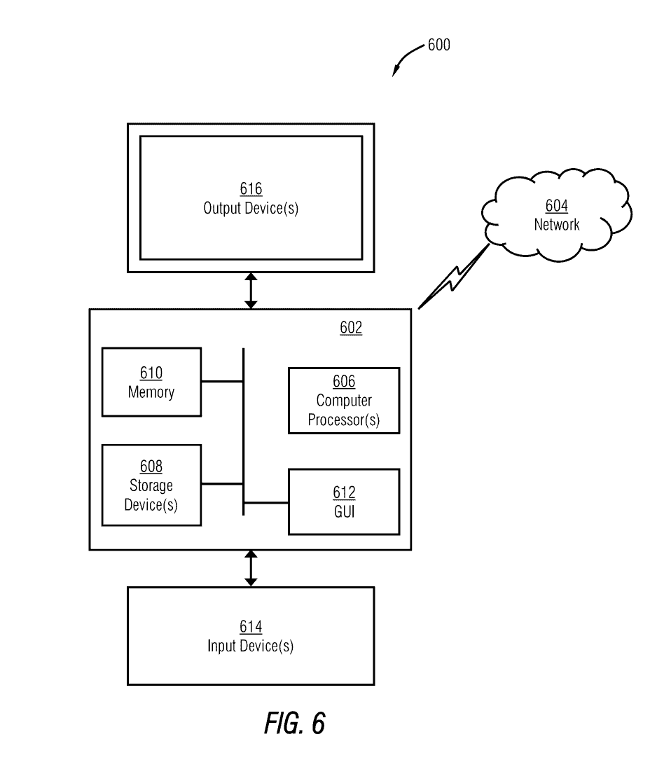

FIG. 6 schematically illustrates an example system 600 which may be used to select, design, optimize, simulate, or otherwise interact with a downhole assembly, according to one or more embodiments of the present disclosure. In one or more embodiments, one or more of the modules and/or elements shown in FIG. 6 may be omitted, repeated, or substituted. Other modules and/or elements may further be added. Accordingly, embodiments of the present disclosure should not be limited to the specific arrangements of modules shown in FIG. 6.

The system 600 may include a computing device 602, which may include one or more computer processors 606 (e.g., a central processing unit (CPU), a graphics processor, etc.), one or more storage devices 608 (e.g., hard disks, optical drives such as a compact disk (CD) drive or digital versatile disk (DVD) drive, solid state storage, etc.), memory 610 (e.g., random access memory (RAM), cache memory, flash or solid state memory, etc.), a graphical user interface (GUI) 612, other components, or any combination of the foregoing.

A computer processor 606 may be an integrated circuit for processing instructions. For example, a computer processor may include one or more cores or micro-cores. Storage devices 608 and/or memory 610 (and/or any information stored therein) may be a data store such as a database, a file system, one or more data structures (e.g., arrays, link lists, tables, hierarchical data structures, logical data structures, network data structures, etc.) configured in a data store or memory, an extensible markup language (XML) file, any other suitable medium for storing data, or any suitable combination thereof The storage devices 608 may be internally or peripherally coupled to the computing device 602. The computing device 602 may include numerous additional other elements and functionalities.

The computing device 602 may be communicatively coupled to a network 604 (e.g., a local area network (LAN), a wide area network (WAN) such as the Internet, mobile network, or any other type of network). The connection between the computing device 602 and the network may be provided through one or more wires, cables, fibers, optical connectors, wireless connections, or network interface connections.

In some embodiments, the system 600 may also include one or more input devices 614. Example input devices 614 may include a touchscreen, keyboard, mouse, microphone, touchpad, electronic pen, biometric reader, camera, or any other type of input device. Further, the system 600 may include one or more output devices 616. Example output devices 616 may include a screen (e.g., a liquid crystal display (LCD), a plasma display, touchscreen, cathode ray tube (CRT) monitor, projector, 2D display, 3D display, or other display device), a printer, internal storage, external storage, or any other output device. One or more of the output devices 616 may be the same or different from the input devices 614. The input and output devices 614, 616 may be locally or remotely (e.g., via the network 604) coupled to one or more of the computer processors 606, memory 610, storage devices 608, or GUI 612. Further, although the output devices 616 are shown as being communicatively coupled to the computing device 602, the output devices 616 may be a component of the computing device 602. Many different types of systems exist, and the input and output devices 614, 616 may take other forms.

Further, one or more elements of the system 600 may be located at a remote location and coupled to the other elements over the network 604. Further, embodiments of the disclosure may be implemented on a distributed system having a plurality of nodes, where one or more portions (and potentially each portion) of the system 600 may be located on a different node within the distributed system. In one or more embodiments of the disclosure, a node corresponds to a distinct computing device. In another embodiment, a node may correspond to a computer processor optionally having associated physical memory. In another embodiment, a node may correspond to a computer processor or micro-core of a computer processor with shared memory and/or resources.

The GUI 612 may be operated by a user (e.g., an engineer, a designer, an operator, an employee, or any other entity) using one or more input devices 614, and the GUI 612 may be visualized using one or more output devices 616 coupled to the computing device 602. In some embodiments, the GUI 612 may include one or more buttons (e.g., radio buttons), data fields (e.g., input fields), banners, menus (e.g., user input menus), boxes (e.g., input or output text boxes), tables (e.g., data summary tables), sections (e.g., informational sections or sections capable of minimizing/maximizing), screens (e.g., welcome screen or home screen), user selection menus (e.g., drop down menus), other features, or any combination of the foregoing. Optionally, the GUI 612 may include one or more separate interfaces, may be usable in a web browser, may be used as a standalone application, may be distributed over a variety of computing devices (e.g., in a software-as-a-service or cloud-computing environment), or otherwise configured.

In one or more embodiments, the computing device 602 may be capable of simulating, designing, optimizing, or selecting a downhole assembly. In some embodiments, designing, optimizing, or selecting a downhole assembly may each include or be based on a simulation of the downhole assembly. In at least some embodiments, the downhole assembly to be simulated may be selected, by a user, from a pre-existing library of downhole assemblies (e.g., stored on memory 610 or accessible over the network 604) or a downhole assembly may be customized, by the user, using the GUI 612 and/or input devices 614 of the computing device 602.

The user may customize the downhole assembly by inputting or selecting a variety of drilling components. In one or more embodiments, the user may select one or more vibration tools and/or one or more shock tools to be included in the downhole assembly. Additional or other components may also be selected by the user via the GUI 612. The user may also customize a number of parameters associated with each of the selected components, including any vibration tools or shock tools. For example, the user may define or modify a distance between a selected vibration tool or shock tool with respect to a drill bit or other component of the downhole assembly. Further, the user may also define or modify a distance between a vibration tool and a shock tool.

In some embodiments, the simulation may be further customized by inputting or selecting a variety of wellbore parameters and/or drilling operating parameters. To modify the downhole assembly and/or customize the downhole assembly simulation, the user may access storage devices 608 or network 604 using input devices 614, or any other suitable input mechanisms. The storage devices 608 may be capable of having data stored thereon, and the network 604 may be capable of having data accessible therethrough. Data accessed from the storage devices 608 and/or the network 604 may include, for example, rock profiles, downhole assembly parameters and components, drilling operating parameter, wellbore parameters, other parameters, or any combination of the foregoing. Once the user selects a pre-existing downhole assembly or customizes the downhole assembly and defines other parameters (e.g., wellbore parameters, downhole assembly parameters, bit parameters, vibration tool parameters, shock parameters, drilling operating parameters), the computing device 602 may use the computer processors 606 to execute computer-executable instructions to perform a simulation based on the selected and/or customized downhole assembly and the parameters (e.g., wellbore parameters, downhole assembly parameters, bit parameters, vibration tool parameters, shock parameters, drilling operating parameters) selected or input by the user. The computer-executable instructions executed by the computer processors 606 may be stored on the storage devices 608, the memory 610, the computer processors 606, or accessed via the network 604.

In some embodiments, the downhole assembly may be selected for simulation or modified based on data input or selected by the user. The user may also modify a downhole assembly based on particular drilling operating parameters, wellbore parameters, vibration tool parameters, shock parameters, or any other parameters known in the art or disclosed herein. The user may determine a desired WOB or ROP and may modify the downhole assembly accordingly taking into account the desired WOB and/or ROP, among others, using the GUI. The user may also refer to results of a previous simulation to modify the downhole assembly and perform a simulation to determine the effect the modifications have on the performance parameters or operation of the downhole assembly.

Once the user customizes the downhole assembly and/or other parameters (e.g., wellbore parameters, downhole assembly parameters, bit parameters, vibration tool parameters, shock parameters, drilling operating parameters), the computing device 602 may execute instructions using one or more computer processors 606, and perform a simulation based on the customized downhole assembly and the parameters selected or input by the user. The simulation may be performed using one or more of the methods set forth herein. Executing the simulation may generate a set of performance parameters. In some embodiments, a set of performance parameters may be generated and may depend on the parameters selected or input by the user. The simulation may include instructions to generate specific performance parameters, as mentioned herein. In other embodiments, the executed simulation may generate one or more performance parameters including, but not limited to, ROP, surface weight on bit (SWOB), downhole weight on bit (DWOB), axial velocity, axial friction force, axial acceleration, lateral acceleration, bit or other tool rotations per minute (RPM), among many others. The one or more performance parameters may also be generated for various locations of the downhole assembly, drill string, BHA, or any other components. For instance, each performance parameter may be an array with values for various locations or components of the downhole assembly.

After simulation, the ROP, SWOB, DWOB, or other performance parameters may then be visualized by the GUI 612 on one or more output devices 616. In some embodiments, the visual outputs may include tabular data of one or more performance parameters. In the same or other embodiments, the outputs may be in the form of plots or graphs and may be represented as percentages or ratios.

Once presented with one or more performance parameters by the GUI 612 and/or output devices 616, the user may modify at least one vibration tool parameter, shock parameter, downhole assembly parameter, wellbore parameter, drilling operating parameter, bit parameter, or any other parameter used in performing a simulation of the downhole assembly. Modification may involve selecting a parameter from pre-existing values or inputting the parameter to obtain a modified value. Pre-existing values may depend on manufacturing capabilities or geometries of the components of the downhole assembly or its components (e.g., the vibration tool, shock tool, bit, stabilizers, drill string, etc.), configurations and features of existing tools and inventory, or any number of other parameters.

After modification of one or more parameters, a second simulation may be executed by the computing device 602. The second simulation may include the modified parameter and selected downhole assembly and its components. The simulation may be executed by the computing device 602 using the computer processors 606 to generate a second set of performance parameters. The simulation may be performed using one or more of the methods set forth herein. In some embodiments, after or during the second simulation, the second set of performance parameters generated may be presented using the GUI 612 and/or one or more output devices 616. The second set of performance parameters may be presented with the initial set of performance parameters to the user for comparison, separately from the first set of performance parameters, or in other manners. The first and second sets of performance parameters may be presented or visualized using any suitable tools, such as, for example, plots, graphs, charts, and logs.

In some embodiments, a second simulation may occur simultaneously with the first simulation. For example, a user may select a number of downhole assemblies with various configurations of at least one of a vibration tool, shocks sub, bit, stabilizer, or any other component to be simulated with particular wellbore and drilling operating parameters (or different wellbore and drilling operating parameters). The system 600 may perform a number of simulations in parallel or in series. The resulting performance parameters may be compared to one another by the user, by the computing system 602, or a combination of the foregoing. Furthermore, the simulation and thus, the comparison, may be done in real-time. More specifically, the system may perform a number of simulations for given parameters and observe performance as the simulation progresses. In some embodiments, differences or other variations between performance parameters may be output using the GUI 612 and/or the output devices 616.

Furthermore, field parameters may be acquired and/or measured in the field. The performance parameters from one or more simulations may be compared to one or more field acquired/measured parameters. For instance, the field acquired/measured parameters may be obtained before or after a simulation is performed. The performance parameters of the simulation may be compared to the field acquired/measured parameters and may optionally be used to calibrate the simulation. For instance, parameters (e.g., wellbore parameters, downhole assembly parameters, bit parameters, vibration tool parameters, shock parameters, drilling operating parameters) may be manually or automatically altered to produce a simulation that more closely matches field acquired/measured parameters.

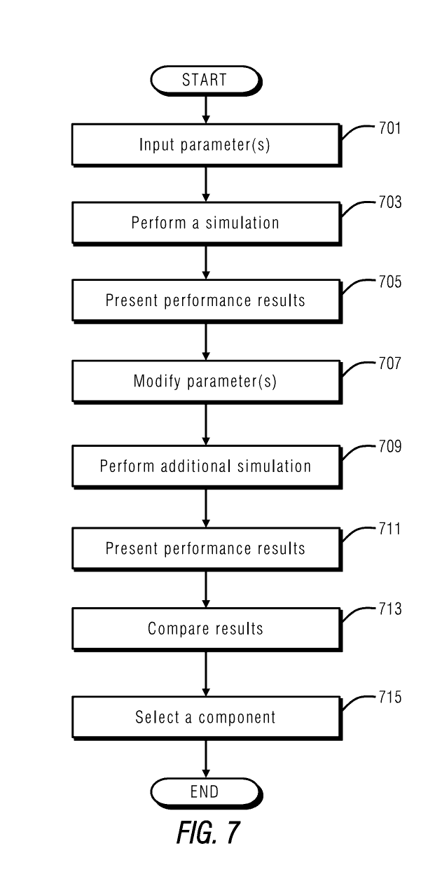

Referring now to FIG. 7, a method for simulating a downhole assembly in accordance with one or more embodiments of the present disclosure is shown. In one or more embodiments, one or more of the elements of the method shown in FIG. 7 may be omitted, repeated, substituted, or performed in a different order. Accordingly, embodiments of the present disclosure should not be considered limited to the specific arrangements of elements of the method shown in FIG. 7.

As shown in FIG. 7, some embodiments contemplate inputting parameters in 701. The parameters that are input may include one of wellbore parameters, downhole assembly parameters, bit parameters, vibration tool parameters, shock parameters, or drilling operating parameters, among others. The parameters may be input by a user using a GUI (e.g., GUI 612 in FIG. 6), input devices, or the like. The parameters may also be associated with any number of different downhole assembly components such as drill pipes and/or collars, transition pipe, stabilizers, downhole motors, and bits, for example.

In one or more embodiments, to setup simulation, input parameters (e.g., wellbore parameters, downhole assembly parameters, bit parameters, vibration tool parameters, shock parameters, drilling operating parameters) may be selected by a user from a library of pre-determined values, manually determined by the user, related to measured/acquired field parameters, or any combination of the foregoing. In some embodiments, during input of the parameters, or after parameters are input, a display showing the input parameters may be shown on a GUI (e.g., GUI 612 in FIG. 6). The display may include any of the input parameters and/or any component of the downhole assembly. In some embodiments, the input parameters may be capable of modification by the user. For example, using the GUI, a user may move, remove, drag, drop, add, or otherwise interact with the input parameters and the components of the downhole assembly to setup the simulation.

After parameters are input, the downhole assembly may be simulated in 703. The simulation may dynamically simulate the downhole assembly based on the parameters input in 701. After simulation, a number of performance parameters may be generated. The simulation may visualize the performance parameters on a GUI (e.g., GUI 612 in FIG. 6) in 705. In one or more embodiments, a number of performance parameters may be reviewed by a user. Optionally, one or more parameters may be modified in 707. The modified parameters may include at least one of wellbore parameters, downhole assembly parameters, bit parameters, vibration tool parameters, shock parameters, drilling operating parameters, among others. In the same or other embodiments, modifying the parameters in 707 may include the user selecting another downhole assembly or component, or other set of parameters. In still other embodiments, the simulation system (e.g., system 600 of FIG. 6) may be automated to iteratively or otherwise modify different wellbore parameters, downhole assembly parameters, bit parameters, vibration tool parameters, shock parameters, drilling operating parameters, and the like. Regardless of the manner in which parameters are modified in 707, an additional simulation may be simulated in 709 using the modified parameters. In at least some embodiments, the additional simulation performed in 709 may use the same wellbore parameters and/or operating parameters, with modifications to one or more of downhole assembly parameters, vibration tool parameters, bit parameters, shock parameters, or other parameters.

More particularly, modification of parameters in 707 may involve changing the value of one or more parameters based on a comparison of the performance parameters and/or a given criterion. For example, a user may want to achieve a particular ROP or DWOB, so as to maintain a drilling schedule. If the performance parameter does not meet a particular threshold or criterion (e.g., if the ROP is lower than desired), the user may modify one or more parameters (e.g., wellbore parameters, downhole assembly parameters, bit parameters, vibration tool parameters, shock parameters, drilling operating parameters), in order to obtain a modified parameter. In the same or other embodiments, should a modification to one or more parameters result in a more favorable performance parameter, a user may select that particular downhole assembly and its components along with the modified parameters.

The performance parameters generated from the additional simulation performed in 709 may be presented for review in 711. A user may then compare multiple simulations in 713. In other embodiments, a system (e.g., system 600 of FIG. 6) may be programmed or otherwise configured to automate comparisons in 713. Optionally, the system may also act as an expert system to select a downhole assembly and/or components based on the comparisons in 713. As noted herein, simulations may be performed simultaneously and their corresponding performance parameters may be observed and compared in 713 as simulation progresses. In other embodiments, simulations may be performed sequentially, and their performance parameters may be observed and compared in 713 as the additional simulation progresses, or upon completion of the additional simulation. Such processes may be repeated for any number of downhole assemblies, components, or parameters until a downhole assembly and/or components (e.g., bit, vibration tool, shock tool, etc.) has been selected in 715. Thus, aspects of the method of FIG. 7 may be performed iteratively. The downhole assembly and/or components may be selected based on any number of performance parameters. For example, the downhole assembly and/or components may be selected based on a quality of wellbore that each simulation outputs, a given criteria or threshold to be satisfied (e.g., ROP, tool life, maximum vibration, etc.), any other criteria, or a combination of the foregoing.

As mentioned above, parameters may be input by a user and/or displayed on a GUI (e.g., GUI 612 in FIG. 6) to set-up simulation. Referring now to FIGS. 8-1 to 8-3, a setup of input parameters in accordance with one or more embodiments of the present disclosure is shown. In one or more embodiments, one or more of the elements shown in FIGS. 8-1 to 8-3 may be omitted, repeated, substituted, or input in any order. Accordingly, embodiments of the present disclosure should not be considered limited to the specific arrangements of elements shown in FIGS. 8-1 to 8-3.

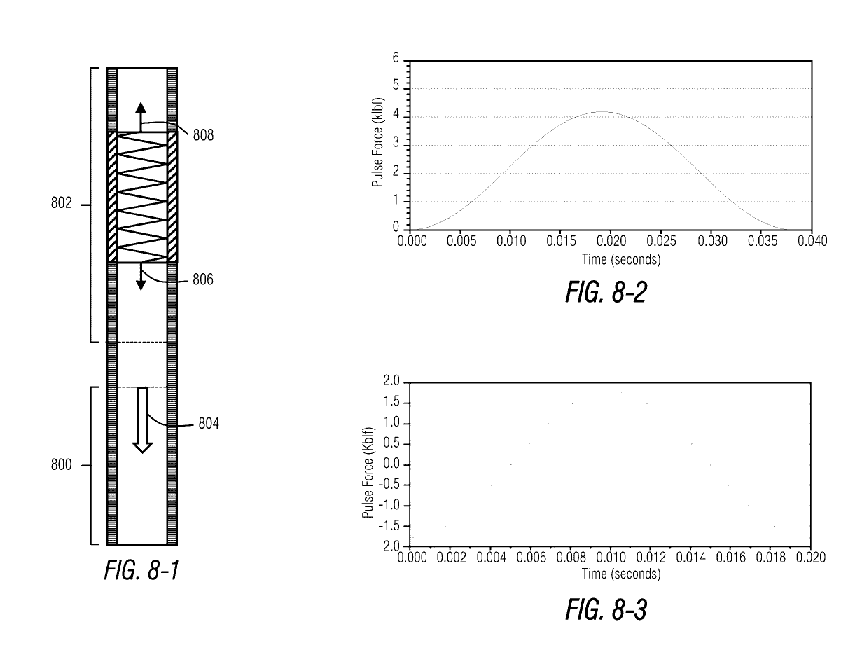

In FIG. 8-1, a model of a vibration tool 800 and a shock tool 802 is shown and may be displayed on a GUI. As described herein, vibration tool parameters and shock parameters, or other parameters (e.g., wellbore parameters, bit parameters, etc.) may be input, displayed, or modified, to set-up a simulation. As shown in FIG. 8-1, a model of an input vibration tool 800 is shown generating a force or downward pressure pulse 804 (i.e., along a longitudinal axis of a downhole assembly). In some embodiments, the vibration tool 800 may be oriented such that the pressure pulse is generated in the direction of drilling, such as during drilling of a horizontal well. In other embodiments, the vibration tool 800 may be oriented to generate the pressure pulse in an upward or other direction. For instance, a lateral or torsional pressure pulse may be generated, or the pressure pulse may be generated in a direction inclined relative to, or in an opposite direction from, the direction of drilling. In some embodiments, pressure pulses may be generated in multiple directions (e.g., in upward/uphole and downward/downhole directions).

In some embodiments, the shock tool 802 may oscillate and/or generate force pulses in one or more directions. As shown, shock tool 802 may generate a downward force pulse 806 and an upward force pulse 808. Pulse characteristics (e.g., amplitude, frequency, period, phase, among other shock parameters) of the downward force pulse 806, the upward force pulse 808, and the downward pressure pulse 804 generated by the vibration tool 800, or any other pulse to setup simulation may be input by a user, using a GUI for example.

Referring now to FIG. 8-2, the downward force pulse 806 and the upward force pulse 808 are plotted as a function of time. In some embodiments, the plot may be obtained using data input by a user. In the illustrated embodiment, the plot includes a force pulse having amplitude of about 4.2 kip (18.7 kN) and a period of 0.04 seconds. The downward force pulse 806 and the upward force pulse 808 may have the same pulse characteristics (as shown in FIG. 8-2); however, the downward force pulse 806 and the upward force pulse 808 may be different and, as mentioned above, shock parameters such as amplitude, frequency, period, phase, among many others may be input by a user using a GUI, for example.

Referring now to FIG. 8-3, the pressure pulse 804 is plotted as a function of time. In this embodiment, the force pulse may have an amplitude of about 3.6 kip (16.0 N) and a period of 0.02 seconds. One of ordinary skill would appreciate that the pressure pulse 804 may vary and may be different from the downward force pulse 806 and the upward force pulse and, as mentioned above, shock parameters such as amplitude, frequency, period, phase, among many other parameters may be input by a user using a GUI, for example.

Referring now to FIGS. 9-1 to 9-3, further example input parameters for a downhole assembly and its components to set-up a simulation are shown. In one or more embodiments, one or more of the elements of shown in FIGS. 9-1 to 9-3 may be omitted, repeated, substituted, or input in any order. Accordingly, embodiments of the present disclosure should not be considered limited to the specific arrangements of elements shown in FIGS. 9-1 to 9-3.

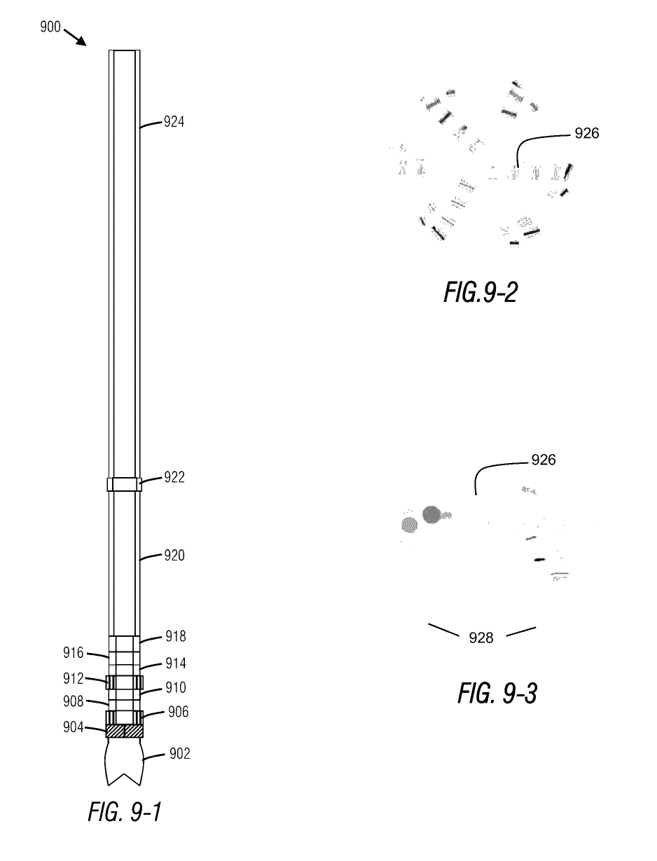

In FIG. 9-1, a BHA 900 of a downhole assembly may be input and displayed on a GUI, for example. The BHA 900 may include a number of components. As shown, the BHA includes a bit 902, a motor 904, a stabilizer 906, a MWD/LWD tool 908, a battery 910, a second stabilizer 912, a connector 914, a filter sub 916, a tool joint 918, a pipe section 920, a vibration tool 922, and a second pipe section 924. For each component, a number of parameters may be input by the user. For instance, the size, weight, and material composition of each component of the BHA 900 may be input by the user and modeled on the GUI. It is noted that any or each of the components and parameters of a BHA 900 or other component of a downhole assembly, including those shown and described herein, may be modified to setup a simulation.

Referring now to FIGS. 9-2 and 9-3, a 3D model of the bit 902 is visualized and may be displayed on a GUI, for example. As shown, the 3D model of the bit 902 may include one or more cutters 926 on one or more blades 928. In some embodiments, the bit 902 may be modeled and displayed in 3D, and may represent a fixed cutter or PDC bit. Those having ordinary skill would appreciate than any type of bit known in the art may be modeled and used as input to a simulation. Further, in other embodiments, the bit 902 may be modeled in 2D or may not be displayed.

As described herein, a user may select parameters from a library of pre-determined values, manually determine or input, calculate parameters, input parameters corresponding to field parameters, or any combination of the foregoing, among any other input technique known in the art. For example, a user may generate or input a data table of parameters and corresponding values, as shown in Table 1.

TABLE 1

| | |
|---|---|
| Depth MD (ft.) | 17,858 |
| WOB (kip/klbs) | 20 |
| Surface RPM | 0 |
| Flow Rate (gpm) | 250 |
| Mud Weight (ppg) | 9.95 |
| Rock | Wellington Shale |
| UCS (ksi) | 3 |
| Confining Pressure (psi) | 3,000 |

In this embodiment, as shown in Table 1, the measured depth of drilling (Depth MD) is 17,858 ft. (5,445 m), weight on bit (WOB) is 20 kilopounds (89.0 kN), surface RPM is 0, mud flow rate is 250 gpm (15.8 L/s), mud weight is 9.95 pounds per gallon (ppg) (1.2 kg/L), rock type is Wellington Shale, unconfined compressive strength (UCS) of the rock is 3 ksi (20.76 MPa), and confining pressure of the rock is 3,000 psi (20.7 MPa). Table 1 is merely illustrative, and the parameters and corresponding values may vary or may be modified by a user and/or system to set-up a simulation. Tables, such as Table 1, or other data may be manually input by a user and/or may be modified by a user. In addition, tables or other data may be stored on a storage device and may be accessible by a simulation system to be used to input parameters for simulation setup.

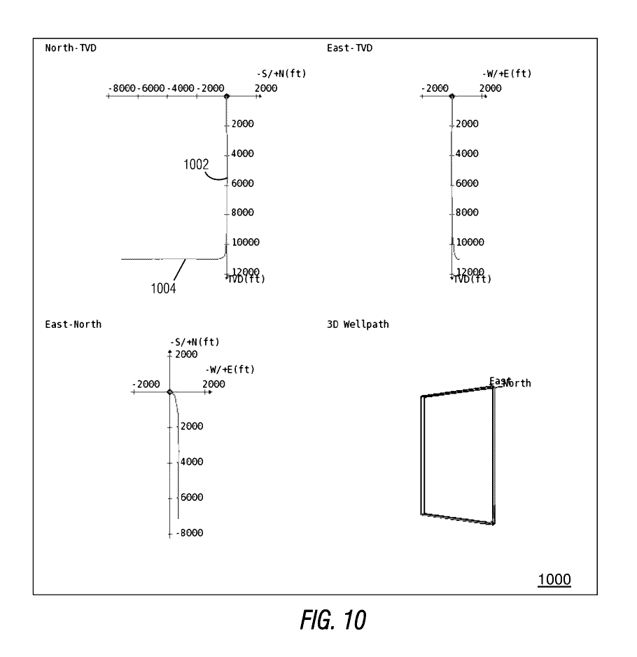

Referring now to FIG. 10, example input parameters for a wellbore 1000 to set-up a simulation are shown. In one or more embodiments, one or more of the elements of shown in FIG. 10 may be omitted, repeated, substituted, or input in any order. Accordingly, embodiments of the present disclosure should not be considered limited to the specific arrangements of elements shown in FIG. 10.

As shown and discussed herein, wellbore parameters may include at least one of the geometry of a wellbore (e.g., size, trajectory) or formation material properties. Wellbore parameters may be input by the user using a GUI, for example, and visualized on a display. For instance, the trajectory of the wellbore may be input or modified by the user. It is noted that any or each of the parameters of the wellbore 1000 may be modified to set-up a simulation.

In one or more embodiments, the wellbore 1000 may include a substantially vertical portion 1002. In some embodiments, the wellbore 1000 and a deviated or lateral portion 1004 that projects horizontally or at an incline from the substantially vertical portion 1002, as shown in the N/S plot of the wellbore profile. In other embodiments, the trajectory of the wellbore may be varied. Although not explicitly illustrated in FIG. 10, formation material properties at various depths along the wellbore may also be defined for use in a simulation. One of ordinary skill in the art will appreciate in view of the disclosure herein that wellbore parameters may include additional properties, such as friction coefficient of the walls of the wellbore, casing and cement properties, and wellbore fluid properties, among others, without departing from the scope of the disclosure.

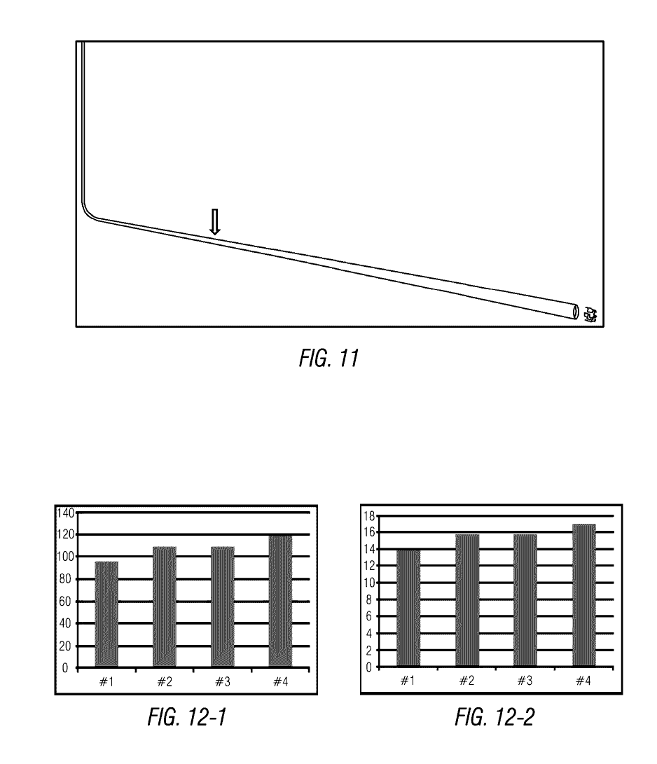

Referring now to FIG. 11, a 3D model of a drill string is shown as may be used or created in a simulation of a vibration tool and/or BHA in accordance with embodiments of the present disclosure. The illustrated figure depicts a drill string within a directional wellbore (e.g., as defined in the GUI of FIG. 10) having a substantially vertical portion 1102 and a deviated or lateral portion 1104 that projects horizontally or at an incline from the substantially vertical portion 1102. In some embodiments, a vibration tool or other component may be illustrated or its position may be identified. In the illustrated embodiment, for instance, an arrow 1106 may be used to indicate the location of a vibration tool. This model is shown for illustrative purposes, as those having ordinary skill would appreciate that the interface, display, properties, parameters, tools, and the like may be customized and modified prior to, during, and after a drilling simulation. For instance, the properties and parameters of a vibration tool may be customized, specified, or modified in other manners. In some embodiments, a downhole operation may be performed with or without a drill bit. A whipstock, plug, reamer, anchor, or other downhole tool may be conveyed into a vertical, inclined, or horizontal wellbore for use in a downhole operation. Where a vibration tool is simulated, a distance between the vibration tool and such other components may be provided. For instance, the vibration tool may be between 100 ft. (30 m) and 10,000 ft. (3,050 m), between 2,000 ft. (610 m) and 8,000 ft. (2,440 m), or between 3,000 ft. (915 m) and 5,000 ft. (1,520 m) from the bit. For instance, the vibration tool may be 4,470 ft. (1,362 m) from the drill bit. In other embodiments, the vibration tool may be less than 100 ft. (30 m) or more than 10,000 ft. (3,050 m) from the bit for a simulation or drilling operation. For ease of reference, the term “drilling operation” as used herein is intended to encompass a variety of downhole operations, including operations which may not include drilling or otherwise engaging formation.

Simulation Results

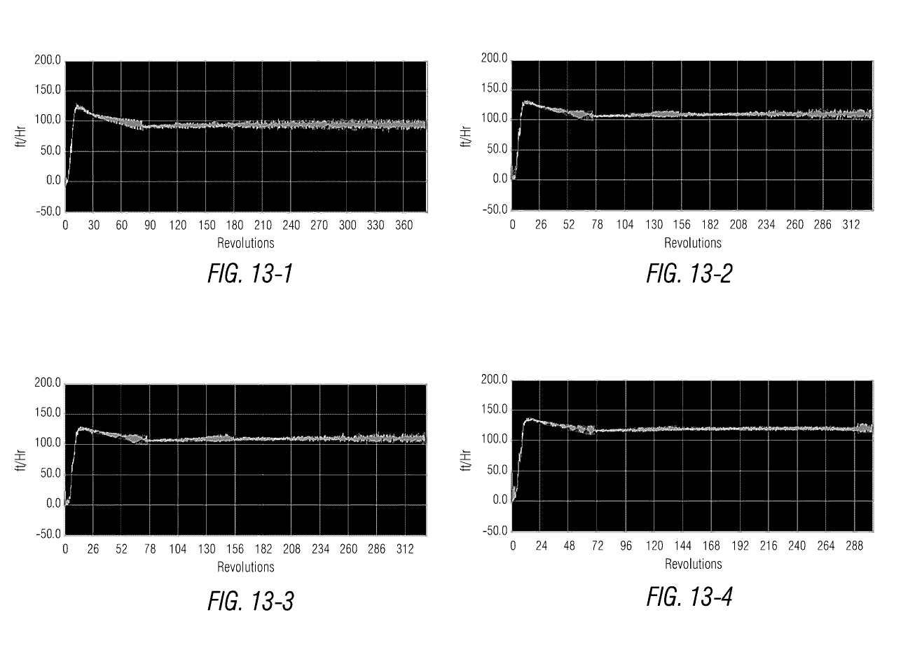

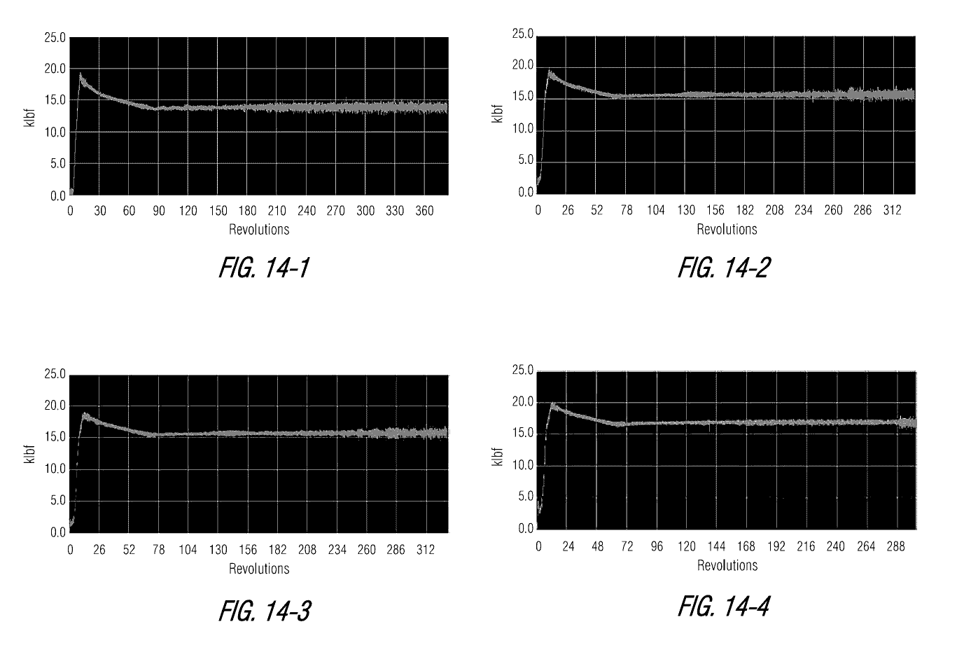

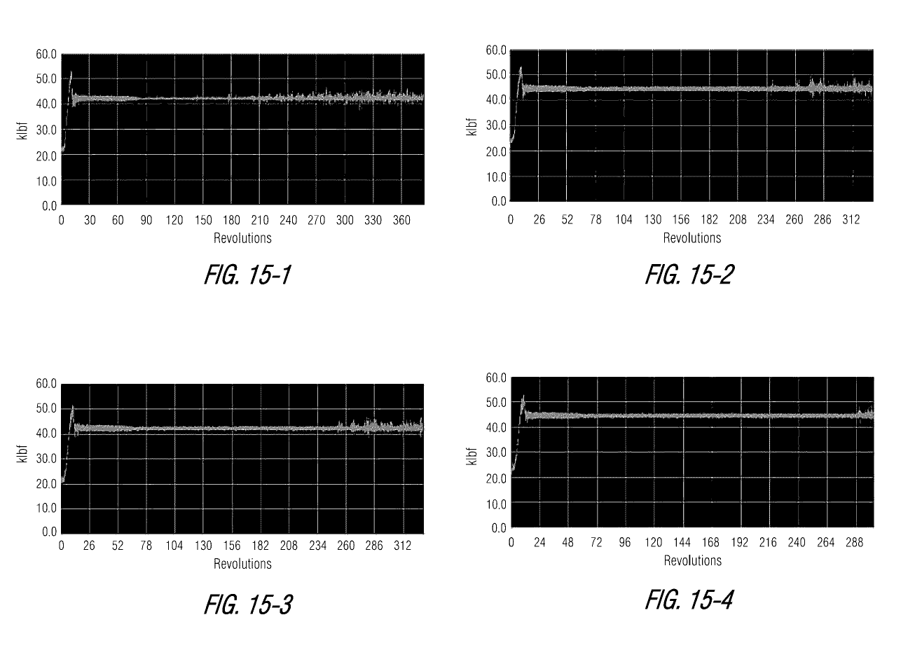

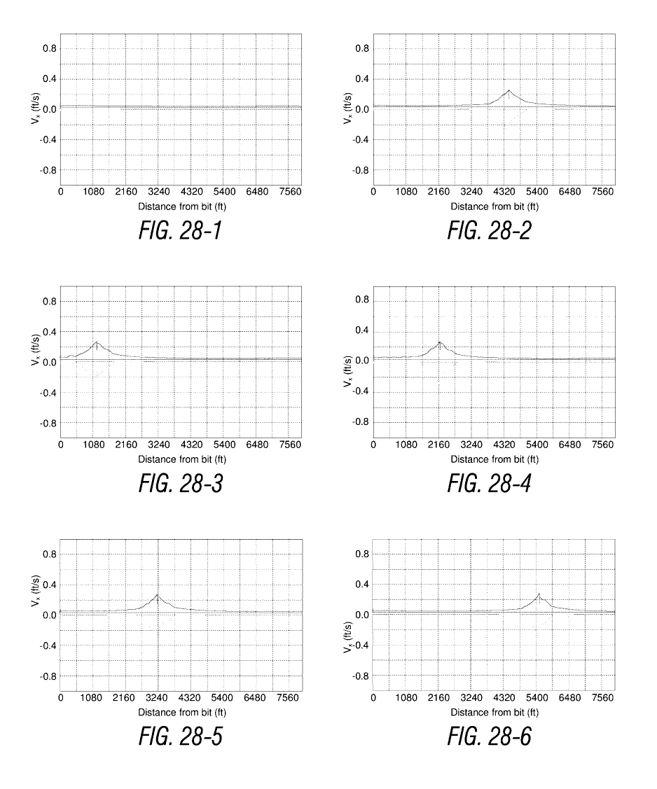

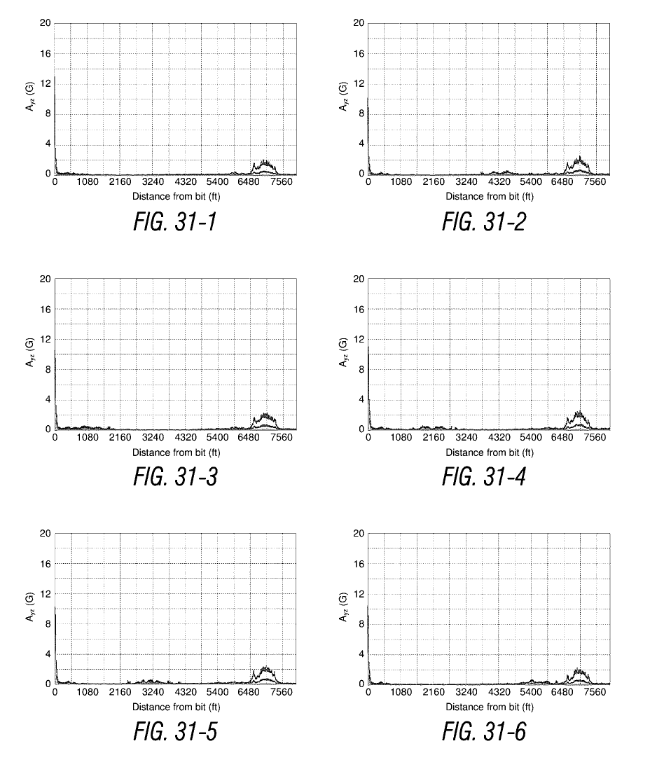

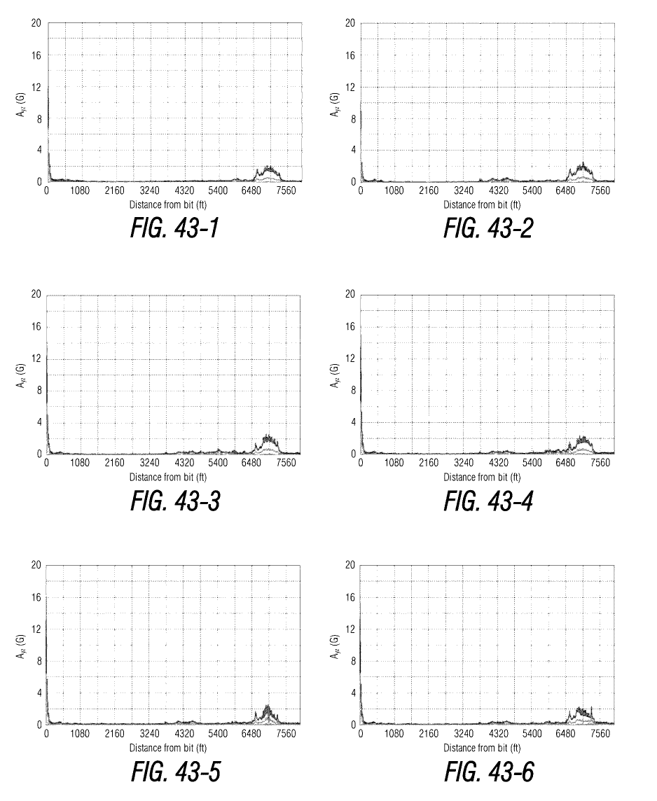

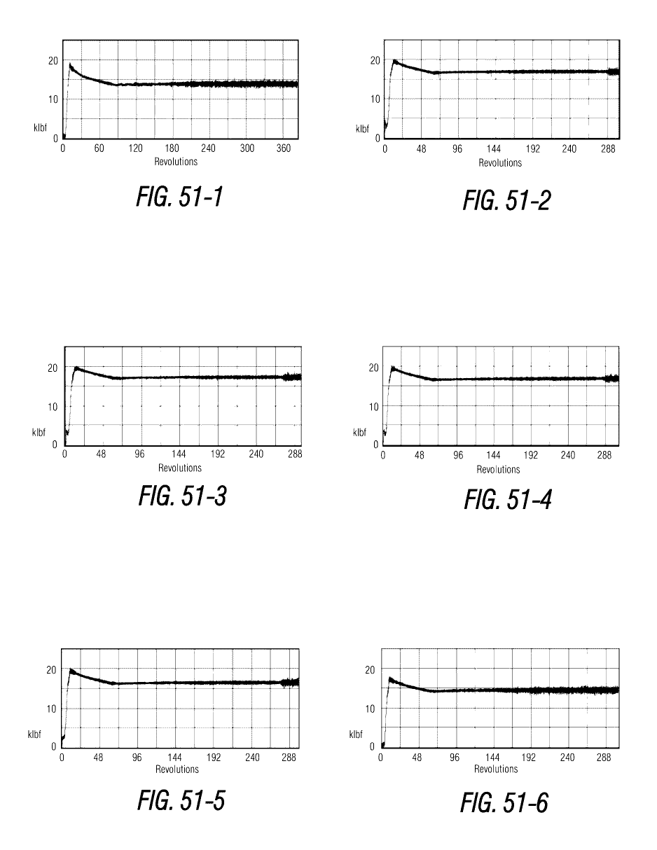

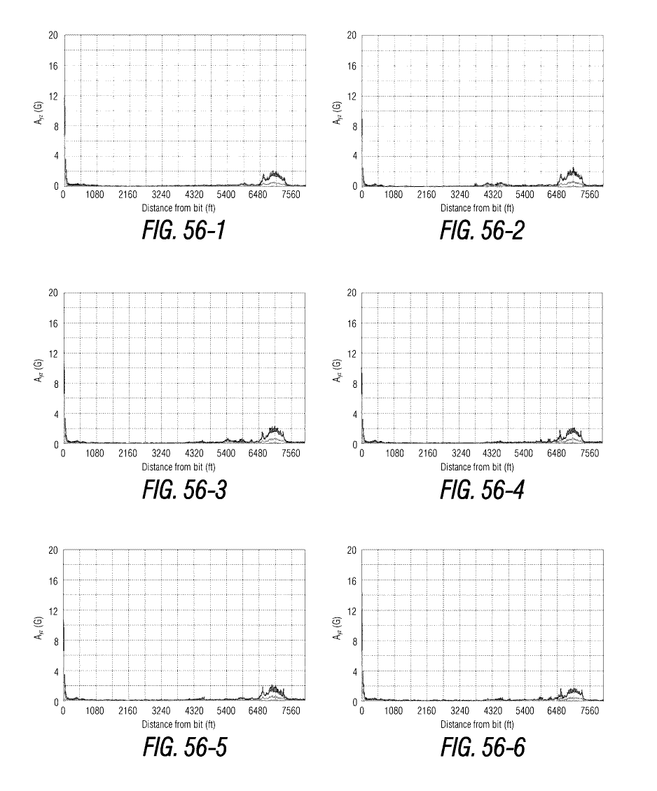

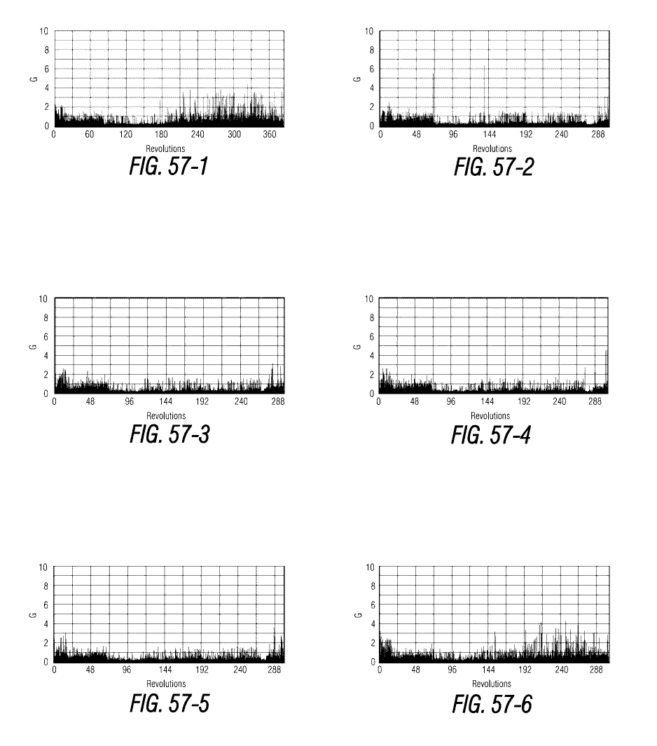

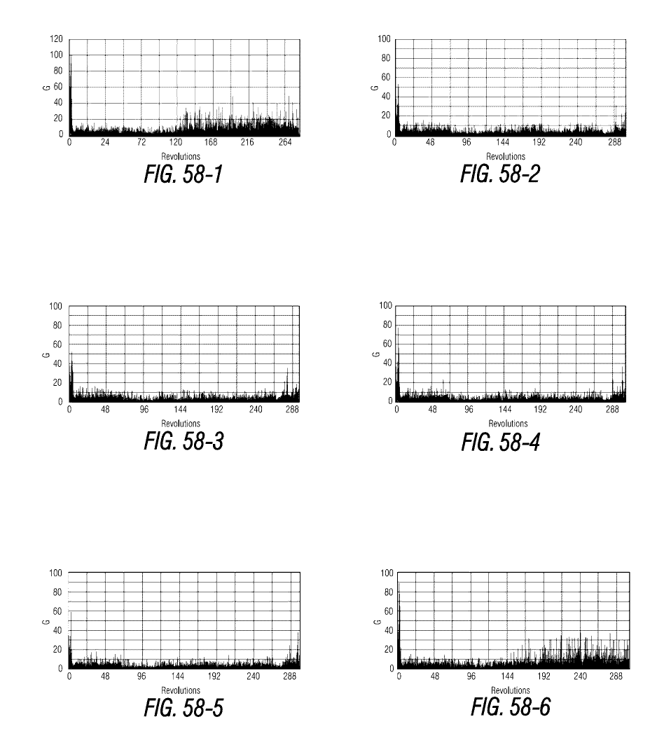

The remaining figures (i.e., FIGS. 12-1 to 59-6) illustrate a number of example types of drilling performance data and parameters that may be generated and/or presented following simulations run with different parameters according to embodiments of the present disclosure. In particular, a number of BHA, vibration tool, and shock parameters may be input and simulated using the same or different wellbore parameters, bit parameters, or drilling operating parameters, and the corresponding performance results may be generated. In some embodiments, comparisons of performance results may be performed. Comparison of these simulations and the corresponding performance results may be done by any of those having skill in the art, automatically by a simulation system, or using a combination of the foregoing techniques. In some embodiments, the performance results or comparisons of performance results may lead to selection of a particular BHA package, particular positioning of components of a BHA, or further modifications of a BHA and/or other components for additional simulation. Although many performance results are illustrated, it is noted that many other or additional simulation parameters may be input into a simulation system and performance parameters may then also be output and/or compared. The following simulation examples should, therefore, be seen as illustrative and should not limit the scope of the present disclosure. In FIGS. 12-1 to 22-4 example simulations may be performed using four example scenarios; however, more or fewer scenarios may be simulated and/or compared. For the illustrated embodiment, the four scenarios may include those described in Table 2.

TABLE 2

| | |
|---|---|
| 1 | Baseline BHA with no vibration tool and no shock tool |
| 2 | BHA with vibration tool 4,470 ft. (1,362 m) from bit |
| 3 | BHA with shock tool 4,470 ft. (1,362 m) from bit |
| 4 | BHA with vibration tool and shock tool 4,470 ft. |
| | (1,362 m) from bit |

Upon performing the simulation for each of the four simulations discussed herein, any of a number of performance parameters may be analyzed and/or output for analysis. FIG. 12-1, for instance illustrates simulated of ROP for a downhole system, while FIG. 12-2 illustrates simulated DWOB for the downhole system. The results may be provided in a bar graph or other graphical format, although raw data or other outputs may be provided. As shown in FIG. 12-1, the fourth simulation (i.e., with the vibration tool and shock tool) was capable of the highest ROP, which was simulated to be approximately 120 ft/hr (36.6 m/hr), which is significantly higher than the baseline simulation for the first simulation, which is approximately 95 ft/hr (29.0 m/hr). The second and third simulations each produced a simulated ROP of approximately 110 ft/hr (33.5 m/hr).

FIG. 12-2 shows a similar result, with the fourth simulation having the highest DWOB, which was simulated to be approximately 17 kip (75.6 kN), while the baseline, first simulation had a simulated DWOB of approximately 14 kip (62.3 kN). The second and third simulations each had a simulated DWOB of approximately 16 kip (71.2 kN). From the results in FIGS. 12-1 and 12-2, which showed the highest ROP and DWOB for the fourth scenario, an engineer or other user of the simulation system may design or select a BHA package that includes, or is coupled to, both a vibration tool and a shock tool, if ROP and DWOB are criteria of interest.

As discussed herein, a number of performance parameters may be analyzed and/or output in any number of different visualizations during or after a simulation. In FIGS. 13-1 to 13-4, ROP is shown for simulation scenario detailed in Table 2. In each of FIGS. 13-1 to 13-4, the simulation results show ROP increasing rapidly toward a maximum ROP (measured in ft/hr) that occurs within about 15 revolutions of the simulation beginning. Thereafter, the ROP decreases over approximately the next 60 revolutions, and levels off to a generally constant rate for the remainder of the simulation (over 300 revolutions). As shown in FIGS. 13-1 to 13-4, the fourth simulation was able to show the highest maximum ROP at approximately 140 ft/hr (42.7 m/hr) and the highest ROP once the leveling occurred, which is shown as being approximately 120 ft/hr (36.6 m/hr). The ROP, once it levels off, is generally consistent with the data shown in FIG. 12-1. By comparing FIGS. 13-1 to 13-4, one skilled in the art will also observe that the line for the fourth simulation is also thinner, on average, than the lines in the other simulations. This thinner line may show that the fourth simulation has less variation in ROP, and particularly after the ROP levels off.

FIGS. 14-1 to 14-4 show DWOB data for each of four simulations, and generally correspond to the data in FIG. 12-2. As shown, for each simulation, the DWOB is shown to increase rapidly and a maximum DWOB occurs within about 15 simulations of the simulation beginning. The DWOB then decreases over about the next 60 revolutions and flattens out for the remainder of the simulation. As expected in view of FIG. 12-2, the fourth simulation has the highest DWOB in the flattened or leveled off section, at about 17 kip (75.6 kN). The fourth simulation also has the highest maximum DWOB at about 20 kip (89.0 kN). By comparing FIGS. 14-1 to 14-4, one skilled in the art will also observe that the line for the fourth simulation is also thinner, on average, than the lines in the other simulations. This thinner line may show that the fourth simulation has less variation in DWOB, particularly once the DWOB levels off.

FIGS. 15-1 to 22-4 illustrate similar output data for additional performance parameters that may be output and/or compared by a simulation system. For instance, FIGS. 15-1 to 15-4 illustrate an example embodiment in which SWOB is provided and can be compared for four simulation scenarios. In each scenario, the trend is similar to that of DWOB in FIGS. 14-1 to 14-4, with SWOB peaking early, although SWOB leveled off more quickly. After SWOB levels off, the second and fourth simulations show similar average SWOB of about 45 kip (200.2 kN), while the first and third simulations show an average SWOB of about 43 kip (191.3 kN). The fourth simulation also has the thinnest line in the graphical data, which reflects the lowest variation in SWOB.

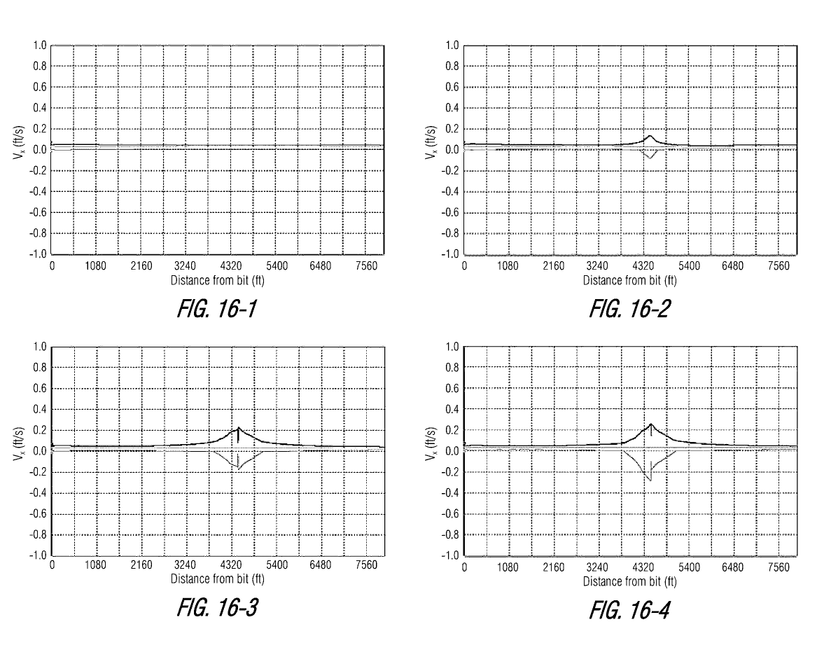

In FIGS. 16-1 to 16-4, another set of charts is shown for yet another example embodiment in which BHA axial velocity is provided and can be compared for four simulation scenarios. In some embodiments, axial velocity may represent vibration data for a BHA. As shown in this embodiment, axial velocity or Vₓ may be measured in ft/s and shown on the y-axis for various distances from a bit, as shown on the x-axis. For the illustrated embodiment, a shock tool and/or vibration tool may be approximately 4,470 ft. (1,362 m) from the bit. Accordingly, FIGS. 16-2 to 16-4 each show axial velocities increasing at a distance of around 4,470 ft. (1,362 m) from the bit. The axial velocity in the fourth simulation of FIG. 16-4 is shown to clearly be larger than in any other simulation, with positive axial velocity reaching about 0.25 ft/s (0.08 m/s) and negative axial velocity reaching about 0.3 ft/s (0.09 m/s). The third simulation in FIG. 16-3 shows positive and negative axial velocity peaking at about 0.2 ft/s (0.06 m/s), while the second simulation in FIG. 16-2 shows positive and negative axial velocity peaking at about 0.1 ft/s (0.03 m/s). A comparison of FIGS. 16-1 to 16-2 may thus show that the highest axial velocities may be obtained using the BHA designed for the fourth simulation.

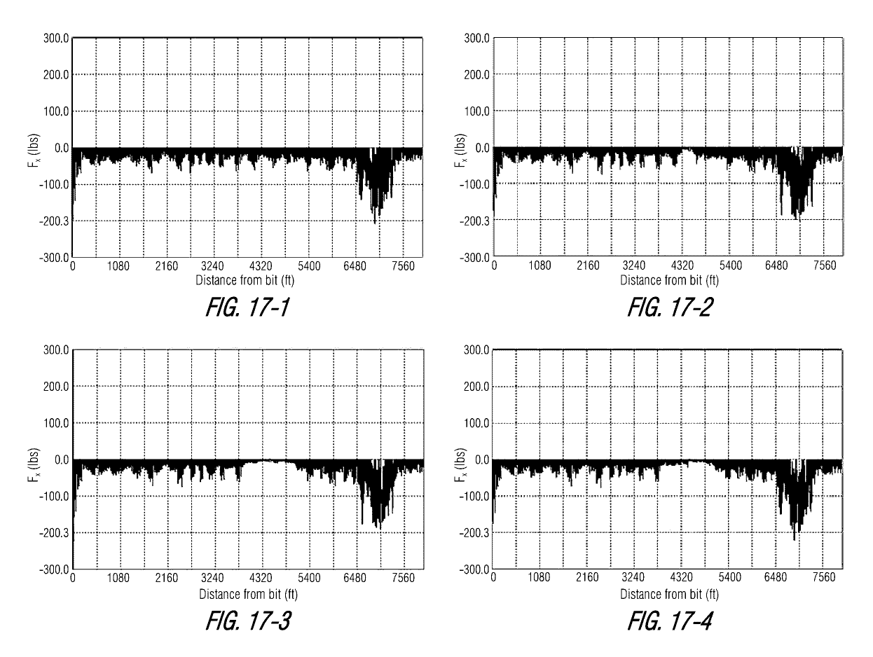

Referring now to FIGS. 17-1 to 17-4, the axial friction force of the BHA is shown for the four simulations in Table 2. As shown, in each of the simulations represented in FIGS. 17-2 to 17-4, the axial friction force at the location of the shock tool and/or vibration tool (e.g., at about 4,470 ft. (1,362 m)) is significantly reduced relative to the baseline shown in FIG. 17-1. The simulations in FIGS. 17-3 and 17-4 in particular, which each includes a vibration tool, are shown to have the lowest friction around the position of the vibration tool.

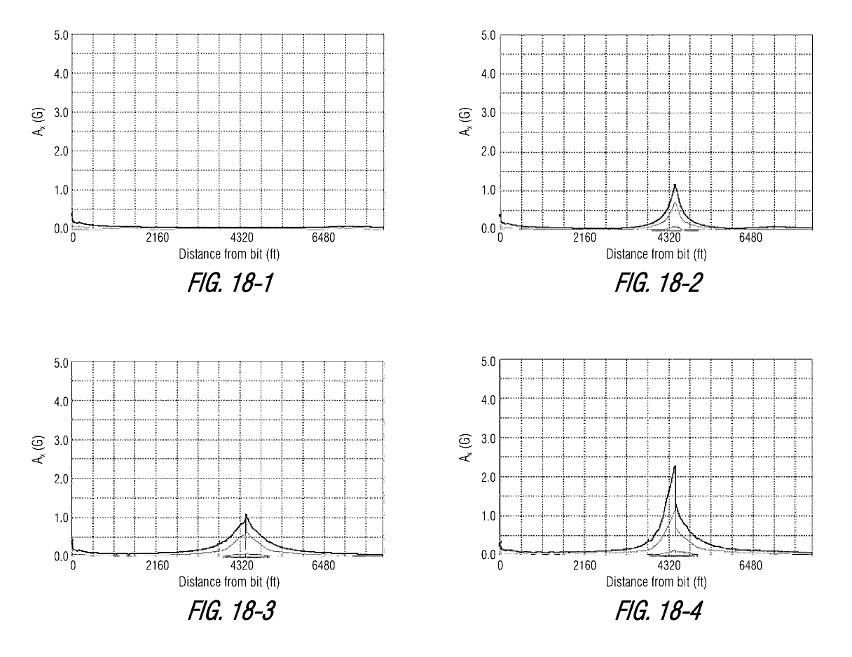

FIGS. 18-1 to 18-4 represent the axial acceleration of portions of a BHA relative to the distance from the bit, for each of the simulations in Table 2. In the illustrated embodiment, the fourth simulation of FIG. 18-4 is shown to have the highest peak (dark line) and average (middle, lighter line) axial accelerations. In particular, the maximum acceleration is shown to be about 2.25 g-forces, and the average axial acceleration to be about 1.25 g-force. In contrast, the second simulation (FIG. 18-2) and the third simulation (FIG. 18-3) are shown to have peak and average accelerations of about 1.1 g-force and 0.7 g-force, respectively. As further shown, a BHA with a vibration tool may experience larger axial accelerations over a greater distance. In particular, the axial accelerations in FIGS. 18-3 and 18-4 may be greater than 0.25 g-force over a distance of about 1,600 ft. (490 m), while in FIG. 18-2, the axial accelerations are greater than 0.25 g-force over a distance of about 800 ft. (245 m).

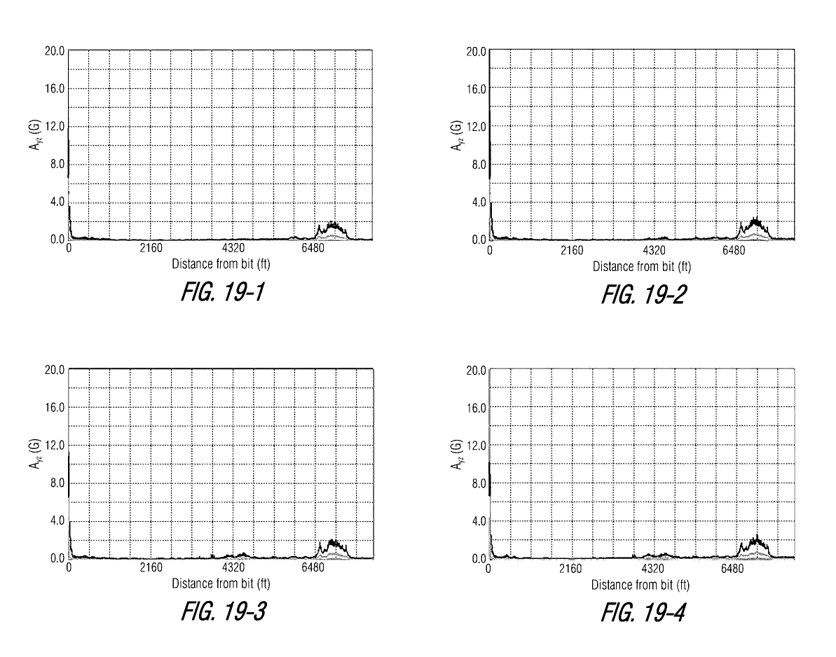

FIGS. 19-1 to 19-4 represent the lateral acceleration of portions of a BHA relative to the distance from the bit, for each of the simulations in Table 2. In each embodiment, lateral accelerations starting at a distance of approximately 6,500 ft. (1,980 m) from the bit are about the same. The lateral vibrations starting at about 3,800 ft. (1,150 m), are different, with the third and fourth simulations in FIGS. 19-3 and 19-4, respectively, showing similar lateral vibrations reaching peaks of about 0.6 g-force. In contrast, the peak lateral vibration for the second simulation in FIG. 19-2 is about 0.3 g-force, and are noticeable over a lesser distance along the length of the BHA.

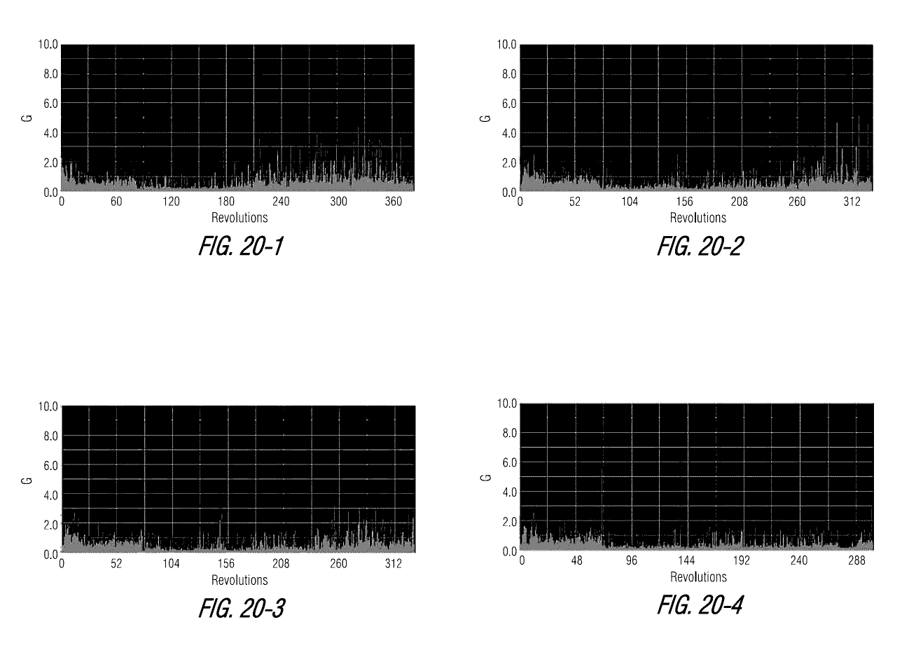

The axial acceleration of the bit may also be simulated, and example results for the simulations in Table 2 are shown in FIGS. 20-1 to 20-4. The illustrated charts show axial acceleration on the y-axis, with the number of bit revolutions of the simulation along the x-axis. As shown, the axial accelerations of the bit up through about 70 revolutions are about the same for each simulation. After that point, however, the acceleration patterns vary, with the fourth simulation (FIG. 20-4) having the lowest average axial acceleration, despite two high peak accelerations. Lower average axial acceleration at the bit may be associated with lower vibration at the bit, thus showing a general dampening of axial acceleration when using a vibration tool and a shock tool when compared to other simulations. Lower vibration at the bit may also be associated with more constant WOB.

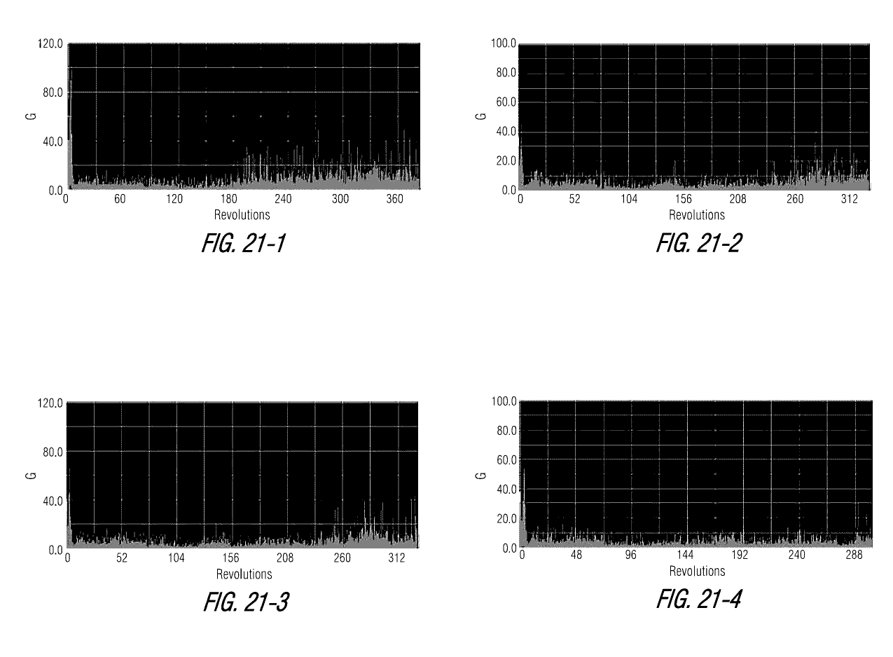

Referring now to FIGS. 21-1 to 21-4, the lateral acceleration of the bit is shown for the simulations in Table 2. Similar to FIGS. 20-1 to 20-4, the simulations show a general dampening of lateral acceleration when using a vibration tool and a shock tool (FIG. 21-4) when compared to the baseline (FIG. 21-1) and other simulations. The second and third simulations (FIGS. 21-2 and 21-3, respectively), also show reduced lateral acceleration of the bit relative to the baseline.

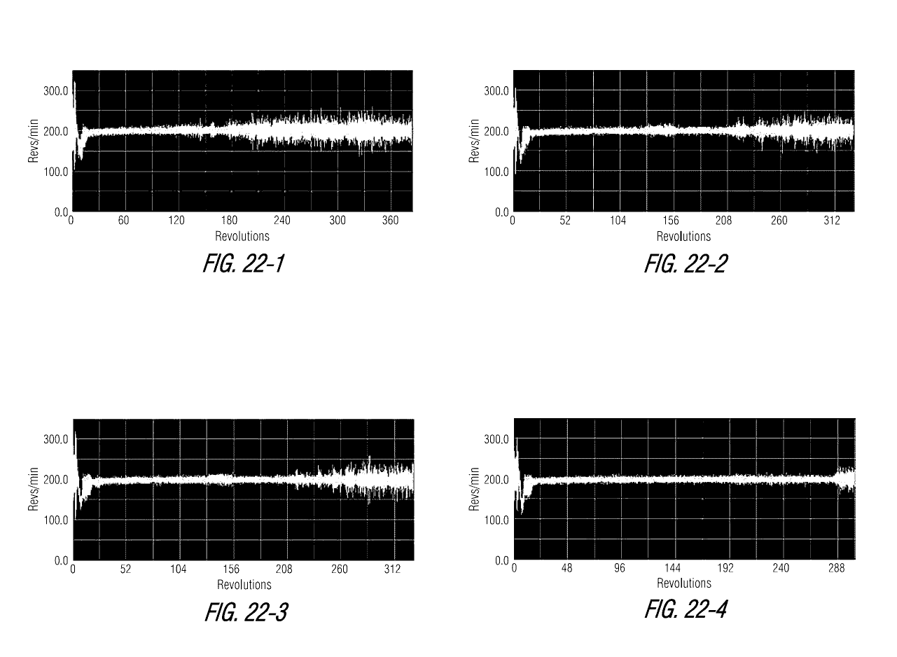

Referring now to FIGS. 22-1 to 22-4, bit rotational speed is shown for the four simulations of Table 2. In each of the four simulations, the bit rotational speed levels out after about 15 revolutions to have an average bit rotational speed of approximately 200 RPM. Despite each simulation showing about the same average rotational speed, the fourth simulation (FIG. 22-4) corresponding to use of a shock tool and a vibration tool, shows considerably less variation in the bit rotational speed, as evidenced by the line being thinner overall when compared to the lines in FIGS. 22-1 to 22-3. While the fourth simulation shows the least variation in bit rotational speed, the second simulation (FIG. 22-2) and third simulation (FIG. 22-3) also show reduced variation in bit RPM when compared to the baseline simulation (FIG. 22-1). In some embodiments, an engineer or other user of a simulation system as disclosed herein, may review the data represented by FIGS. 12-1 to 22-4 and determine that a vibration tool may increase ROP and DWOB without detrimental effects to the bit or the dynamics of the BHA. In some embodiments, the engineer or other user may use the data to select a particular BHA configuration for use in the field or to be modified for additional simulations.

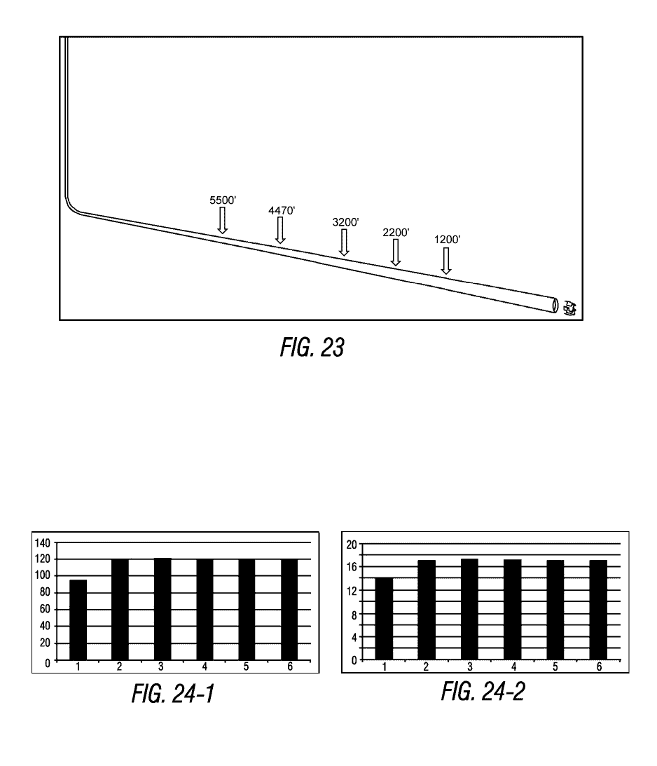

As described herein, any number of different simulations may be performed consistent with various embodiments of the present disclosure. Referring now to FIGS. 23 to 34-6, additional examples of simulations that can be performed, and the corresponding performance results for the simulations, are shown in additional detail. In particular, FIG. 23 illustrates a 3D model of a drill string with arrows showing different locations where components (e.g., vibration tool, shock tool, etc.) may be located. This model is merely illustrative, as those having ordinary skill would appreciate that the properties and parameters of a wellbore, drill string, BHA, other component, or combinations of the foregoing, may be customized and/or modified prior to, during, and after a drilling simulation.

In some embodiments, each location of a component coupled to a drill string may correspond to a different simulation scenario that may be used in a simulation, in accordance with embodiments of the present disclosure. In at least some embodiments, the identified locations in FIG. 23 may correspond to a location where a vibration tool may be located. In the same or other embodiments, a shock tool may be simulated at each location. In still other embodiments, a vibration tool and shock tool may be simulated at each location. In still other embodiments, additional or other components may be simulated at each location (or at other locations). To compare the effects that the component has at each location (e.g., as defined with respect to a distance from the bit), each simulation may be run with the same wellbore parameters, BHA parameters, and drilling operating parameters. In some particular embodiments discussed herein with respect to FIGS. 23 to 34-6, the simulations performed may include a vibration tool and shock tool at each location. For the illustrated embodiments, six simulation scenarios may be used, as described in Table 3.

TABLE 3

| Simulation | Distance from bit |
|---|---|
| 1 | N/A (no vibration tool or shock tool) |
| 2 | 4,470 ft. (1,362 m) |
| 3 | 1,200 ft. (366 m) |
| 4 | 2,200 ft. (671 m) |
| 5 | 3,200 ft. (975 m) |
| 6 | 5,500 ft. (1676 m) |

The first simulation in Table 3 may be a baseline, and may be the same as the first simulation described in Table 2. The second simulation may be the same as the fourth simulation described in Table 2, as the vibration and shock tools may be located at 4,470 ft. (1,360 m) from the bit. Simulations 3-6 of Table 3 may vary the distance of the vibration tool and the shock tool with respect to the bit. It will be appreciated in view of the disclosure herein that the distances shown in Table 3 are merely illustrative, and may be varied in other embodiments. Additionally, while the vibration tool and shock tool are shown as being at the same distance, in other embodiments, the vibration tool and shock tool may be separated and simulated at different distances, or a simulation may not include one or both of the shock tool and the vibration tool.

During or after the simulations in Table 3, a number of performance parameters may be used or output for analysis. In FIGS. 24-1 and 24-2, the ROP and DWOB for each simulation scenario is presented, which may allow a comparison. In other embodiments, the results may be presented in numerical, raw data, or other formats. As shown in FIG. 24-1, varying the location of the vibration tool and shock tool may result in similar ROP of about 120 ft/hr (36.6 m/hr) for each of simulations 2-6, which may be above the baseline of about 95 ft/hr (29.0 m/hr). In FIG. 24-2, the DWOB may also be similar for simulations 2-6, and around 17 kip ((75.6 kN), while the baseline, first simulation had a simulated DWOB of approximately 14 kip (62.3 kN). Thus, FIGS. 24-1 and 24-2 may show, for the simulated BHA, that the position of a vibration tool and shock tool may have less of an impact to ROP and DWOB than the inclusion of a vibration tool and shock tool.

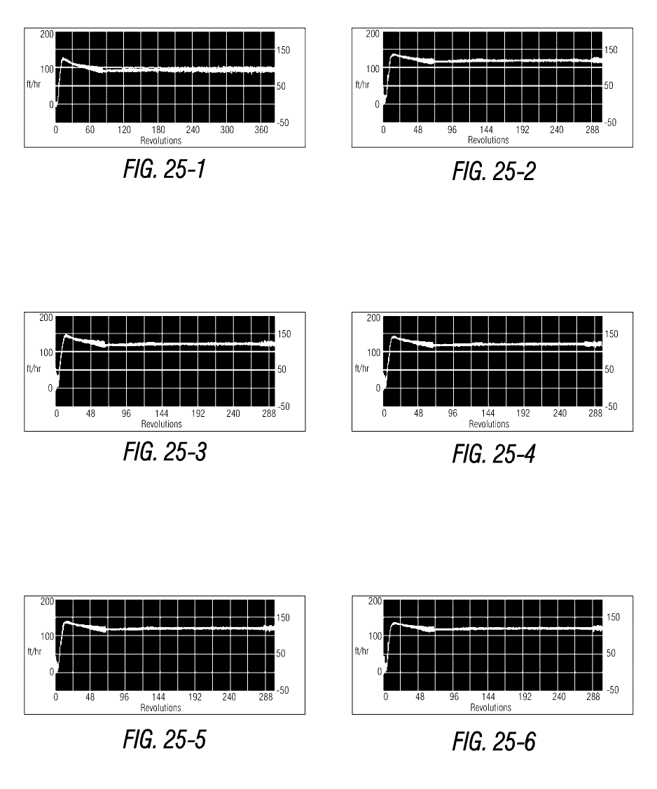

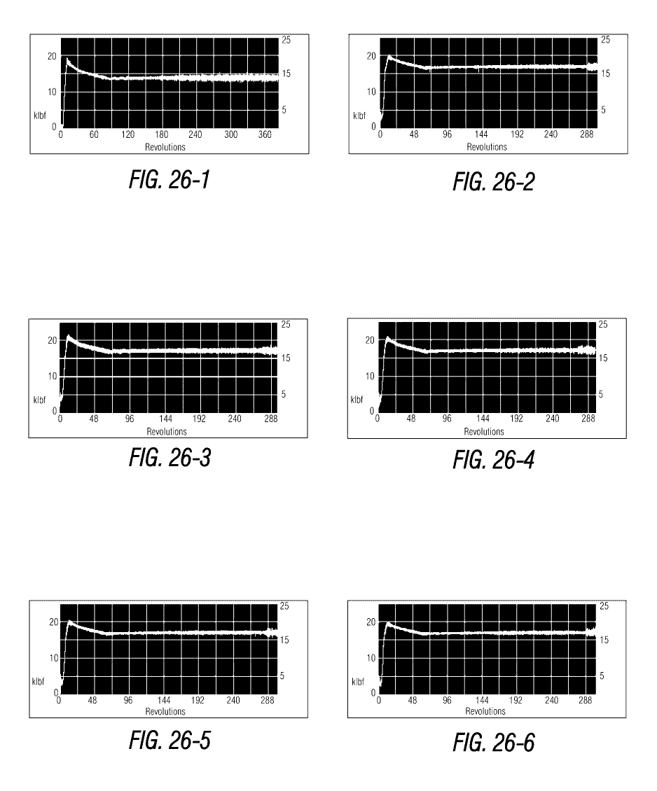

In FIGS. 25-1 to 25-6, the ROP for a BHA is shown for each of the simulations in Table 3. There are some variations between the simulations (e.g., increased variation in ROP begins at about 288 revolutions in FIGS. 25-2 and 25-6, but at about 276 revolutions in FIGS. 25-3 and 25-4), but overall, and as discussed relative to FIG. 24-1, the ROP of simulations 2-6, are similar, and are each higher than the ROP for the baseline simulation in FIG. 25-1. FIGS. 26-1 to 26-6 show the DWOP for a BHA with the same six simulations. There are some variations between the simulations (e.g., the lines in FIGS. 26-2 and 26-6 are thinner and show less variation than the DWOB reflected by the lines in FIGS. 26-3 and 26-4), but overall the DWOB of simulations 2-6 are similar, and are each higher than the DWOB for the baseline simulation in FIG. 26-1.

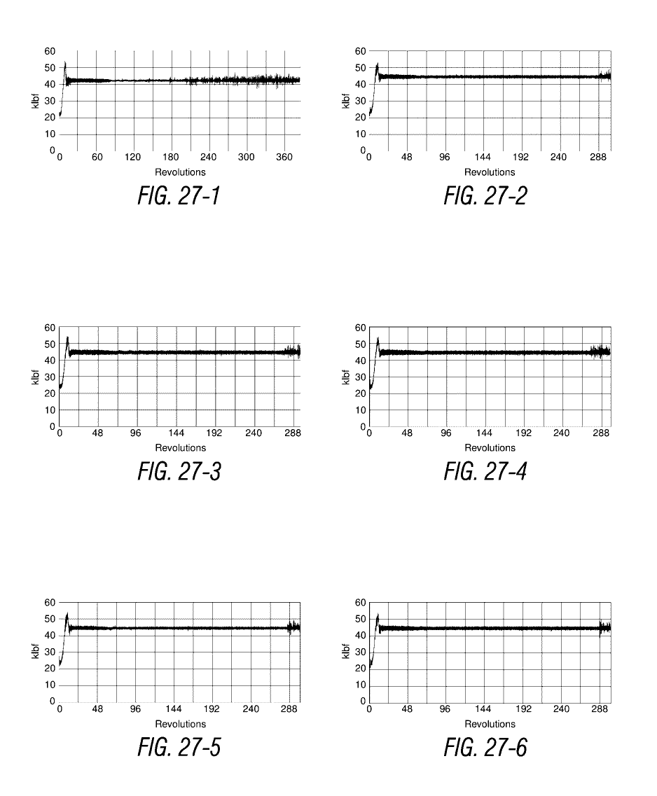

FIGS. 27-1 to 27-6 illustrate an example embodiment in which SWOB is provided and can be compared for the six simulation scenarios in Table 3. In each scenario, the trend is similar to that of DWOB in FIGS. 26-1 to 26-6, with SWOB peaking early, although SWOB leveled off more quickly than DWOB. After SWOB levels off, the second through sixth simulations show similar average SWOB of about 45 kip (200.2 kN), while the first simulation show an average SWOB of about 43 kip (191.3 kN). The second, fifth, and sixth simulation also have the thinnest lines in the graphical data, which reflects the lowest variation in SWOB. Similar to ROP and DWOB, the location of the vibration tool and shock tool contribute to relatively minor differences in SWOB, but show a more noticeable improvement over the baseline simulation (FIG. 27-1).

In FIGS. 28-1 to 28-6, another set of charts is shown for yet another example embodiment in which BHA axial velocity is provided and can be compared for the six simulation scenarios of Table 3. For the illustrated embodiment, a shock tool and/or vibration tool may be positioned at different locations and different distances from the bit. Accordingly, FIGS. 28-2 to 28-6 each show axial velocities increasing at a distance near the offset of the vibration tool and/or shock tool. The magnitude of the axial velocity in each of the second through sixth simulations are generally similar, with positive axial velocity reaching about 0.25 ft/s (0.08 m/s) and negative axial velocity reaching about 0.3 ft/s (0.09 m/s). Thus, spikes of generally the same amplitude are shown in FIGS. 28-2 to 28-6, but correspond to the locations of the vibration tool and shock tool.

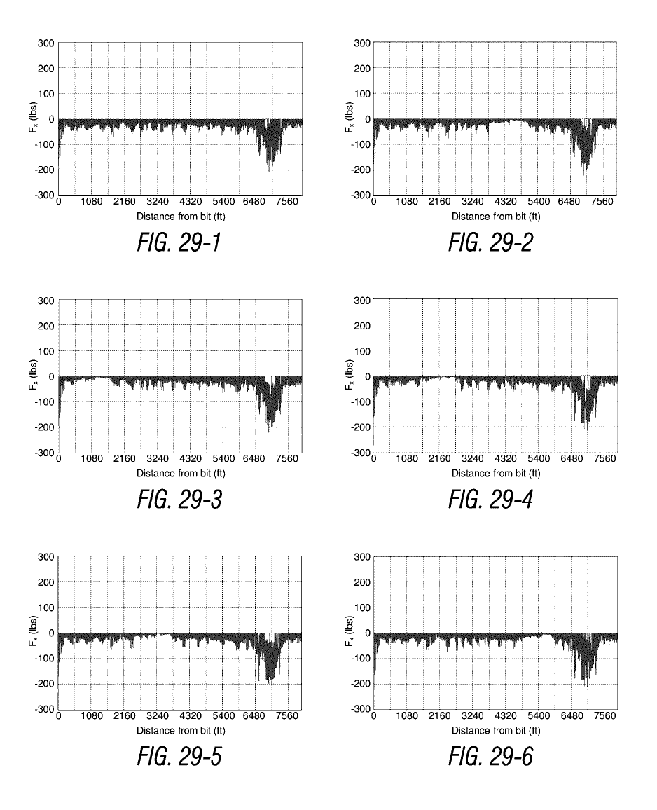

Referring now to FIGS. 29-1 to 29-6, the axial friction force of the BHA is shown for the six simulations in Table 3. As shown, in each of the simulations represented in FIGS. 29-2 to 29-6, the axial friction force at the location of the shock tool and/or vibration tool (e.g., at about 4,470 ft. (1,362 m) for FIG. 29-2, at about 1,200 ft. (366 m) for FIG. 29-3, etc.) is significantly reduced relative to the baseline shown in FIG. 29-1. As shown, the friction force is lower over about a 1,000 ft. (305 m) interval centered at the position of the vibration tool and/or shock tool, when compared to the same location in the baseline simulation.

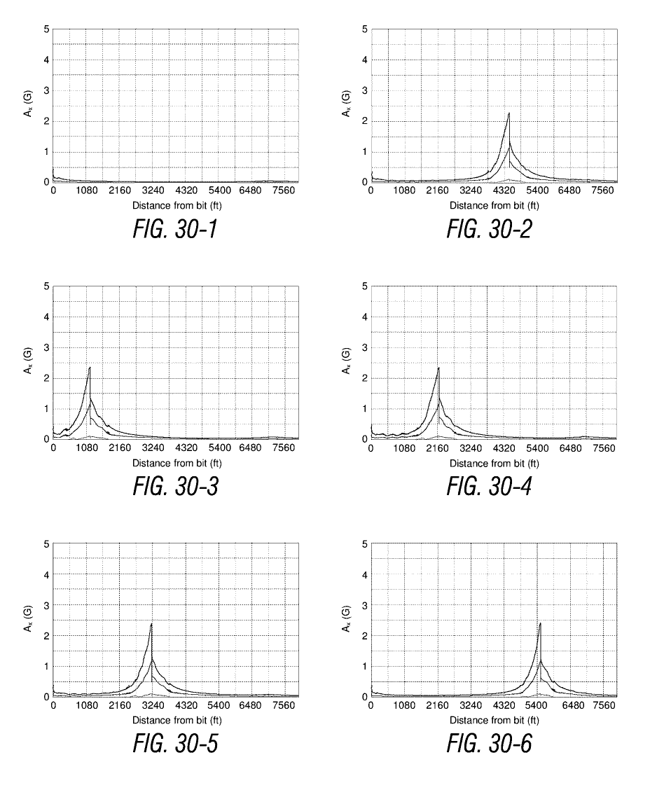

FIGS. 30-1 to 30-6 represent the axial acceleration of portions of a BHA relative to the distance from the bit, for each of the simulations in Table 3. In the illustrated embodiment, each of the simulations other than the baseline simulation FIG. 30-1 are shown to have similar magnitudes of the highest peak (top line) and average (middle line) axial accelerations. In particular, the maximum acceleration is shown to be about 2.25 g-forces, and the peak average axial acceleration is about 1.25 g-force. The spikes of axial acceleration are generally centered at the position of the vibration tool and/or shock tool and extend over a distance of about 3,000 ft. (915 m).

FIGS. 31-1 to 31-6 represent the lateral acceleration of portions of a BHA relative to the distance from the bit, for each of the simulations in Table 3. In each embodiment, lateral accelerations starting at a distance of approximately 6,500 ft. (1,980 m) from the bit are about the same. The lateral vibrations centered at about the location of the vibration tool and shock tool for each respective simulation are, however, different, with each reaching peaks of about 0.6 g-force, and the variation in lateral acceleration be noticeable over about a 1,000 ft. (305 m) to 1,500 ft. (455 m) interval. As also seen in comparing the lateral acceleration of FIGS. 31-1 to 31-6 to the axial acceleration of FIGS. 30-1 to 30-6, some embodiments of a vibration tool may have a more pronounced impact on axial vibration. This may result from, for example, the vibration tool inducing axial pulses. In contrast, vibration tool with lateral or torsional pulses or vibrations may show increased lateral accelerations relative to axial accelerations.

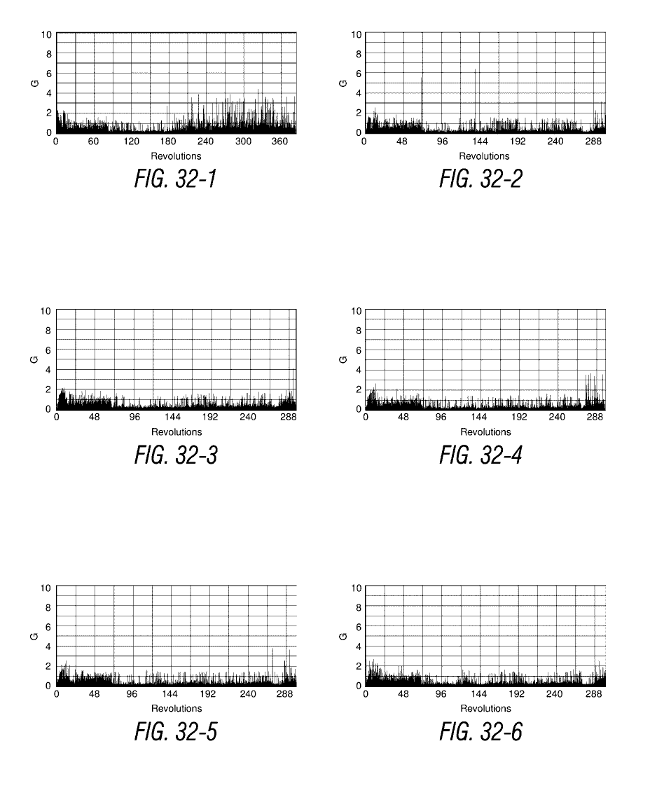

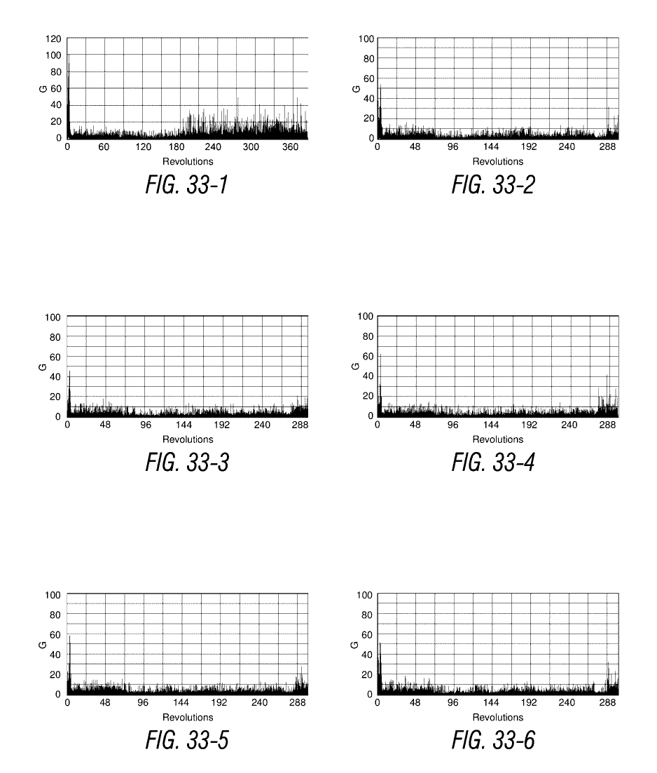

The axial and lateral accelerations of the bit may also be simulated, and example results for the simulations in Table 3 are shown in FIGS. 32-1 to 32-6 and in FIGS. 33-1 to 33-6, respectively. FIGS. 32-1 to 32-6 show axial acceleration on the y-axis, with the number of bit revolutions of the simulation along the x-axis. As shown, the axial accelerations of the bit up through about 70 revolutions are about the same for each simulation. After that point, however, the acceleration patterns vary, with each of the second through sixth simulations having a lower average axial acceleration, relative to the baseline in FIG. 32-1. Similarly, FIGS. 33-1 to 33-6 show lateral acceleration on the y-axis and bit revolutions along the x-axis. Other than a reduction in a peak acceleration near start-up of the bit-rotation for various simulations, the lateral accelerations of the bit up through about 100 revolutions are about the same for each simulation. The acceleration patterns then vary, with the average bit lateral acceleration being generally similar for each of the second through sixth simulations, and less than the average of the baseline simulation shown in FIG. 33-1. The results of FIGS. 32-1 to 33-6 show a general dampening of axial and lateral accelerations when using a vibration tool and a shock tool when compared to a baseline simulation without such tools. Lower vibration at the bit may also be associated with more constant WOB.

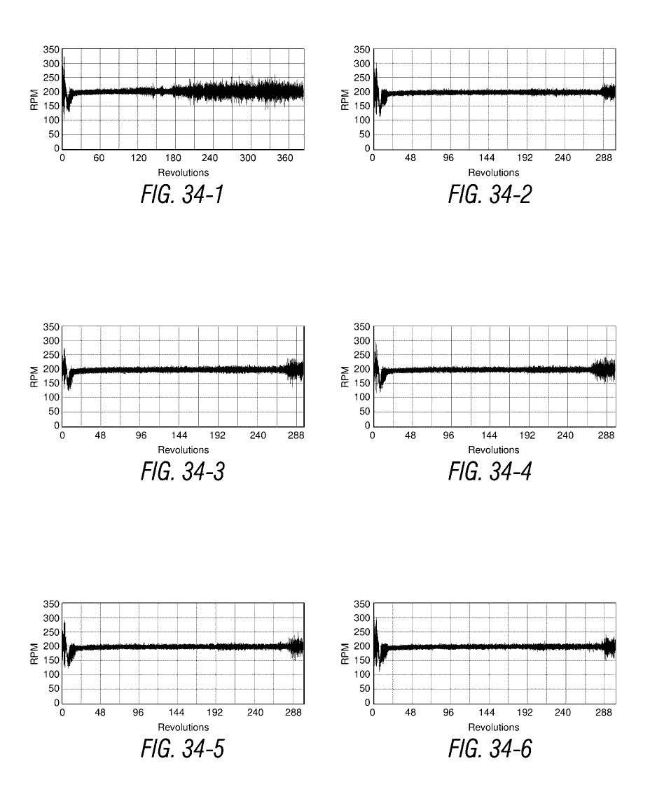

Referring now to FIGS. 34-1 to 34-6, bit rotational speed is shown for the six simulations of Table 3. In each of the simulations, the bit rotational speed levels out after about 15-20 revolutions to have an average bit rotational speed of approximately 200 RPM. Despite each simulation showing about the same average rotational speed, the second through sixth simulations show considerably less variation in the bit rotational speed, as evidenced by the line being thinner overall when compared to the lines in the baseline simulation of FIG. 34-1.

In some embodiments, an engineer or other user of a simulation system as disclosed herein, may review the data in FIGS. 24-1 to 34-6 to determine that a vibration tool and shock tool may increase ROP and DWOB without detrimental effects to the bit or the dynamics of the BHA. In some embodiments, the engineer or other user may use the data to select a particular BHA configuration (e.g., location along the drill string for a vibration and/or shock tool) for use in the field or to be modified for additional simulations. From the simulation data shown in FIGS. 23 to FIG. 34-6, a person may conclude, for instance, that a combination of a vibration tool and shock tool improves ROP and DWOB, but the location of the tools does not drastically affect the performance, and the tools do not appear to harmfully affect the bit or the dynamics of the BHA (and may even improve BHA or bit dynamics). In other embodiments, whether simulated or real drilling scenarios, placing the vibration tool and/or shock tool at various locations, such as near the bit, may have adverse effects on the bit or BHA dynamics.

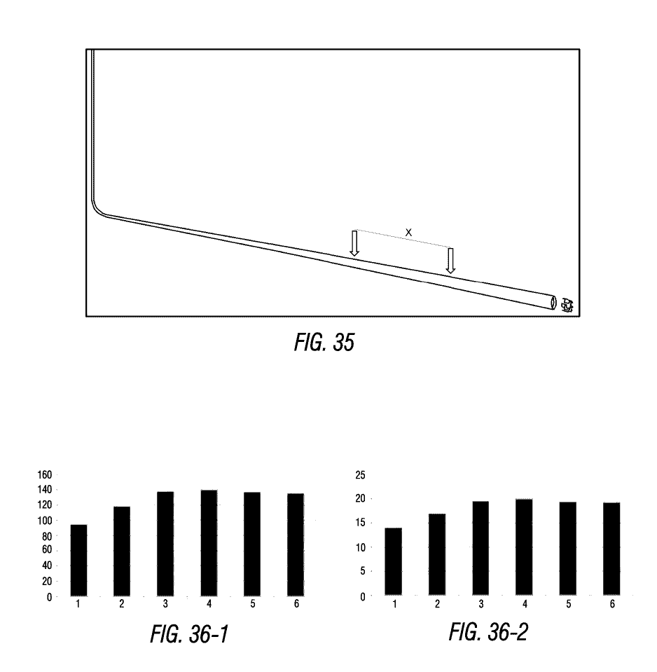

As described herein, any number of different simulations may be performed consistent with various embodiments of the present disclosure. Referring now to FIGS. 35 to 46-6, additional examples of simulations that can be performed, and the corresponding performance results for the simulations, are shown in additional detail. In particular, FIG. 35 illustrates a 3D model of a drill string with arrows showing different locations where components (e.g., vibration tool, shock tool, etc.) may be located. A separation between the arrows, labeled as X, may represent a distance of separation between multiple components (e.g., between a vibration tool and a shock tool, between two vibration tools, between two shock tools, between a combination of a vibration and shock tool and another combination of a vibration and shock tool, etc.). This model is merely illustrative, as those having ordinary skill would appreciate that the properties and parameters of a wellbore, drill string, BHA, other component, or combinations of the foregoing, may be customized and/or modified prior to, during, and after a drilling simulation.

In some embodiments, different simulation scenarios may be used in a simulation, in accordance with embodiments of the present disclosure. In at least some embodiments, the identified locations in FIG. 35 may correspond to a location where a vibration tool and shock tool may be located, although in other embodiments each location may be a single vibration tool or a single shock tool. In still other embodiments, additional or other components may be simulated at each location (or at other locations).

To compare the effects that components have at each location (e.g., as defined with respect to a distance from the bit), each simulation may be run with the same wellbore parameters, BHA parameters, and drilling operating parameters. In some particular embodiments discussed herein with respect to FIGS. 35 to 46-6, the simulations performed may include a vibration tool and shock tool at each location (other than a baseline location). For the illustrated embodiments, six simulation scenarios may be used, as described in Table 4.

TABLE 4

| Simulation | Description |
|---|---|
| 1 | N/A (no vibration tool or shock tool) |
| 2 | Tools 4,470 ft. (1,362 m) from bit |
| 3 | 1,030 ft. (314 m) separation |
| | Located 4,470 ft. (1,362 m) and 5,500 ft. (1,676 m) from bit |
| 4 | 1,830 ft. (558 m) separation |
| | Located 4,470 ft. (1,362 m) and 6,300 ft. (1,920 m) from bit |
| 5 | 2,530 ft. (771 m) separation |
| | Located 4,470 ft. (1,362 m) and 7,000 ft. (2,134 m) from bit |
| 6 | 2,930 ft. (893 m) separation |
| | Located 4,470 ft. (1,362 m) and 7,400 ft. (2,256 m) from bit |

The first simulation in Table 4 may be a baseline, and may be the same as the first simulation described in Tables 2 and 3. The second simulation may be the same as the fourth simulation described in Table 2 and the second simulation described in Table 3, as the vibration and shock tools may be located at 4,470 ft. (1,360 m) from the bit. Simulations 3-6 of Table 4 may include multiple sets of vibration and shock tools on a single drill string and vary the separation of the tools from each other and/or the distances with respect to the bit. It will be appreciated in view of the disclosure herein that the distances shown in Table 4 are merely illustrative, and may be varied in other embodiments. Additionally, while the vibration tool and shock tool are shown as being at the same distance, in other embodiments, the vibration tool and shock tool may be separated and simulated at different distances, or a simulation may not include one or both of the shock tool and the vibration tool.

During or after the simulations in Table 4, a number of performance parameters may be used or output for analysis. In FIGS. 36-1 and 36-2, the ROP and DWOB for each simulation scenario is presented, which may allow a comparison. In other embodiments, the results may be presented in numerical, raw data, or other formats. As shown in FIG. 36-1, adding multiple vibration and shock tool combinations, and then varying the distance between combinations of tools, may result in similar ROP of about 140 ft/hr (42.7 m/hr) for each of simulations 3-6, which may be above the baseline of about 95 ft/hr (29.0 m/hr) for simulations with no vibration and shock tools, and above an ROP of about 120 ft/hr (36.6 m/hr) for simulations with a single set of vibration and shock tools. In FIG. 36-2, the DWOB may also be similar for simulations 3-6, and around 19.5 kip ((86.7 kN), while the baseline, first simulation had a simulated DWOB of approximately 14 kip (62.3 kN) and the second simulation had a simulated DWOB of approximately 17 kip (75.6 kN). Thus, FIGS. 36-1 and 36-2 may show, for the simulated BHA, that the separation between sets of vibration and shock tools may have less of an impact to ROP and DWOB than the inclusion of multiple sets of vibration and shock tools. Nevertheless, as also shown in FIGS. 36-1 and 36-2, comparing different scenarios may allow selection of an optimum package, as the fourth scenario from Table 4 is shown to have slightly higher ROP and DWOB than other scenarios.

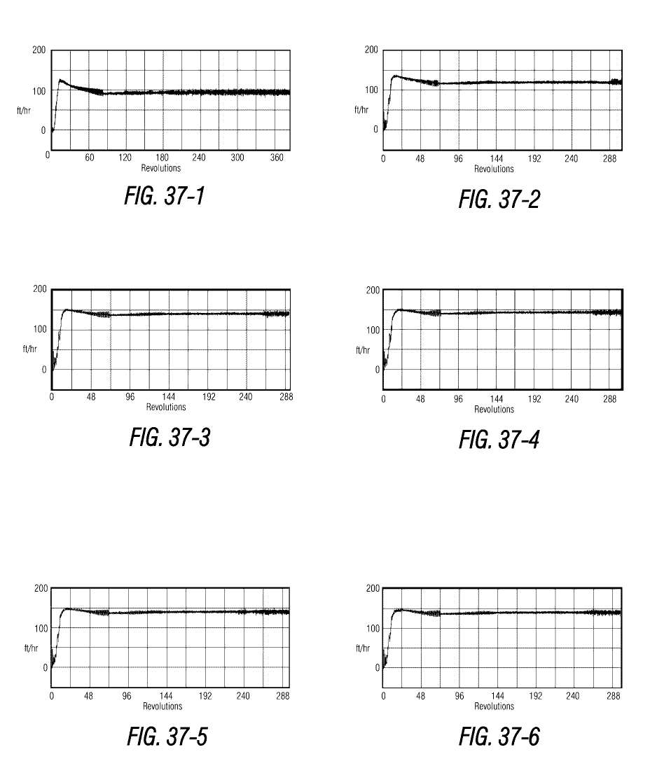

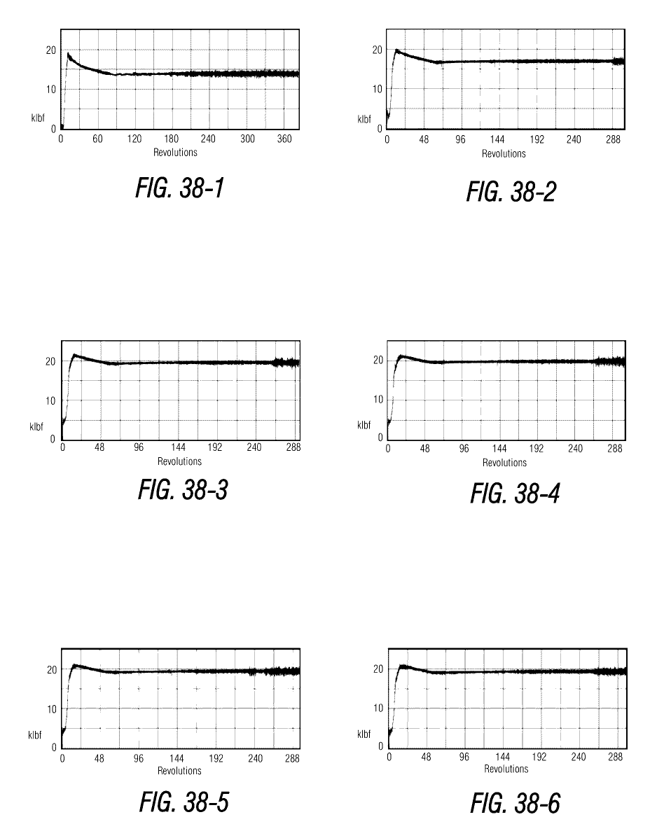

In FIGS. 37-1 to 37-6, the ROP for a BHA is shown for each of the simulations in Table 4. There are some variations between the simulations (e.g., increased variation in ROP beginning at about 288 revolutions in FIG. 37-2, at about 264 revolutions in FIGS. 37-3 and 37-4, at about 252 revolutions in FIG. 37-6, and at about 230 revolutions in FIG. 37-5, but overall, and as discussed relative to FIG. 36-1, the ROP of simulations 3-6, are similar, and are each higher than the ROP for the baseline simulation in FIG. 37-1, and the single vibration and shock tool BHA in FIG. 37-2. FIGS. 38-1 to 38-6 show the DWOP for a BHA with the same six simulations. There are some variations between the simulations (e.g., the line in FIG. 38-4 is thinner to show less variation than the DWOB reflected by the lines in other simulations), but overall the DWOB of simulations 3-6 are similar, and are each higher than the DWOB for the baseline simulation in FIG. 38-1 and the single tool simulation of FIG. 38-2.

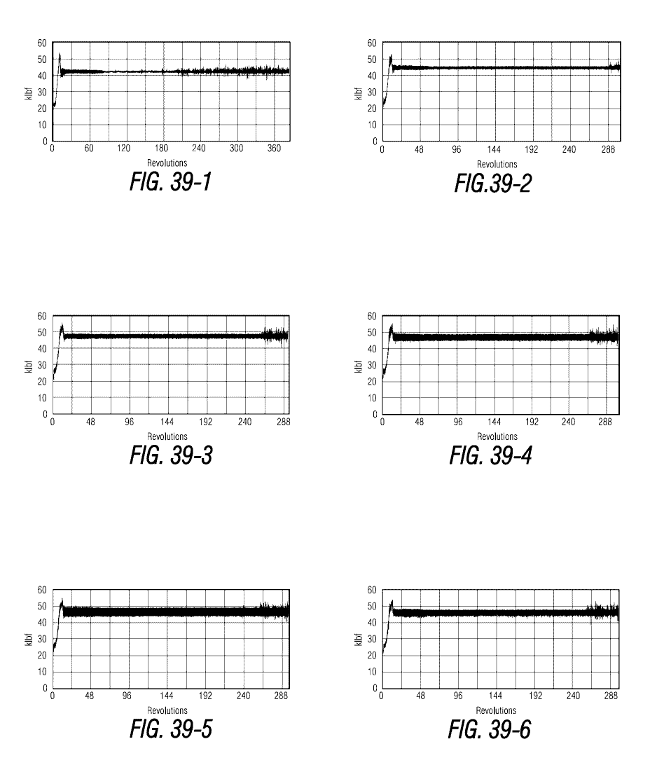

FIGS. 39-1 to 39-6 illustrate an example embodiment in which SWOB is provided and can be compared for the six simulation scenarios in Table 4. In each scenario, the trend is similar to that of DWOB in FIGS. 38-1 to 38-6. After SWOB levels off, simulations 3-6 show similar average SWOB of about 48 kip (213.5 kN), while the first simulation show an average SWOB of about 43 kip (191.3 kN), and the second simulation shows an average SWOB of about 45 kip (200.2 kN). The second and third simulations have the thinnest lines in the graphical data, which reflects the lowest variation in SWOB. As described previously, however, the fourth simulation may have the highest ROP, so variation in SWOB may, for this embodiment, not be highly correlative to improved downhole performance. Similar to ROP and DWOB, however, the separation between multiple vibration and shock tools may contribute to relatively minor differences in average SWOB, but show a more noticeable improvement over the baseline simulation (FIG. 39-1) and simulation with a single tool set (FIG. 39-2).

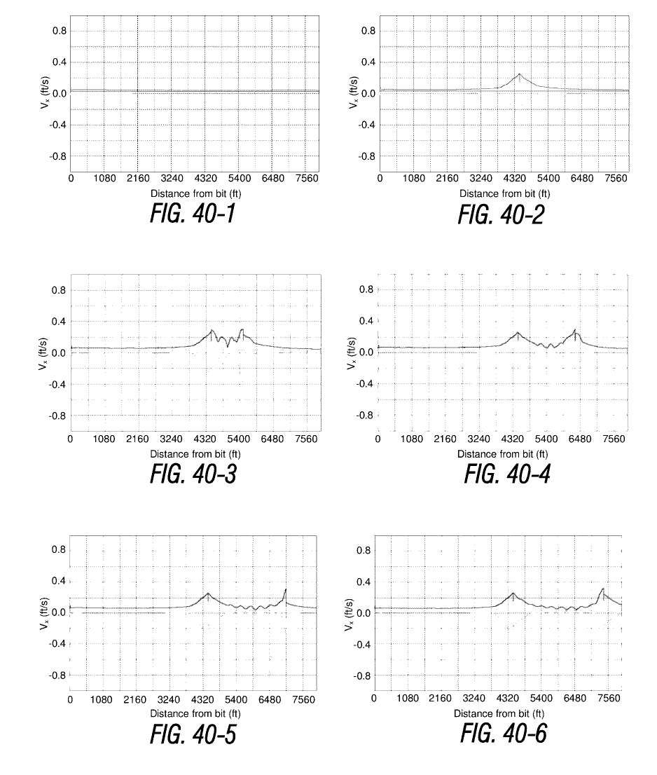

In FIGS. 40-1 to 40-6, another set of charts is shown for yet another example embodiment in which BHA axial velocity is provided and can be compared for the six simulation scenarios of Table 4. For the illustrated embodiment, a sets of shock and vibration tools may be positioned at different locations, with difference separation distances and different distances from the bit. Accordingly, FIGS. 28-2 to 28-6 each show axial velocities increasing at a distance near the offset of the tool sets. The magnitude of the axial velocity in each of the second through sixth simulations are generally similar—with multiple peaks occurring in simulations 3-6 which include multiple tool sets—with positive and negative axial velocities generally reaching about 0.3 ft/s (0.09 m/s). Thus, spikes of generally the same amplitude are shown in FIGS. 40-2 to 40-6, but correspond to the locations of the first and/or second vibration and shock tools. The range over which the axial velocity is measurable also varies, and a even at the greatest separation shown in FIG. 40-6, waves between the peak axial velocities can be seen, which waves are each above the baseline values shown in FIG. 40-1.

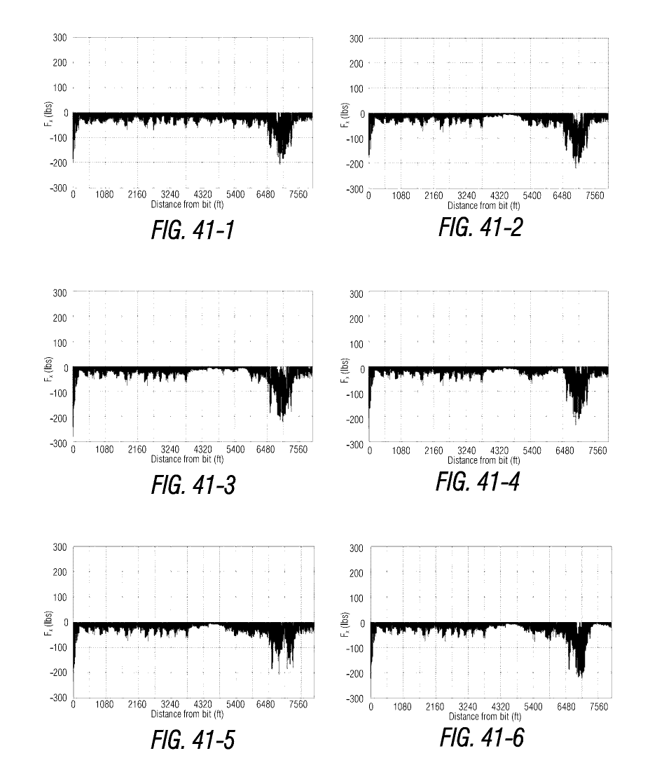

Referring now to FIGS. 41-1 to 41-6, the axial friction force of the BHA is shown for the six simulations in Table 4. As shown, in each of the simulations represented in FIGS. 41-2 to 41-6, the axial friction force at the location of at least one of the shock and vibration tool sets (e.g., at about 4,470 ft. (1,362 m)) is significantly reduced relative to the baseline shown in FIG. 41-1. Depending on the location of other tool sets, the interval over which the friction force is reduced. For instance, the interval may be about 1,000 ft. (305 m) in FIG. 41-2, and about 2,000 ft. (610 m) in FIG. 41-3. In some embodiments, the friction force may be less at locations of both first and second (or more) sets of vibration and shock tools.

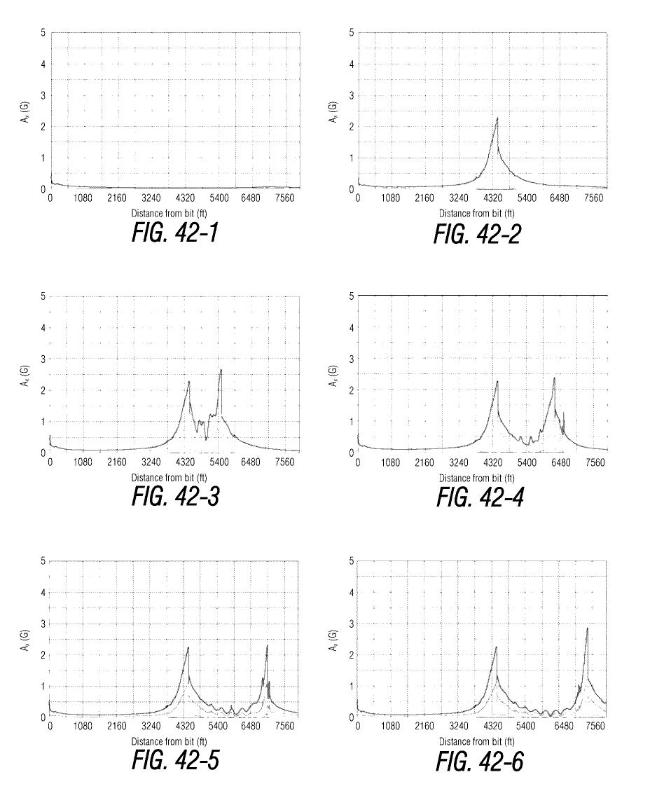

FIGS. 42-1 to 42-6 represent the axial acceleration of portions of a BHA relative to the distance from the bit, for each of the simulations in Table 4. In the illustrated embodiment, each of the simulations other than the baseline simulation FIG. 42-1 are shown to have similar magnitudes of the highest peak (top line) and average (middle line) axial accelerations, while simulations 3-6 also include multiple peaks. In particular, the maximum acceleration is shown to be between about 2.25 g-forces and 2.75 g-forces, and the average axial acceleration to have a peak at about 1.25 g-force. The spikes of axial acceleration are generally centered at the position of the vibration tool and/or shock tool. Depending on the separation between shock and vibration tool sets, the effect of the tools on axial acceleration may be measured over different distances. For instance, the single tool set in FIG. 42-2 may have effects over about a 3,000 ft. (915 m) distance, while the effects in FIG. 42-6, which has a larger separation between two tool sets, may be over about a 5,400 ft. (1,645 m) distance.

FIGS. 43-1 to 43-6 represent the lateral acceleration of portions of a BHA relative to the distance from the bit, for each of the simulations in Table 4. In each embodiment, lateral accelerations starting at a distance of approximately 6,500 ft. (1,980 m) from the bit are about the same. The lateral vibrations centered at about the location of the first and second vibration and shock tools for each respective simulation are, however, different, with each reaching peaks of up to about 0.6 g-force. The interval over which the increased lateral acceleration is noticeable may also vary depending on the separation of the first and second shock tools.

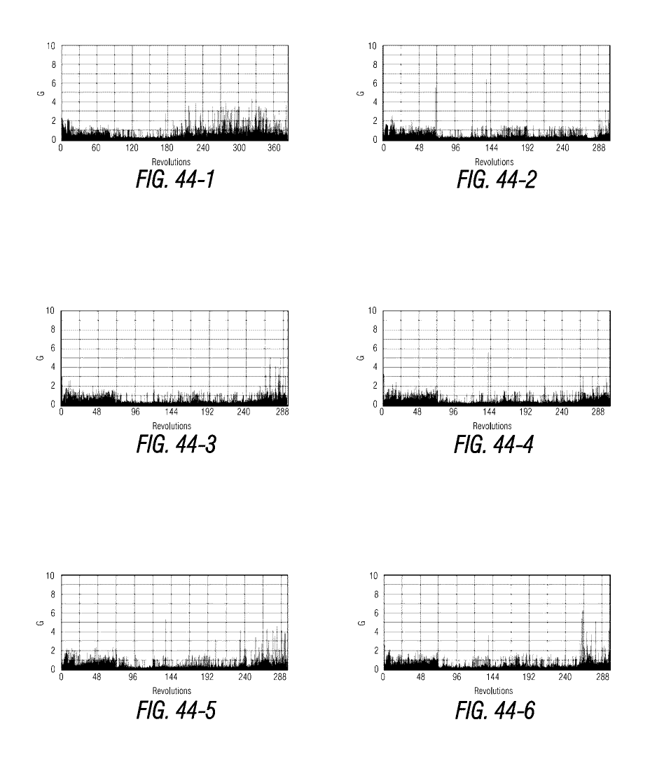

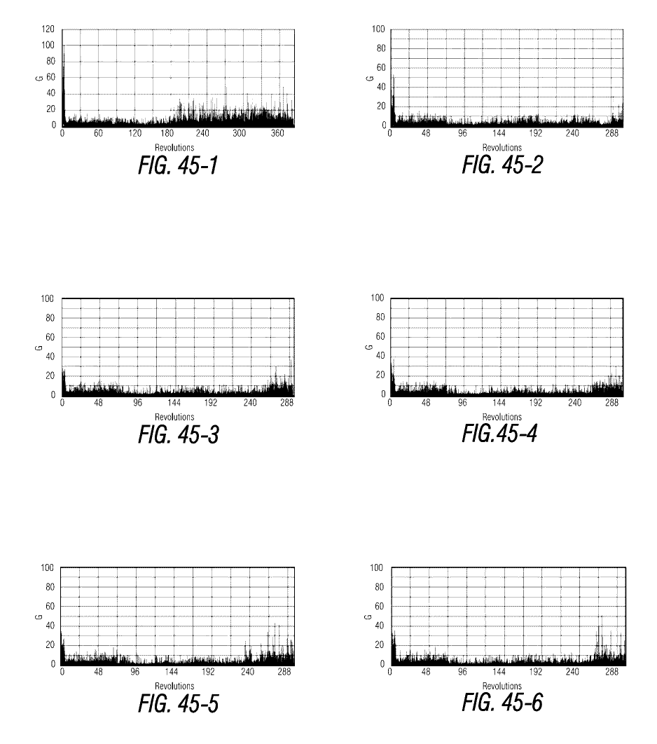

Axial and lateral accelerations of the bit may also be simulated, and example results for the simulations in Table 4 are shown in FIGS. 44-1 to 44-6 and in FIGS. 45-1 to 45-6, respectively. FIGS. 44-1 to 44-6 show axial acceleration on the y-axis, with the number of bit revolutions of the simulation along the x-axis. As shown, the axial accelerations of the bit may be similar for each of the simulations up to a particular number of revolutions (e.g., about 70 revolutions). After that point, however, the acceleration patterns for simulations 2-6 vary significantly relative to the baseline in FIG. 44-1, and have a lower average axial acceleration. Similarly, FIGS. 45-1 to 45-6 show lateral acceleration of the bit on the y-axis and bit revolutions along the x-axis. Other than a reduction in a peak acceleration near start-up of the bit-rotation, the lateral accelerations of the bit up through about 100 revolutions are about the same for each simulation. The acceleration patterns then vary, with the average bit lateral acceleration being generally similar for each of the second through sixth simulations, and less than the average of the baseline simulation shown in FIG. 45-1. The results of FIGS. 44-1 to 45-6 show a general dampening of axial and lateral bit accelerations when using a vibration tool and a shock tool (and when using multiple sets of vibration and shock tools) when compared to a baseline simulation without such tools. Multiple sets of tools may also show lower lateral and/or axial bit acceleration than a tool string having a single tool set. Lower vibration at the bit may also be associated with more constant WOB.

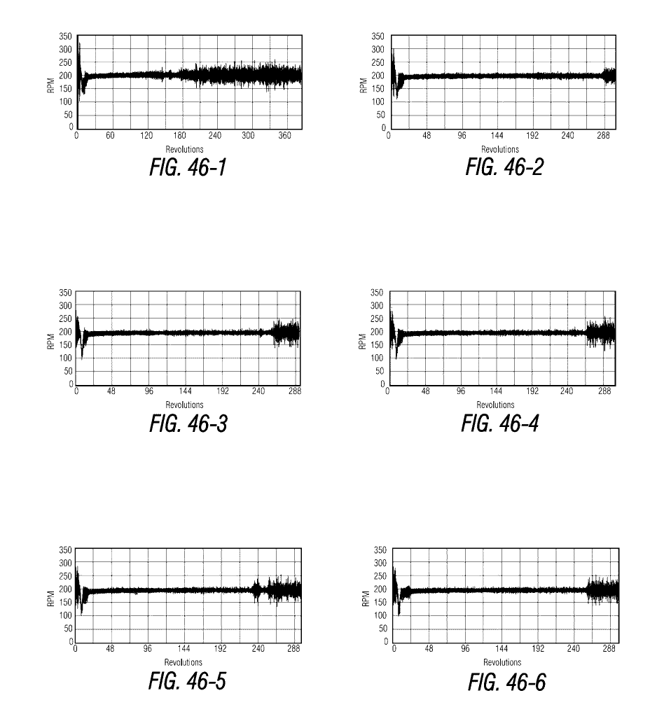

Referring now to FIGS. 46-1 to 46-6, bit rotational speed is shown for the six simulations of Table 4. In each of the simulations, the bit rotational speed levels out after about 15-20 revolutions to have an average bit rotational speed of approximately 200 RPM. Despite each simulation showing about the same average rotational speed, simulations 2-6 show considerably less variation in the bit rotational speed, as evidenced by the line being thinner overall when compared to the lines in the baseline simulation of FIG. 46-1. While there may also be some difference resulting from the addition of multiple sets of vibration and shock tools, the multiple sets of tools do not, in this embodiment, show a drastic effect, although after a period of reduced variability in bit rotational speed, the simulations with multiple sets of vibration and shock tools do tend to increase in variability more quickly (e.g., at or before about 264 revolutions in FIGS. 46-3 to 46-3 and at about 288 revolutions in FIG. 46-2).

In some embodiments, an engineer or other user of a simulation system as disclosed herein, may review the data in FIGS. 36-1 to 46-6 to determine the effect of multiple sets of vibration and/or shock tools, and the distances between such tools or between the tools and the bit. For instance, it may be determined that multiple sets of vibration and shock tools may increase ROP and DWOB without detrimental effects to the bit or the dynamics of the BHA. In some embodiments, the engineer or other user may use the data to select a particular BHA configuration (e.g., location along the drill string for multiple vibration and/or shock tools) for use in the field or to be modified for additional simulations. From the simulation data shown in FIGS. 35 to FIG. 46-6, a person may conclude, for instance, that a combination of a multiple sets of vibration and shock tools improves ROP and DWOB, but the separation between tools may not drastically affect the performance, and the tools do not appear to harmfully affect the bit or the dynamics of the BHA (and may even improve BHA or bit dynamics). In some embodiments, placement of the second or more vibration and shock tool sets may depend on other conditions, such as the field environment in which a downhole operation is performed.

In some embodiments, the distance between a vibration tool and a shock tool may also be simulated. Such simulation may potentially include the effects of the period, amplitude, or other features of a vibration or pressure pulse, and how such a pulse affects a pulse of another tool or component. FIGS. 47-1 to 47-3, for instance, illustrate various example waves or pressure pulses according to some embodiments of the present disclosure. In particular, each may include a shock wave (S) from a shock tool and a vibrational wave (V) from a vibration tool. In FIG. 47-1, the shock wave and vibrational wave are shown as having generally the same period (P) and different amplitudes. When such waves are fully in-phase, as shown in FIG. 47-1, the waves may produce a combined wave (C) as shown, which may have the same period P, and an amplitude (A) that is the sum of the amplitudes of the shock and vibrational waves. This is an example of constructive wave interference.

In other embodiments, when the shock and vibrational waves have the same period (P) and are fully out of phase, as shown in FIG. 47-2, the period (P) may remain the same while the amplitude (A) of the combined wave may be reduced. The amplitude of the combined wave may, for example, be the difference between the amplitudes of the shock and vibrational waves, which in FIG. 47-2 is less than the amplitude of either the shock or vibrational wave. When out-of-phase, the waves may exhibit destructive wave interference.

In still other embodiments, the shock and vibrational waves may have the same period but may be offset to be partially in-phase and partially out-of-phase. In such an embodiment, the combined wave may be produced by both constructive and destructive interference, and different times. In still other embodiments, the shock and vibrational waves may have different periods, which can also result in both constructive and destructive interference. FIG. 47-3, for instance, illustrates an example in which the shock (S) and vibrational (V) waves have different periods and amplitudes. The resulting, combined wave (C) then has a variable period (shown by periods P₁ and P₂) and varying amplitude (shown by amplitudes A₁ and A₂). The interactions of multiple waves may be simulated in accordance with embodiments of the present disclosure to determine the effects on ROP, DWOB, SWOB, velocities, accelerations, and the like. Those having ordinary skill will also appreciate in view of the present disclosure that other phase conditions exist without departing from the present disclosure. Further, while waves have been described in terms of combining shock and vibrational waves, in other embodiments, simulations may per performed while simulating the interference between multiple shock waves, between multiple vibrational waves, or between multiple combined waves.

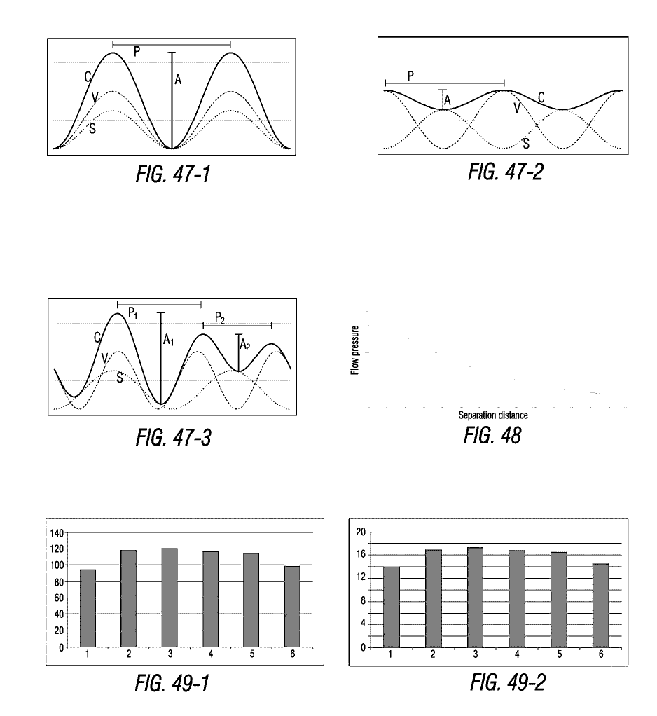

The distance a wave travels may also affect how two waves interfere with each other. FIG. 48, for instance, illustrates an example chart of an axial pulse traveling through drilling fluid prior to arriving at a shock tool. As shown, the pressure of the pulse is attenuated, and decreases as the separation distance increases. This attenuation can be taken into account during simulation of shock and vibration tools. In particular, depending on the distance a shock tool is from a vibration tool, the attenuation may result in reduced amplitude, which corresponds to the reduced flow pressure. As a result, shock tools run with a vibration tool may have different simulated wave amplitudes at different distances, even if other parameters remain the same.

In some embodiments, different simulation scenarios may be used in a simulation, in accordance with embodiments of the present disclosure. In at least some embodiments, one location identified in FIG. 35 may correspond to a location of a vibration tool, and another location may correspond to a location of a shock tool. To compare the effects of placing the components at different locations (e.g., as defined with respect to a distance from the bit), various simulations may be run with the same wellbore parameters, BHA parameters, and drilling operating parameters. In some particular embodiments discussed herein with respect to FIGS. 49-1 to 59-6, the simulations performed (other than a baseline location) may include a vibration tool at a particular location and a shock tool further uphole a particular distance from the vibration tool (although in other embodiments the shock tool could be further downhole). Additional considerations included in the simulations are whether pressure pulses for the shock and vibration tool are in-phase (constructive interference) or out-of-phase (destructive interference). For the illustrated embodiments, six simulation scenarios may be used, as described in Table 5.

TABLE 5

| Simulation | Description |
|---|---|
| 1 | N/A (no vibration tool or shock tool) |
| 2 | Tools together 4,470 ft. (1,362 m) from bit |
| 3 | 1,000 ft. (305 m) separation |
| | Vibration tool 4,470 ft. (1,362 m) from bit |
| | In-phase pressure pulses |
| 4 | 2,000 ft. (610 m) separation |
| | Vibration tool 4,470 ft. (1,362 m) from bit |
| | In-phase pressure pulses |
| 5 | 3,000 ft. (915 m) separation |
| | Vibration tool 4,470 ft. (1,362 m) from bit |
| | In-phase pressure pulses |
| 6 | 2,000 ft. (610 m) separation |
| | Vibration tool 4,470 ft. (1,362 m) from bit |
| | Out-of-phase pressure pulses |

The first simulation in Table 5 may be a baseline, and may be the same as the first simulation in Table 4. The second simulation may be the same as the second simulation in Table 4, as the vibration and shock tools may be together at a location at 4,470 ft. (1,360 m) from the bit. Simulations 3-6 of Table 5 may include a separation between vibration and shock tools, with the separation of the tools and/or the phase of the pressure pulses varying for each simulation. It will be appreciated in view of the disclosure herein that the distances shown in Table 5 are merely illustrative, and may be varied in other embodiments. Additionally, while single vibration tool and shock tools are shown, in other embodiments, multiple shock and/or vibration tools (whether separated or positioned together) may be simulated.

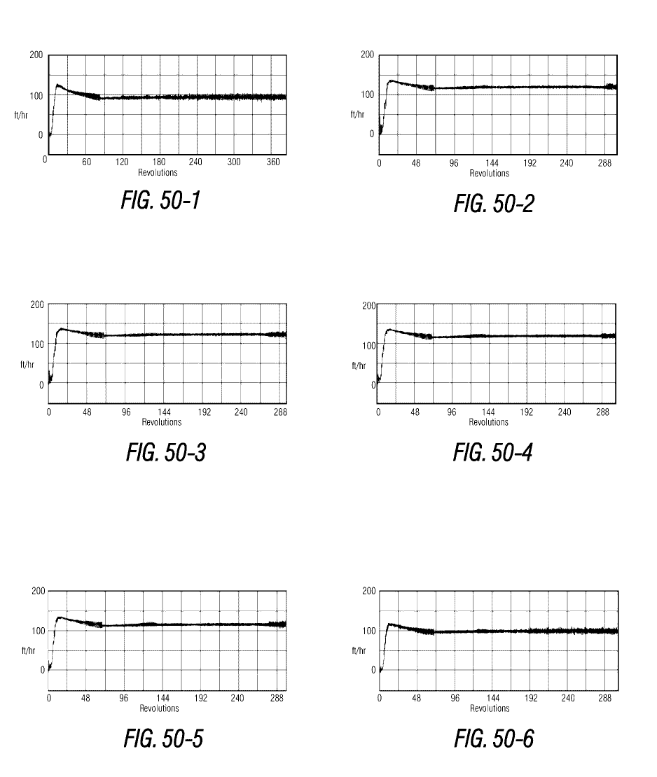

During or after the simulations in Table 5, a number of performance parameters may be used or output for analysis. In FIGS. 49-1 and 49-2, the ROP and DWOB for each simulation scenario is presented, which may allow a comparison. In other embodiments, the results may be presented in numerical, raw data, or other formats. As shown in FIG. 49-1, when the shock and vibration tools are together or spaced apart, the resulting ROP may be similar, and may be about 120 ft/hr (36.6 m/hr) for each of simulations 2-5, which include in-phase pressure pulses. This is above the baseline of about 95 ft/hr (29.0 m/hr) for simulations with no vibration and shock tools, and above an ROP of about 100 ft/hr (30.5 m/hr) for a simulation with shock and vibration tools that are spaced apart with out-of-phase pressure pulses (simulation 6). In FIG. 49-2, the DWOB may also be similar for simulations 2-5, and around 17 kip (75.6 kN), while the baseline, first simulation had a simulated DWOB of approximately 14 kip (62.3 kN) and the sixth simulation had a simulated DWOB of approximately 14.5 kip (64.5 kN). Thus, FIGS. 49-1 and 49-2 may show, for the simulated BHA, that the separation between a vibration tool and a shock tool may have less of an impact to ROP and DWOB than the inclusion of both tools. In this embodiment, however, inclusion of both tools can also be largely negated if the vibration and shock tools operate out-of-phase. As also shown in FIGS. 49-1 and 49-2, comparing different scenarios may allow selection of an optimum package, as the third scenario from Table 5 is shown to have slightly higher ROP and DWOB than other scenarios. If the distance is less than or greater than the optimal location (simulation 3 in this example embodiment), the BHA may have lower ROP and DWOB.

One skilled in the art may, however, decide against using an optimal package. For instance, it may be unknown whether tools in the field will operate in-phase or out-of-phase when separated. As the illustrated embodiment shows a relatively small difference in ROP and DWOB between the optimal package (simulation 3) and the package with the shock and vibration tools positioned together (simulation 2), one skilled in the art may choose the configuration in the second simulation to avoid uncertainty of pulse or wave interference. Where, however, the pressure pulse characteristics are known, an optimal or near-optimal solution may be determined and selected.

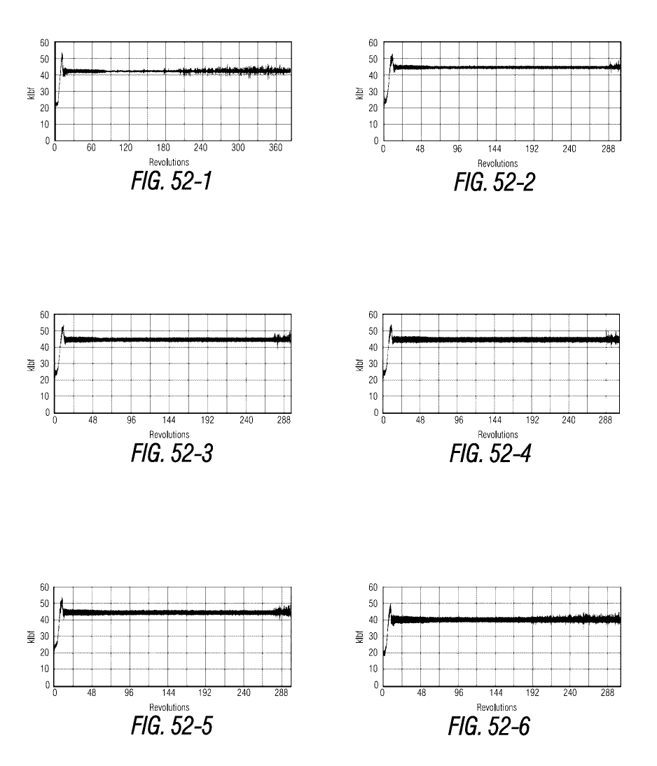

As discussed herein, a number of performance parameters may be output and illustrated in a number of different visualizations. FIGS. 50-1 to 59-6 present various plots or charts of data, and are similar to those previously described. Accordingly, such plots will be briefly discussed to avoid obscuring aspects of the present disclosure. In FIGS. 50-1 to 50-6, ROP is shown for the simulations in Table 5. FIGS. 51-1 to 51-6 show DWOB, and FIGS. 52-1 to 52-6 show SWOB for the simulations in Table 5. Similar to the above, if the shock tool and vibration tool are out-of-phase (FIGS. 50-6 and 51-6), a drastic reduction in ROP and DWOB is observed and is very close to the baseline results (FIGS. 50-1 and 51-1). In the case of SWOB, when the shock and vibration tool are out-of-phase (FIG. 52-6), the SWOB may be less than the baseline result (FIG. 52-1).

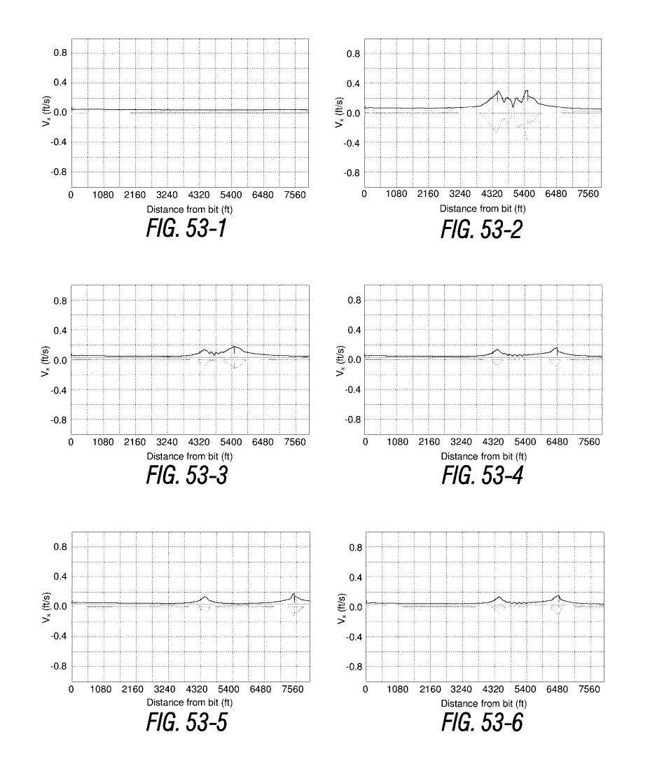

Referring now to FIGS. 53-1 to 53-6, the axial velocity of the BHA is shown for the simulations in Table 5. As shown, the axial velocity spikes are generally of the same amplitude in each of the plots (except for FIG. 53-2 corresponding to the vibration tool and shock tool being positioned near one another, which has larger spikes). The spikes also correspond to the locations of the vibration tool (left, lower amplitude spike) and shock tool (right, higher amplitude spike).

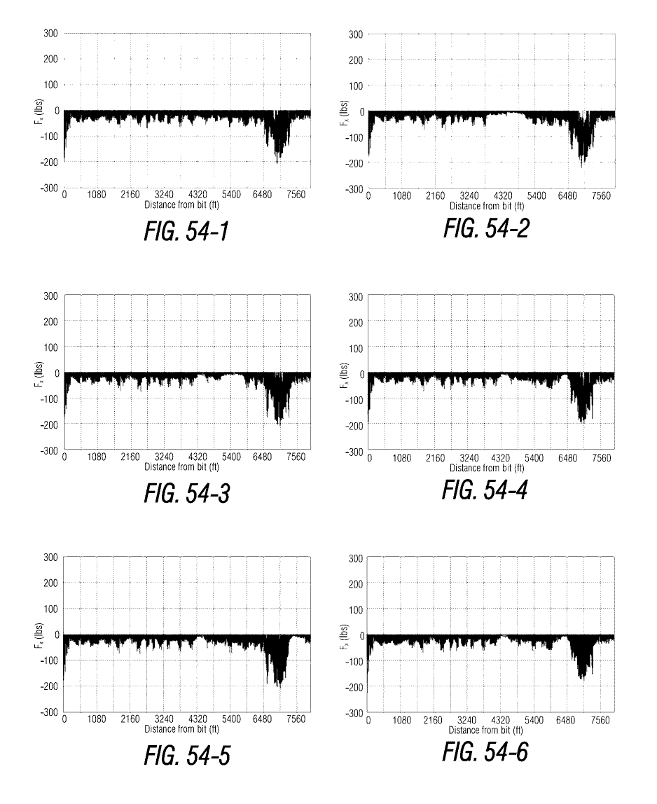

Referring now to FIGS. 54-1 to 54-6, the axial friction force of the BHA is shown for the simulations of Table 5. As shown, the friction force is reduced, relative to the baseline of FIG. 54-1, at the location of the shock and vibration tools. In FIG. 54-2, the reduced vibration occurs over a longer distance as the shock and vibration tools are positioned together, where in FIGS. 54-3 to 54-6, there are reductions at the specific locations of the shock and vibration tools.

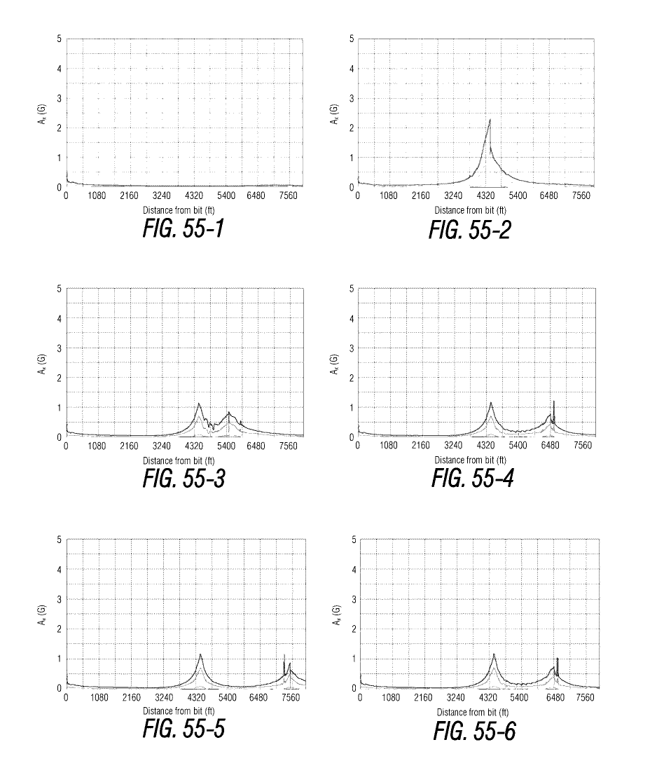

In FIGS. 55-1 to 55-6, the axial acceleration of the BHA is shown for the simulations in Table 5. As shown, the spikes occur at the positions of the vibration tool and the shock tool, and the axial acceleration is largest when the shock and vibration tool are positioned near one another (FIG. 55-2).

Referring now to FIGS. 56-1 to 56-6, the lateral acceleration of the BHA is shown for the simulations in Table 5. As shown, the lateral acceleration in each of the simulations is similar, with relatively minor axial vibration increases at the location of the vibration and shock tools (e.g., starting at about 4,470 ft. (1,362 m) from the bit.

The axial accelerations (FIGS. 57-1 to 57-6) and lateral accelerations (FIGS. 58-1 to 58-6) of the bit are also shown for the simulations in Table 5. As shown, there is a general dampening of axial acceleration and lateral acceleration relative to the baseline simulation when the vibration and shock tools operate in-phase. That dampening is largely eliminated when the shock tool and the axial vibration tool are out-of-phase.

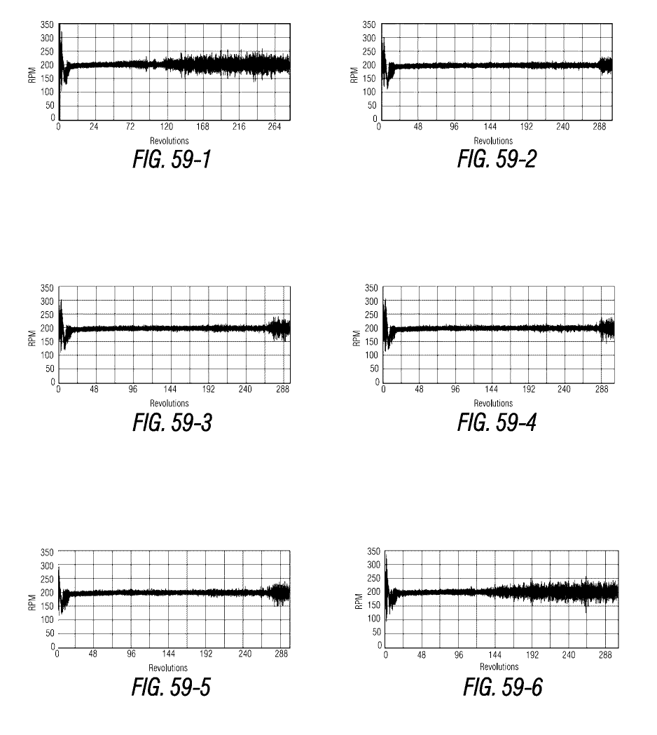

In FIGS. 59-1 to 59-6, the bit RPM is shown for the simulations in Table 5. As shown, when vibration and shock tools are together or separate, but run in-phase, the simulation shows significantly less variability in the bit RPM. In contrast, when the simulation is run with the vibration and shock tools being out-of-phase, bit RPM is much more inconsistent, and is similar to the baseline simulation of FIG. 59-1, in which there is no vibration or shock tool.

Embodiments of the present disclosure, therefore, allow a simulation system and/or a user to compare and contrast performance parameters of one or more downhole assemblies under various operating conditions. In particular, users and/or the simulation system may analyze and compare the performance parameters resulting from simulations with different vibration tool parameters, shock parameters, bit parameters, downhole assembly parameters, and the like. As such, users or the simulation system may then add, remove, or move components of the downhole assembly to obtain different performance parameters. By allowing a user or simulation system to review the performance parameters of a downhole assembly and its components (e.g., a vibration tool and/or a shock tool), the overall performance of the downhole assembly for a given operation may be improved.

It should also be noted that in the description provided herein, computer software may be used, or may be described, as performing certain tasks. For example, a simulation system may include or execute computer-executable instructions in machine, source, binary, or other code to set-up and/or perform one or more simulations according to embodiments of the present disclosure.

Computer-executable instructions may be accessed from computer-readable media for use by a computing system or other simulation system in accordance with embodiments of the present disclosure. The term computer-readable medium includes, but is not limited to portable or fixed storage devices, optical storage devices, wireless channels and various other media capable of storing, containing, or carrying instruction(s) and/or data. Computer-readable media may therefore include both storage-type and transmission-type media. Storage-type media (including storage devices) embodies one or more physical devices for storing data, including read-only memory (ROM), random access memory (RAM), magnetic RAM, core memory, magnetic disk storage media, optical storage media, flash memory devices, or other machine readable media which store information. Hardware and firmware may also be considered types of storage-type computer-readable media. Wireless channels, carrier waves, and media capable of carrying instructions are examples of transmission-type media. Storage-type media should be considered distinct from transmission-type media, although both may generally be categorized as computer-readable media.

From the foregoing, it will be apparent that a technology has been presented herein that provides for a mechanism for performing simulations in industrial processes in a manner that allows operators of such processes—which operators may be human controllers, processors, drivers, control systems, or the like—to make note of or detect performance parameters of various simulations, change or select designs of a downhole assembly or other downhole system, change operation of a downhole assembly or other downhole system, or optimally operate or define downhole operations in light of the environment, status of the system performing the procedure, and the like.

Merely by way of example, some embodiments of the disclosure provide software programs, which may be executed on one or more computing devices, for performing the methods and/or procedures described herein. In particular embodiments, for example, there may be a plurality of software or firmware components configured to execute on various hardware devices. In other embodiments, the methods may be performed by a combination of hardware, firmware, or software.

It should also be appreciated that the methods described herein may be performed by hardware components and/or may be embodied in sequences of computer-executable instructions, which may be used to cause a machine, such as a general-purpose or special-purpose computer, machine, or logic circuit, to perform the methods. The embodiments presented herein may either be used to recommend courses of action to operators of simulation systems, to display or output data for analysis by operators, or as automated processes. While the techniques herein are described primarily in the context of simulating vibration tools and shock tools within a drilling environment in a wellbore for use in the exploration or production of oil and gas resources, the techniques are applicable to other processes (e.g., conveying tooling when drilling is not occurring, milling, remedial processes, fishing processes, underreaming, completion processes, fracturing processes, etc.).

In the foregoing description, for the purposes of illustration, various methods and/or procedures were described in a particular order. It should be appreciated that in other embodiments, the methods and/or procedures may be performed in an order different than that described, or even omitted, or additional or other methods and/or procedures may be added.

Although a few example embodiments have been described in detail herein, those skilled in the art will readily appreciate in view of the present disclosure that many modifications are possible in the example embodiments without materially departing from this disclosure. Accordingly, any such modifications are intended to be included within the scope of this disclosure.

Embodiments are shown in the above-identified drawings and description. In describing the embodiments, like or identical reference numerals are used to identify common or similar elements. The drawings are not necessarily to scale and certain features may be shown exaggerated in scale or in schematic in the interest of clarity and conciseness. Features, components, and elements of various systems, methods, devices, apparatus, and the like may be used in any combination.

Throughout this document, the term “field” may refer to a site where any type of valuable fluids or minerals can be found and the activities for extraction. The term may also refer to sites where substances are deposited or stored by injecting them into subterranean structures using wellbores and the operations associated with this process. Further, the term “field operation” refers to an operation associated with a field and/or performed in the field, including, but not limited to, activities related to field planning, wellbore drilling, wellbore casing, wellbore cementing, wellbore completion, wellbore abandonment, wellbore casing cutting/removal, and production using the wellbore.

While most of the terms used herein will be recognizable to those of skill in the art, it should be understood, however, that when not explicitly defined, terms should be interpreted as adopting a meaning presently accepted by those skilled in the art. Further, the phrase “coupled to” may refer to one or more elements being attached to, secured to, and/or connected to one another. In addition, those having ordinary skill in the art will appreciate that when describing a first element coupled to a second element, it is understood that coupling may be either directly coupling the first element to the second element, or indirectly coupling the first element on the second element. For example, a first element may be directly coupled to a second element, such as by having the first element and the second element in direct contact with each other, or a first element may be indirectly coupled to a second element, such as by having a third element, and/or additional elements, between the first and second elements.

As used herein, the terms “up” and “down,” “upper” and “lower,” “upwardly” and “downwardly,” “below” and “above,” “left” and “right,” and other similar terms indicating relative positions may be used in connection with some implementations of various technologies described herein. When applied to equipment and methods for use in wellbores that are deviated or horizontal, however, or when applied to equipment and methods that when arranged in a wellbore are in a deviated or horizontal orientation, such terms may refer to other relationships as appropriate.

In the claims, means-plus-function clauses are intended to cover the structures described herein as performing the recited function as well as structural equivalents which operate in a similar manner, and also equivalent structures which perform a similar function. It is the express intention of the applicant not to invoke means-plus-function or other functional claiming for any limitations of any of the claims herein, except for those in which the claim expressly uses the words ‘means for’ together with an associated function.

What is claimed is:

1. A system for simulating a downhole operation, comprising:
a computing device including a computing processor; and
computer-readable media storing computer-executable instructions that, when executed by the computing processor, are configured to cause the computing device to:
use bottom hole assembly (BHA) parameters, wellbore parameters, drilling operating parameters, and at least a first set of one or more of vibration tool parameters or shock tool parameters, to execute a first simulation to generate first performance parameters;
use the BHA parameters, wellbore parameters, drilling operating parameters, and at least a second set of one or more of vibration tool parameters or shock tool parameters to execute a second simulation to generate second performance parameters; and
execute a graphical user interface with functionality to:
receive the BHA parameters, wellbore parameters, drilling operating parameters, first set of one or more of vibration tool parameters or shock tool parameters, and second set of one or more of vibration tool parameters or shock tool parameters;
present, on the graphical user interface, the first performance parameters generated from the first simulation;
modify at least one parameter of the first set of one or more of vibration tool parameters or shock tool parameters to obtain the second set of one or more of vibration tool parameters or shock tool parameters;
present, on the graphical user interface, the second performance parameters generated from the second simulation; and
select a downhole system based on the first or second performance parameters.

2. The system of claim 1, the first performance parameter including at least one of: rate of penetration; surface weight on bit; downhole weight on bit; axial velocity; axial friction force; axial acceleration; lateral acceleration; or bit rotations per minute.

3. The system of claim 1, the second performance parameter including at least one of: rate of penetration; surface weight on bit; downhole weight on bit; axial velocity; axial friction force; axial acceleration; lateral acceleration; or bit rotations per minute.

4. The system of claim 1, the first set of one or more of vibration tool parameters or shock tool parameters including at least one of: fluid pressure applied to a vibration tool; number of vibration tools; number of shock tools; fluid pressure applied to at least one of the number of shock tools; fluid pressure applied to at least one of the number of vibration tools; vibration tool distance to bit; shock tool distance to bit; distance between shock tool and vibration tool; or type of vibration of the vibration tool.

5. The system of claim 1, wherein modifying the at least one parameter of the first set of one or more of vibration tool parameters or shock tool parameters to obtain the second set of one or more of vibration tool parameters or shock tool parameters includes changing a distance from a bit.

6. The system of claim 1, wherein modifying the at least one parameter of the first set of one or more of vibration tool parameters or shock tool parameters to obtain the second set of one or more of vibration tool parameters or shock tool parameters includes adding or removing a vibration tool.

7. The system of claim 1, wherein modifying the at least one parameter of the first set of one or more of vibration tool parameters or shock tool parameters to obtain the second set of one or more of vibration tool parameters or shock tool parameters includes adding or removing a shock tool.

8. The system of claim 1, wherein modifying the at least one parameter of the first set of one or more of vibration tool parameters or shock tool parameters to obtain the second set of one or more of vibration tool parameters or shock tool parameters includes changing a distance between a shock tool and a vibration tool.

9. The system of claim 1, wherein modifying the at least one parameter of the first set of one or more of vibration tool parameters or shock tool parameters to obtain the second set of one or more of vibration tool parameters or shock tool parameters includes changing a distance between a first tool set and a second tool set, each of the first and second tool sets including a vibration tool and a shock tool.

10. The system of claim 1, wherein modifying the at least one parameter of the first set of one or more of vibration tool parameters or shock tool parameters to obtain the second set of one or more of vibration tool parameters or shock tool parameters includes changing phase of fluid pulses.

11. A method for selecting a downhole assembly, comprising:
receiving vibration tool parameters, bottom hole assembly (BHA) parameters, wellbore parameters, and drilling operating parameters;
performing a dynamic simulation of a first downhole assembly based on the vibration tool parameters, BHA parameters, wellbore parameters, and drilling operating parameters; and
presenting a performance parameter of the first downhole assembly, the performance parameter being obtained from performing the dynamic simulation.

12. The method of claim 11, the wellbore parameters including at least one of: geometry of a wellbore; formation material properties; trajectory of the wellbore; friction of the wellbore; or wellbore fluid properties.

13. The method of claim 11, the performance parameter being a first performance parameter, and the method further comprising:
modifying, based on the performance parameter, at least one of the vibration tool parameters, BHA parameters, wellbore parameters, or drilling operating parameters by changing at least a value of one parameter to obtain a modified parameter;
performing a dynamic simulation of a second downhole assembly based on the modified parameter;
presenting a second performance parameter of the second downhole assembly, the second performance parameter being obtained from performing the dynamic simulation of the second downhole assembly; and
selecting a downhole assembly based on the first or second performance parameters.

14. The method of claim 13, the modified parameter including one or more of: number of vibration tools; number of shock tools; position on a tool string; distance between vibration tools; distance between shock tools; distance between a vibration tool and a shock tool; distance between a first set of a vibration tool and shock tool relative to a second set of a vibration tool and a shock tool; or phase of fluid pulses or waves.

15. The method of claim 11, the vibration tool parameters including parameters of an axial vibration tool.

16. A method of designing a downhole assembly, comprising:
accessing vibration tool parameters, shock tool parameters, bottom hole assembly (BHA) parameters, wellbore parameters, and drilling operating parameters;
performing a dynamic simulation of a first downhole assembly based on the vibration tool parameters, shock tool parameters, BHA parameters, wellbore parameters, and drilling operating parameters; and
presenting a performance parameter of the first downhole assembly calculated from the dynamic simulation of the first downhole assembly.

17. The method of claim 16, the shock tool parameters including at least one of: a number of shock tools; fluid pressure applied to at least one of the number of shock tools; shock tool distance to bit; or distance between a shock tool and a vibration tool.

18. The method of claim 16, the BHA parameters including at least one of: bit type; size of bit;
shape of bit; cutting type of cutting structures on the bit; cutting element geometry of the cutting structures on the bit; number of cutting structures on the bit; or location of cutting structures on the bit.

19. A storage-type medium storing computer-executable-instructions that, when executed by one or more computing processors, are configured to cause a computing system to:
access, using a graphical user interface, vibration tool parameters, bottom hole assembly (BHA) parameters, wellbore parameters, and drilling operating parameters;
perform a dynamic simulation of a first downhole assembly based on the vibration tool parameters, BHA parameters, wellbore parameters, and drilling operating parameters; and
present, on the graphical user interface, a first performance parameter of the first downhole assembly as calculated from the dynamic simulation.

20. The method of claim 19, the vibration tool parameters including at least one of: shock tool parameters; fluid pressure applied to a vibration tool; number of vibration tools; number of shock tools; fluid pressure applied to at least one of the number of shock tools; fluid pressure applied to at least one of the number of vibration tools; vibration tool distance to bit; shock tool distance to bit; distance between shock tool and vibration tool; phase of a vibration, pulse, or wave; attenuation of a vibration, pulse, or wave; or direction of vibration.
